(19) United States
(12) Patent Application Publication
(10) Pub. No.: US 2024/0081383 A1
(43) Pub. Date: Mar. 14, 2024

(54) SOLUBLE AND INSOLUBLE SACCHARIDE COMPOSITIONS AND RELATED METHODS

(71) Applicant: Cambridge Glycoscience Ltd, Cambridge (GB)

(72) Inventors: Thomas J. SIMMONS, Cambridge (GB); Jeremy BARTOSIAK-JENTYS, Chester (GB)

(21) Appl. No.: 18/486,869

(22) Filed: Oct. 13, 2023

Related U.S. Application Data
(63) Continuation of application No. PCT/EP2022/061871, filed on May 3, 2022.
(60) Provisional application No. 63/183,576, filed on May 3, 2021.

(51) Int. Cl. A23L 33/24; A21D 2/18; A21D 2/36; A23L 27/30; A23P 10/40

(52) U.S. Cl. CPC A23L 33/24; A21D 2/188; A21D 2/36; A23L 27/33; A23P 10/40

(57) ABSTRACT

Compositions comprising soluble oligosaccharides and insoluble saccharides are provided. Methods for the formation of the compositions, food products, baked goods, or sweeteners, including the production of the saccharide particles, the saccharide particles with various ratios and properties of the saccharides, and the uses of the same are also provided.

### CROSS-REFERENCE

This application is a continuation of International Application No. PCT/EP2022/061871 filed May 3, 2022, which claims the benefit of U.S. Provisional Patent Application No. 63/183,576, filed May 3, 2021, which application is entirely incorporated herein by reference.

### BACKGROUND

Sugary foods and drinks are an important part of cultural and lifestyle habits across the world, but the sugar they contain has been linked to obesity, diabetes, poor dental health, and disruptive behavior in people. Obesity and diabetes have tripled since the 1970's. In 2016, close to two billion adults were overweight. Over 650 million of these adults were medically obese. Furthermore, about ten percent of world population suffered from diabetes in 2019.

Natural sugar substitutes have emerged as a choice as a sugar replacement in food and beverages. Compared to artificial sweeteners, they do not produce bitter undertones or other unpleasant tastes along with their sweetness, both of which consumers find unappealing. But sugar substitutes may disrupt gut flora, whether they are natural or not. Adding dietary fiber alongside sugar substitutes helps maintain digestive health and a well-regulated gut flora. Such fiber includes saccharides of varying chain lengths and types. In addition to being found naturally in a wide spectrum of foods, fiber can also be produced separately and added to other foods during their manufacture.

However, dietary fiber can decrease the functional performance of the food, and in turn, the appeal of the food to the public. Hence, methods and compositions to incorporating fibers into food and beverage without compromising the functional performance of the food are sought.

Consumer demand for sustainability and biodegradability in cosmetic, home care, personal care products, and the like, are major challenges for companies operating in those industries. Current products are too often derived from petrochemical products, or from other such unsustainable raw materials, and often comprise components that are non-biodegradable, such as microplastics.

Because plant fibers are sustainable to produce and entirely biodegradable, they have potential to be used to meet these currently unmet consumer needs. Hence, methods and compositions to incorporating fibers into cosmetic, home care, personal care products, and the like, without comprising the functional performance of the food are sought.

### SUMMARY

Disclosed herein are methods and compositions that incorporate fiber into consumable products (e.g., food, cosmetics, etc.) without compromising the functional performance of the consumable product (e.g. food, cosmetic, etc.).

Disclosed herein is a dry composition comprising a plurality of first particles, each first particle comprising a core component, a surface on the core, and a coating at least partially covering the surface. The core component may comprise insoluble saccharide. The coating component may comprise soluble saccharide. The plurality of first particles may comprise insoluble saccharide and soluble oligosaccharide in a weight ratio of insoluble saccharide to soluble oligosaccharide of from 99:1 to 50:50. In some embodiments, the soluble oligosaccharide is independently xylo-oligosaccharide, cello-oligosaccharide, manno-oligosaccharide, fructo-oligosaccharide, galacto-oligosaccharide, or a combination thereof. In some embodiments, the insoluble saccharide is cellulose; hemicellulose, xylan, mannan, glucan, microcrystalline cellulose (MCC), or a combination thereof. In some embodiments, the core component can comprise at least 80 wt. % insoluble saccharide. In some embodiments, the coating component can comprise at least 80 wt. % soluble oligosaccharide.

In some embodiments, the plurality of first particles has a D10 particle size from 25 μm to 100 μm, and a D90 particle size from 100 μm to 500 μm. In some embodiments, the insoluble saccharide comprises MCC, wherein MCC has a D50 particle size from 150 μm to 280 μm. In some embodiments, MCC has a D50 particle size from 90 μm to 140 μm. In some embodiments, MCC has a D50 particle size from 45 μm to 75 μm. In some embodiments, the plurality of particles collectively can comprise core component and coating component in a core component to coating component weight ratio of at least 1:1.

In some embodiments, the composition can further comprise a plurality of second particles. Each second particle can comprise soluble saccharide (e.g., wherein the soluble saccharide of the first particles and second particles is the same or different). In some embodiments, the composition may comprise insoluble saccharide and soluble oligosaccharide in a weight ratio of insoluble saccharide to soluble oligosaccharide of from 1:99 to 50:50. In some embodiments, a dry weight ratio of the plurality of second particles to the plurality of first particles can be at least 1:1. In some embodiments, the dry weight ratio of the plurality of second particles to the plurality of first particles is about 2:1, 4:1, 6:1, 8:1, 10:1, 15:1, 20:1, 25:1, 30:1, 35:1, 40:1, 45:1, 50:1; 55:1, 60:1; 65:1, 70:1, 75:1, 80:1; 85:1, 90:1, 95:1, or 99:1. In some embodiments, the another soluble oligosaccharide is independently xylo-oligosaccharide, cello-oligosaccharide, manno-oligosaccharide, fructo-oligosaccharide, galacto-oligosaccharide, or a combination thereof. In some embodiments, the soluble saccharide of the second of particles can be the same as the soluble saccharide of the coating component of the first particles. In some embodiments, the soluble saccharide of the first particles and the second particles can be independently selected from the group consisting of xylo-oligosaccharide, cello-oligosaccharide, manno-oligosaccharide, fructo-oligosaccharide, galacto-oligosaccharide, or a combination thereof. In some embodiments, each second particle further comprises a third soluble oligosaccharide, wherein the third soluble oligosaccharide is different from the another soluble oligosaccharide. In some embodiments, the dry composition further comprises a plurality of third particles, each third particle comprising a third soluble oligosaccharide, wherein the third soluble oligosaccharide is different from the another soluble oligosaccharide. In some embodiments, the third soluble oligosaccharide is independently xylo-oligosaccharide, cello-oligosaccharide, manno-oligosaccharide, fructo-oligosaccharide, galacto-oligosaccharide, or a combination thereof. In some embodiments, the insoluble saccharide can comprise at least two saccharides selected from the group consisting of a cellulose; a xylan; and a mannan. In some embodiments, the insoluble saccharide can comprise a multimolecular complex of cellulose and hemicellulose. In some embodiments, the core component can further comprise a polyaromatic compound. In some embodiments, the insoluble saccharide can comprise microcrystalline cellulose (MCC).

In some embodiments, the insoluble saccharide can comprise greater than 20% cellulose. In some embodiments, the insoluble saccharide can comprise greater than 1% xylan. In some embodiments, the insoluble saccharide can comprise less than 70% xylan. In some embodiments, the insoluble saccharide can comprise greater than 1% mannan. In some embodiments, the insoluble saccharide can comprise less than 70% mannan. In some embodiments, the insoluble saccharide can comprise greater than 0.1% mixed-linkage glucan. The insoluble saccharide can comprise less than 17.5% mixed-linkage glucan. In some embodiments, the insoluble saccharide can comprise greater than 0.1 wt. % xyloglucan. In some embodiments, the insoluble saccharide can comprise less than 17.5 wt. % xyloglucan. In some embodiments, the insoluble saccharide can comprise greater than 0.1 wt. % fructan. In some embodiments, the insoluble saccharide can comprise less than 99 wt. % fructan. In some embodiments, the insoluble saccharide can comprise greater than 0.1 wt. % galactan. In some embodiments, the insoluble saccharide can comprise less than 99 wt. % galactan. In some embodiments, the insoluble saccharide can comprise greater than 0.1 wt. % pectin. In some embodiments, the insoluble saccharide can comprise less than 17.5 wt. % pectin. In some embodiments, the soluble saccharide can comprise xylo-oligosaccharides with degrees of polymerization of two to twelve. In some embodiments, the soluble saccharide can comprise cello-oligosaccharides with degrees of polymerization of two to six. In some embodiments, the composition is a sweetener composition. In some embodiments, the first plurality of dried particles can have a D10 particle size of 25 μm to 100 μm. The first plurality of dried particles can have a D90 particle size of 100 μm to 500 μm.

Disclosed herein is a method of producing a dry composition comprising: (a) providing a mixture of (i) soluble oligosaccharide(s) (e.g., dissolved) in a liquid medium, and (ii) insoluble saccharide(s); (b) drying the mixture to form a plurality of first particles, each first particle comprising a core component, a surface on the core, and a coating at least partially covering the surface, the core component comprising insoluble saccharide(s), the coating component comprising soluble oligosaccharide(s). In some embodiments, a dry weight ratio of the soluble oligosaccharide to the insoluble saccharide in the dry composition is from 1:99 to 50:50. In some embodiments, drying can be performed via spray drying. In some embodiments, drying can be performed via spray granulation. In some embodiments, drying can be performed via vacuum drying. In some embodiments, drying can be performed via freeze drying. In some embodiments, drying can be performed via spray drying, spray granulation, vacuum drying, freeze drying, or a combination thereof. In some embodiments, the insoluble saccharide can be provided a liquid medium. In some embodiments, the liquid medium further comprises a second soluble oligosaccharide, and wherein the second soluble oligosaccharide is different from the soluble oligosaccharide. In some embodiments, drying can further comprise drying a second plurality of particles wherein each particle of the second plurality of particles comprises soluble saccharides. In some embodiments, the soluble saccharides of the second plurality of particles can be the same as the soluble saccharide of the coating component.

In some embodiments, a dry weight ratio of the plurality of second particles to the plurality of first particles is at least 1:1. In some embodiments, the dry weight ratio of the plurality of second particles to the plurality of first particles is about 2:1, 4:1, 6:1, 8:1, 10:1, 15:1, 20:1, 25:1, 30:1, 35:1, 40:1, 45:1, 50:1; 55:1, 60:1; 65:1, 70:1, 75:1, 80:1; 85:1, 90:1, 95:1, or 99:1.

In some embodiments, the soluble saccharides can comprise one or more of xylo-oligosaccharide, cello-oligosaccharide, manno-oligosaccharide, fructo-oligosaccharide, galacto-oligosaccharide, or a combination thereof. In some embodiments, the insoluble saccharides can comprise at least one of: (i) a cellulose; (ii) a xylan; (iii) a mannan; (iv) a mixed-linkage glucan; (v) a xyloglucan; (vi) a fructan; (vii) a galactan; or (viii) a pectin. In some embodiments, the insoluble saccharides can comprise at least two of: (i) a cellulose; (ii) a xylan; or (iii) a mannan; (iv) a mixed-linkage glucan; (v) a xyloglucan; (vi) a fructan; (vii) a galactan; or (viii) a pectin. In some embodiments, the saccharides can comprise microcrystalline cellulose (MCC). In some embodiments, the insoluble saccharides can comprise greater than 20% cellulose. In some embodiments, the insoluble saccharides can comprise greater than 1% xylan. In some embodiments, the insoluble saccharides can comprise less than 70% xylan. In some embodiments, the insoluble saccharides can comprise greater than 1% mannan. In some embodiments, the insoluble saccharides can comprise less than 70% mannan. In some embodiments, the soluble saccharides can comprise xylo-oligosaccharides with degrees of polymerization of two to twelve. In some embodiments, the soluble saccharides can comprise cello-oligosaccharide with degrees of polymerization of two to six. In some embodiments, the plurality of particles can have a D10 particle size of 25 μm to 100 μm. In some embodiments, the plurality of particles can have a D90 particle size of 100 μm to 500 μm. In some embodiments, the method can further comprise diluting the soluble oligosaccharide to a concentration of between 20-90 wt. %. In some embodiments, drying can further comprise drying a third plurality of dried particles comprising insoluble saccharide(s). In some embodiments, drying can further comprise forming a first plurality of dried particles, a second plurality of dried particles, and a third plurality of dried particles, wherein a ratio of the first plurality of dried particles to the second plurality of dried particles and the third plurality of dried particles collectively is 1:99 to 50:50. In some embodiments, the method can comprise providing the insoluble saccharides and soluble oligosaccharides in a weight ratio of 99:1 to 50:50.

In some circumstances, adding insoluble saccharide to soluble saccharide solutions improves the behavior of said soluble saccharides during drying processes, and can reduce the undesirable tendency to stick to surfaces. In some circumstances, compositions of insoluble saccharides and soluble saccharides that are dried together, for example by spray drying, can more faithfully mimic the properties of sucrose in food products.

In various embodiments, compositions provided herein are prepared according to any suitable process, such as the co-drying technique described herein (e.g., spray drying).

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. The patent of application file contains at least one drawing executed in color. Copies of this patent or patent application publication with color drawing(s) will be provided by the Office upon request and payment of the necessary fee. A better understanding of the features and advantages of the present disclosure will be obtained by reference to the following detailed description that sets forth illustrative embodiments, in which the principles of the disclosure are utilized, and the accompanying drawings of which:

FIG. 1 shows the particle size profile of partially hydrolyzed corn cob fiber. The Y-axis shows the percentage (%) of the particle. The X-axis shows the diameter of the particle.

FIG. 2 shows the generation of unhydrolyzed corn cob fiber with a particle size of <200 μm and <500 μm. The Y-axis shows the sieve percentage (%) of particles retained. The X-axis shows the sieve diameter.

FIG. 3 shows whole baked cookies with various fibers. The cookies were pressed down on the baking tray.

FIG. 4 shows the response of consumers (n=13) when asked if they could feel a bitty/sandy mouthfeel in whole baked cookies with various fibers.

FIG. 5 shows a comparison of six different spray drying mixtures tested.

FIG. 6A shows a comparison of four different spray drying mixtures tested.

FIG. 6B shows a comparison of three different spray drying mixtures tested.

FIG. 7 shows a magnification of six different spray dried products at 1000× magnification and 5000× magnification.

FIG. 8 shows a magnification of seven different spray dried products at 1000× magnification and 5000× magnification.

FIG. 9A shows an image of cookies made with dry-mixed saccharides and spray dried saccharides pre and post baking.

FIG. 9B shows an image of cookies made with dry-mixed saccharides and spray granulated saccharides pre and post baking.

FIG. 10 shows a comparison of five different vacuum drying mixtures tested.

FIG. 11 shows a magnification of five different vacuum dried products at 1000× magnification and 5000× magnification.

FIG. 12 shows the image of BUCHI Mini Spray Dryer B-290 unit used in spray drying studies.

FIG. 13 shows (A) Yields of recovered spray dried product (%) with varying concentrations of MCC. (B) Percentage of spray dried material that stuck to the evaporation chamber.

FIG. 14 shows (A) SEM image of spray dried material with 0% MCC at 5000× magnification. (B) SEM image of spray dried material with 0% MCC at 1000× magnification. (C) SEM image of spray dried material with 0% MCC at 500× magnification. (D) SEM image of spray dried material with 10% MCC at 5000× magnification. (E) SEM image of spray dried material with 10% MCC at 1000× magnification. (F) SEM image of spray dried material with 10% MCC at 500× magnification. (G) SEM image of spray dried material with 15% MCC at 5000× magnification. (H) SEM image of spray dried material with 15% MCC at 1000× magnification. (I) SEM image of spray dried material with 15% MCC at 500× magnification. (J) SEM image of spray dried material with 20% MCC at 5000× magnification. (K) SEM image of spray dried material with 20% MCC at 1000× magnification. (L) SEM image of spray dried material with 20% MCC at 500× magnification.

FIG. 15 shows the hygroscopicity (%) of spray dried samples with varying concentrations of MCC incubated at 85% RH and 20° C. for 1 week.

FIG. 16 shows the before and after images of cookies prepared with spray dried product containing varying concentrations of MCC compared against a control prepared with dry mixed samples.

FIG. 17 shows the SEM images of MCC, UOF and POF at 1000× magnification.

FIG. 18 shows (panel A) SEM image of Trial A spray dried sample at 5000× magnification. (panel B) SEM image of Trial A spray dried sample at 1000× magnification. (panel C) SEM image of Trial A spray dried sample at 500× magnification. (panel D) SEM image of Trial B spray dried sample at 5000× magnification. (panel E) SEM image of Trial B spray dried sample at 1000× magnification. (panel F) SEM image of Trial B spray dried sample at 500× magnification. (panel G) SEM image of Trial C spray dried sample at 5000× magnification. (panel H) SEM image of Trial C spray dried sample at 1000× magnification. (panel I) SEM image of Trial C spray dried sample at 500× magnification. (panel J) SEM image of Trial D spray dried sample at 5000× magnification. (panel K) SEM image of Trial D spray dried sample at 1000× magnification. (panel L) SEM image of Trial D spray dried sample at 500× magnification. (panel M) SEM image of Trial E spray dried sample at 5000× magnification. (panel N) SEM image of Trial E spray dried sample at 1000× magnification. (panel O) SEM image of Trial E spray dried sample at 500× magnification.

FIG. 19A shows Hygroscopicity (%) of spray dried samples with differing soluble and insoluble saccharide compositions incubated at 85% RH and 20° C. for 1 week. FIG. 19B shows Particle size distribution (%) of MCC and POF.

FIG. 20 shows the before and after images of cookies prepared with spray dried product prepared in trials A-E compared against a control prepared with dry mixed samples.

FIG. 21 shows the SEM images at 5000× and 500× magnification of spray dried samples containing 15% MCC samples crushed using various techniques compared against intact samples.

FIG. 22A shows the SEM images at 100×, 500×, and 1000× of spray granulated material obtained in Example 4 for MCC Trials A, B, C and E in table 10. FIG. 22B shows the SEM images at 100×, 500×, and 1000× of spray granulated material obtained in Example 4 for MCC Trials D, F, and G in table 10

FIG. 23 shows the SEM images of spray dried samples from MCC trial F after being subjected to crushing by pestle and mortar, and liquid nitrogen compared to an intact sample at 100×, 500×, 1000× and 2000×.

### DETAILED DESCRIPTION

Described herein are insoluble saccharides that can be useful in food products, baked goods, sweeteners, nutraceuticals, cosmetics, home care or personal care goods. Also described are methods of forming or formulating the same. The insoluble saccharides may be obtained from partially hydrolyzed biomass. The insoluble saccharides may include lignin, cellulose, or hemicellulose. Adding the insoluble saccharides obtained from partially hydrolyzed biomass may improve the functional performance of the food products, baked goods, sweeteners, nutraceuticals, cosmetics, home care or personal care goods compared to those lacking the same.

Further adding insoluble saccharides alongside the soluble saccharides may improve the functional performance of the food products, baked goods, sweeteners, nutraceuticals, cosmetics, home care or personal care goods compared to those lacking the same. The soluble oligosaccharides may also include cello-oligosaccharides, xylo-oligosaccharides, and/or mannan-oligosaccharides.

Provided in various embodiments herein are compositions, sweetener compositions, nutraceutical compositions, cosmetic compositions, home care compositions or personal care compositions, foodstuffs comprising such a (e.g., sweetener) composition, methods of making such (e.g., sweetener) compositions, methods of making foodstuffs with such sweetener compositions, and the like. In certain embodiments, provided herein are compositions comprising a soluble oligosaccharide component and an insoluble saccharide component (e.g., comprising oligosaccharide and/or polysaccharide). In some embodiments, a composition provided herein comprises additional agents (e.g., monosaccharide(s)).

In certain embodiments, a composition provided herein comprises any suitable amount of soluble oligosaccharide and insoluble saccharide (e.g., having the DP, composition, size, shape or other parameters described herein), such as in a combined total amount of at least 50 dry wt. %. In some embodiments, a composition provided herein comprises any ratio of insoluble saccharide to soluble oligosaccharide (e.g., having the DP, composition, size, shape or other parameters described herein), such as in a weight ratio of at most 1:1 (e.g., 1:1 to 1:99).

In some specific embodiments, the soluble oligosaccharide component comprises soluble oligosaccharide having a DP of two to 20 (e.g., wherein the soluble oligosaccharide having a DP of two to 20 comprises a single DP or a mixture of DP within the two to 20 range).

In certain embodiments, a composition provided herein comprises any suitable amount of insoluble saccharide (e.g., having the DP, composition, size, shape or other parameters described herein) in a specific pH range, such as between 2 and 9, 2.5 and 8.5, 3 and 8, 3.5 and 7.75, 4 and 7.5, 4.5 and 7.25, 5 and 7. In some specific embodiments, pH-modulating compounds such as acids, bases, acidity regulators and pH buffers may be additionally found in the composition. In some specific embodiments the compositions may comprise organic acids including oxalate, tartrate, malate, succinate, lactate, formate, acetate, sorbic acid, acetic acid, benzoic acid, propionic acid, adipic acid, ammonium aluminum sulfate, ammonium bicarbonate, ammonium carbonate, ammonium citrate, dibasic, ammonium citrate monobasic, ammonium hydroxide, ammonium phosphate, dibasic, ammonium phosphate, monobasic, calcium acetate, calcium acid pyrophosphate, calcium carbonate, calcium chloride, calcium citrate, calcium fumarate, calcium gluconate, calcium hydroxide, calcium lactate, calcium oxide, calcium phosphate (dibasic), calcium phosphate (monobasic), calcium phosphate (tribasic), calcium sulfate, carbon dioxide, citric acid, cream of tartar, fumaric acid, gluconic acid, glucono-delta-lactone, hydrochloric acid, lactic acid, magnesium carbonate, magnesium citrate, magnesium fumarate, magnesium hydroxide, magnesium oxide, magnesium phosphate, magnesium sulfate, malic acid, manganese sulfate, metatartaric acid, phosphoric acid, potassium acid tartrate, potassium aluminum sulfate, potassium bicarbonate, potassium carbonate, potassium chloride, potassium citrate, potassium fumarate, potassium hydroxide, potassium lactate, potassium phosphate (dibasic), potassium phosphate (tribasic), potassium pyrophosphate (tetrabasic), potassium sulfate, potassium tartrate, potassium tripolyphosphate, sodium acetate, sodium acid pyrophosphate, sodium acid tartrate, sodium aluminum phosphate, sodium aluminum, sulfate, sodium bicarbonate, sodium bisulfate, sodium carbonate, sodium citrate, sodium fumarate, sodium gluconate, sodium hexametaphosphate, sodium hydroxide, sodium lactate, sodium phosphate (dibasic), sodium phosphate (monobasic), sodium phosphate (tribasic), sodium potassium hexametaphosphate, sodium potassium tartrate, sodium potassium tripolyphosphate, sodium pyrophosphate (tetrabasic), sodium tripolyphosphate, sulfuric acid, sulfurous acid, tartaric acid, a salt thereof, or a combination thereof.

In certain embodiments, a composition provided herein comprises any suitable amount of insoluble saccharide (e.g., having the DP, composition, size, shape or other parameters described herein), with two or more of the components described above. For example, a composition might comprise insoluble saccharide, protein and soluble polysaccharide. For example, a composition might comprise insoluble saccharide, soluble oligosaccharide and soluble polysaccharide. For example, a composition might comprise insoluble saccharide, protein, surfactant and soluble polysaccharide. In certain embodiments, a composition provided herein comprises five or more of the aforementioned components.

As used in the specification and claims, the singular forms “a,” “an,” and “the” include plural references unless the context clearly dictates otherwise. For example, the term “a sample” includes a plurality of samples, including mixtures thereof.

The term “about,” as used herein, can mean within 1 or more than 1 standard deviation. Alternatively, about can mean a range of up to 10%, up to 5%, or up to 1% of a given value. For example, “about” can mean up to ±10% of a given value. In more targeted instances, “about” can mean ±9%, ±8%, ±7%, ±6%, ±5%, ±4%, ±3%, ±2%, or 10% of a given value.

As used herein, “food” and “foodstuff” generally refer to any item destined for consumption, which may be consumption by a human or by any other animal. It may be food, feed, beverage, or an ingredient to be used in the production of any of the above.

As used herein, “nutraceutical” generally refers to any composition introduced into a human or other animal, whether by ingestion, injection, absorption, or any other method, for the purpose of providing nutrition to the human or other animal. Use of such a nutraceutical may take the form of a drink with added dietary fiber, a prebiotic additive, a pill or other capsule, or any other suitable use.

As used herein, “cosmetic” generally refers to any composition which is intended for use on humans or other animals or on products or materials used by humans or animals to increase the aesthetic appeal or prevent future loss of aesthetic appeal of said humans, animals, products or materials, as well as any other compositions known in general parlance as cosmetics. Aesthetic appeal is not limited to visual aesthetics but applies as well to textural or any other appeal. The cosmetic may be mascara, foundation, lip gloss, eyeshadow, eyeliner, primer, lipstick, blush, nail polish, bronzer, or any other makeup; shampoo, conditioner, styling mousse, styling gel, hairspray, hair dye, hair wax, or any other hair product; moisturizer, exfoliant, sun cream, face cream, cleanser, toothpaste, cream, lotion, ointment, or any other composition effective in modifying teeth, skin, hair, or other parts of the body in some aesthetic way. Further, the cosmetic may be a composition used as a component of a face mask, brush, hair roller, other styling device, other solid structure, or any other suitable composition. Further, the cosmetic may be a composition used as a component of all-purpose cleaners, abrasive cleaners, powders, liquids, scouring pads, non-abrasive cleaners, powder cleaners, liquid cleaners, spray cleaners, kitchen cleaners, bathroom cleaners, glass and metal cleaners, bleaches, disinfectants and disinfectant cleaners, drain openers, glass cleaners, glass and multi-surface cleaners, hard water mineral removers, metal cleaners and polishes, oven cleaners, shower cleaners, toilet bowl cleaners, tub cleaners, tile cleaners, sink cleaners, floor cleaners, furniture cleaners, carpet cleaners, rug cleaners, dusting products, floor care products, furniture cleaners, polishes and upholstery cleaners.

As used herein, “ingredient” generally refers to any composition suitable for incorporation into a foodstuff, cosmetic, or nutraceutical product, which may include those which are used directly as the product itself. It may be a dry or liquid ingredient unless it is specifically referred to as “dry” or “liquid.” This includes compositions that may be deemed to be an intermediate during a method of the disclosure, such as a composition formed after the combining of the one or more oligosaccharides and the one or more soluble polysaccharides prior to any further purification, optimization, drying, dissolving, or any other such steps, as well as including the final composition obtained from the method.

As used herein, “polysaccharide” generally refers to a saccharide polymer of any length greater than 20 residues. Polysaccharides may be highly branched, lightly branched, or unbranched. Polysaccharides may include any manner of glycosidic bond in any combination; any number of, for example, α or β linkages; and any combination of monomer types, such as glucose, glucosamine, mannose, xylose, galactose, fucose, fructose, glucuronic acid, arabinose, or derivatives thereof, such as any combination of the above monomers decorated with acetyl or other groups. The polysaccharide may be a cellulosic or hemicellulosic polymer. Hemicellulosic polymers envisaged include xylan, glucuronoxylan, arabinoxylan, glucomannan, and xyloglucan. In some embodiments, the cellulosic polymer may be cellulose.

As used herein, “cellulose” generally refers to polysaccharides composed of glucose residues linked by β-1,4-glycosidic bonds, and derivatives thereof. Cellulose can be found in crystalline or amorphous forms and cellulosic aggregates can comprise both crystalline and amorphous parts. Different types of crystallinities can also be found within cellulose, such as cellulose I-alpha, cellulose I-beta and cellulose II.

As used herein, “xylan” generally refers to polysaccharides composed of a backbone of xylose residues and may also contain glucuronic acid residues, arabinose residues and/or acetyl groups and/or any other modification. Derivatives of xylan include arabinoxylan, glucuronoxylan and arabinoglucuronoxylan. Unless otherwise stated, when used herein these types of xylans are used interchangeably to refer to any other.

As used herein, “mixed-linkage glucan” generally refers to polysaccharides composed of glucose residues linked by β-1,3-glycosidic bonds and β-1,4-glycosidic bonds. As used herein, “mannan” generally refers to polysaccharides composed of mannose residues and optionally containing glucose and/or galactose residues. Derivatives of mannan include glucomannan, galactomannan and galactoglucomannan. Unless otherwise stated, when used herein these types of mannans are used interchangeably to refer to any other.

As used herein, “chitin” or “chitosan” generally refer to polysaccharides composed of glucosamine and/or N-acetyl-glucosamine residues. As used herein, “pectin” generally refers to any galacturonic acid-containing saccharide, for example homogalacturonan and rhamnogalacturonan. The polysaccharides of cellulose, xylan, mixed-linkage glucan, mannan, chitin, or chitosan may include chemical variants that have been modified by oxidation, reduction, esterification, epimerization, or another chemical modification.

As used herein, “lignocellulose” generally refers to polysaccharide-comprising aggregates that are, or are derived from, plant cell wall material. For example, they may include one or more of lignin and/or the following polysaccharides associated together: cellulose, xylan, mannan, and mixed-linkage glucan.

As used herein “highly branched,” “lightly branched,” and “unbranched” generally refer to the number of side-chains per stretch of main chain in a saccharide. Highly branched saccharides have on average from 4 to 10 side chains per 10 main-chain residues, slightly branched saccharides have on average from 1 to 3 side chains per 10 main-chain residues, and unbranched saccharides have only one main chain and no side chains. The average is calculated by dividing the number of side chains in a saccharide by the number of main-chain residues.

As used herein, “saccharide” generally refers to any polysaccharide and/or oligosaccharide and/or monosaccharide and/or a disaccharide.

As used herein, “oligosaccharide” generally refers to saccharide polymers having chain lengths less than or equal to 20 saccharide residues (e.g., and at least two saccharide residues). Oligosaccharides may be highly branched, lightly branched, or unbranched; and may include glycosidic bonds in any combination, any number of a or 3 linkages, and any combination of monomer types, such as glucose, glucosamine, mannose, xylose, galactose, fucose, fructose, glucuronic acid, arabinose, or derivatives thereof. Suitable derivatives include the above monomers including acetyl or other groups.

As used herein, “monosaccharide” and “disaccharide” generally refer to saccharide compounds consisting of one or two residues, respectively. Monosaccharides are compounds such as glucose, glucosamine, xylose, galactose, fucose, fructose, glucuronic acid, arabinose, galacturonic acid, or epimers or other derivatives thereof. Suitable derivatives include acetyl or other groups. Disaccharides are compounds consisting of two monosaccharides joined via any glycosidic bond.

As used herein, “cello-oligosaccharides” generally refer to oligosaccharides composed of one or more glucose residues linked by β-1,4-glycosidic bonds, and may be chemically related to that by oxidation, reduction, esterification, epimerization, further glycosylation, or another chemical modification.

As used herein, “xylo-oligosaccharides” generally refer to oligosaccharides composed primarily of xylose residues (typically linked by β-1,4-glycosidic bonds) and may also contain glucuronic acid residues and/or arabinose residues and/or acetyl groups and/or any other modification, and may be chemically related to that by oxidation, reduction, esterification, epimerization, further glycosylation, or another chemical modification.

As used herein, “xyloglucan-oligosaccharides” generally refer to oligosaccharides composed primarily of glucose and xylose residues and may also contain galactose, fucose and/or arabinose residues and/or acetyl groups and/or any other modification, and may be chemically related to that by oxidation, reduction, esterification, epimerization, further glycosylation, or another chemical modification.

As used herein, “mixed-linkage glucan-oligosaccharides” generally refer to oligosaccharides composed of one or more glucose residues linked by at least one β-1,3-glycosidic bond and at least one β-1,4-glycosidic bond, and may be chemically related to that by oxidation, reduction, esterification, epimerization, further glycosylation, or another chemical modification.

As used herein, “xyloglucan” generally refers to polysaccharides composed of greater than 25% by weight of glucose residues and greater than 10% by weight xylose. As used herein, “fructan” generally refers to polysaccharides composed primarily of fructose residues. As used herein, “galactan” generally refers to polysaccharides composed primarily of galactose residues. The polysaccharides of xyloglucan, fructan, or galactan may include chemical variants that have been modified by oxidation, reduction, esterification, epimerization, or another chemical modification.

As used herein, “manno-oligosaccharides” or “mannan-oligosaccharides” generally refer to oligosaccharides composed of one or more mannose residues and optionally containing one or more glucose and/or galactose residues, and may be chemically related to that by oxidation, reduction, esterification, epimerization, further glycosylation, or another chemical modification.

As used herein, “chito-oligosaccharides” generally refer to oligosaccharides composed of one or more glucosamine and/or N-acetyl-glucosamine residues, and may be chemically related to that by oxidation, reduction, esterification, epimerization, further glycosylation, or another chemical modification.

As used herein, “fructo-oligosaccharides” (FOS) generally refer to oligosaccharides composed of one or more fructose residues, and may be chemically related to that by oxidation, reduction, esterification, epimerization, or another chemical modification.

As used herein, “galacto-oligosaccharides” (GOS) generally refer to oligosaccharides composed of one or more galactose residues and optionally containing one or more glucose residues, and may be chemically related to that by oxidation, reduction, esterification, epimerization, or another chemical modification.

As used herein, “malto-oligosaccharides” or “maltodextrins” (MD) generally refer to oligosaccharides composed of one or more glucose residues linked by at least one alpha-bond, and may be chemically related to that by oxidation, reduction, esterification, epimerization, or another chemical modification.

As used herein, “lignin” generally refers to polymeric or oligomeric structures composed of aromatic subunits (generally having been constructed within plants via non-enzymatic coupling reactions) such as lignols, or products of lignin thermochemical breakdown/depolymerization.

As used herein, “soluble” generally refers to a compound that that can be solubilized in a pH-neutral aqueous medium at or below a given concentration. Relevant concentrations are between 10 and 100 g/L. Soluble oligosaccharides can include cello-oligosaccharides of DP 2-6, xylo-oligosaccharides of DP 2-10, mannan-oligosaccharides of DP 2-6 and mixed-linkage glucan oligosaccharides of DP 3-10. Soluble polysaccharides can include hemicellulose, pectin, xylan, mannan, mixed-linkage glucan, inulin, fructan, arabinan and xyloglucan.

As used herein, “insoluble” generally refers to a compound that may not be solubilized in a pH-neutral aqueous medium at or below a given concentration. Relevant concentrations can be between 1 and 10 g/L. It may be the case that a given compound is insoluble in a pH-neutral aqueous medium at any concentration. Compounds that could become soluble in a pH-neutral aqueous medium upon thermochemical treatment can be classified as insoluble until such a thermochemical treatment has enabled their solubility. Insoluble saccharides can include cellulose as well as aggregates containing cellulose complexed with other compounds (including xylan, mannan, mixed-linkage glucan and lignin) such as lignocellulose.

As used herein, in some instances, “pre-treatment” is any process which makes a feedstock more easily acted upon by the enzymes in the enzymatic reaction step. The pre-treatment can occur before the enzymatic reaction, and may comprise acid treatment by, for example, sulphuric acid, phosphoric acid, or trifluoroacetic acid; alkali treatment by, for example, potassium hydroxide, sodium hydroxide, or ammonia fiber expansion; heat treatment by, for example, hot water, hot steam, or hot acid; ionic liquid treatment, and related technologies; Alcell pulping, and related technologies; supercritical solvent, such as supercritical water treatment; and/or enzyme treatment by, for example, a hydrolase, lyase, or LPMO, or any mixture of the above processes.

### Compositions Having Soluble Oligosaccharides and Insoluble Saccharides

A composition may comprise a soluble oligosaccharide component and an insoluble saccharide component. The soluble oligosaccharide and the insoluble saccharide components described herein may be used to formulate a food product, baked good, or sweetener. The saccharide components may comprise one or more of any type of saccharide. A saccharide may be a monosaccharide. A saccharide may be a disaccharide. A saccharide may be an oligosaccharide. A saccharide may be a polysaccharide. For example, the saccharide component may comprise one or more monosaccharides, disaccharides, oligosaccharides, polysaccharides, any derivatives thereof, or a combination thereof.

### Insoluble Saccharides

In some embodiments, the insoluble saccharide component of the composition may have a DP of at least 20. The insoluble saccharide may have a DP of 20 to 20,000. The insoluble saccharide may have a DP of 40 to 10,000. In some cases, the insoluble saccharide may have a DP of 50 to 5,000. In other cases, the insoluble saccharide may have a DP of 60 to 2,500. The insoluble saccharide may also have a DP of 70 to 2,000. In some cases, the insoluble saccharide may have a DP of 75 to 1,500. In some embodiments, the insoluble saccharide component of the composition may have a DP of 20 to 200. The insoluble saccharide component of the composition may have a DP of 25 to 500. In some cases, the insoluble saccharide may have a DP of 30 to 500. The insoluble saccharide component of the composition may have a DP of 40 to 600. In some cases, the insoluble saccharide may have a DP of 50 to 700. The insoluble saccharide component of the composition may have a DP of 60 to 1,000. In some cases, the insoluble saccharide may have a DP of 70 to 1,500. The insoluble saccharide component of the composition may have a DP of 80 to 2,000. In some cases, the insoluble saccharide may have a DP of 90 to 5,000. The insoluble saccharide component of the composition may have a DP of 100 to 10,000.

The insoluble saccharide component of the composition may comprise partially hydrolyzed biomass. The biomass may comprise grain, grain chaff, bean pods, seed coats, seed materials, seaweeds, corn cob, corn stover, straw, wheat straw, rice straw, soy stalk, bagasse, sugar cane bagasse, miscanthus, sorghum residue, switch grass, bamboo, monocotyledonous tissue, dicotyledonous tissue, fern tissue, water hyacinth, leaf tissue, roots, vegetative matter, vegetable material, vegetable waste, hardwood, hardwood chips, hardwood pulp, softwood, softwood chips, softwood pulp, paper, paper pulp, cardboard, wood-based feedstocks, crab shells, squid biomass, shrimp shells, marine biomass, other suitable feedstocks, or a combination thereof. In some cases, the biomass may be microcrystalline cellulose (MCC). In some cases, the biomass may comprise plant biomass. The plant biomass may comprise corn. The corn for the biomass may comprise corn or maize. The corn for the biomass may comprise corn stover or corn straw. Corn stover may comprise corn leaves, stalks, or cobs. In other cases, the biomass may comprise lignocellulosic biomass. The plant biomass may comprise wood biomass or grass biomass. In some cases, the plant biomass may comprise bamboo, grass, hardwood stem, nut-shell, rice straw, softwood stem, sugar cane bagasse, switch grass, or wheat straw. In various cases, a plant biomass may comprise sugar cane, wheat, sugar beet, switchgrass, miscanthus, poplar, willow, or sweet potato. In some cases, the plant biomass may comprise oat fiber, oat hulls or oat husks.

The soluble saccharide and the insoluble saccharide may be obtained from the biomass by hydrolysis, including by partial hydrolysis. In some cases, the method may comprise obtaining the soluble saccharide and the insoluble saccharide from the same biomass. In some cases, the method may comprise obtaining the soluble saccharide and the insoluble saccharide from the same biomass and the same hydrolysis reaction. In some cases, the method may comprise obtaining the soluble saccharide in the form of oligosaccharides by partial hydrolysis of a plant biomass and may comprise obtaining the insoluble saccharide in the form of the remaining undigested biomass. In some instances, the partial hydrolysis may be an enzyme-based hydrolysis. In some instances, the partial hydrolysis may be an acid-based hydrolysis. In some instances, the partial hydrolysis may be a combination of one or more hydrolysis methods. In general, partial hydrolysis of the biomass may include any form of hydrolysis of acetyl groups from hemicellulose. It may comprise other methods of digesting biomasses and reduce the average degree of polymerization of the biomass.

In some instances, the insoluble saccharide component of the composition may comprise lignin, xylan, or a combination thereof. The insoluble saccharide may comprise lignin. The insoluble saccharide may comprise xylan. The insoluble saccharide may comprise mannan. The insoluble saccharide may comprise mixed-linkage glucan. The insoluble saccharide may also comprise pectin. In some cases, the insoluble saccharide may comprise cellulose. In certain cases, the insoluble saccharide may comprise a multimolecular complex of cellulose and hemicellulose. The insoluble saccharide may comprise hemicellulose. Hemicellulose of the composition, in some cases, may comprise xylan, glucuronoxylan, arabinoxylan, glucuronoarabinoxylan, glucomannan, galactoglucomannan and/or xyloglucan. The insoluble saccharide may also comprise a polyaromatic compound. A polyaromatic compound may comprise lignin. In other cases, the polyaromatic compound may comprise an aromatic ring. In some cases, the insoluble saccharide may comprise various percentages of cellulose, lignin, hemicellulose, and/or pectin by dry wt. %. In some cases, the plant source of the insoluble saccharide may determine the percentages of cellulose, lignin, hemicellulose, or pectin of the insoluble saccharide by dry weight. For example, corn cob biomass can comprise about 45 dry wt. % of cellulose, about 35 dry wt. % hemicellulose, and/or about 15 dry wt. % lignin. In another example, corn stover biomass can comprise about 35 dry wt. % to 40 dry wt. % of cellulose by dry weight, about 21 dry wt. % to 25 dry wt. % hemicellulose, and/or about 11 dry wt. % to 19 dry wt. % lignin.

The insoluble saccharide component of the composition may comprise fiber. A fiber may comprise a plant fiber. A plant fiber may comprise a plant stem fiber, a plant leaf fiber, or a plant seed-hair fiber. A plant stem fiber, for example, may be derived from the fibrous materials in the inner bark of the plant stem (e.g., a bast fiber). The plant stem fiber may also comprise a wood fiber. Plant fibers may comprise sugar cane, corn, wheat, sugar beet, switchgrass, miscanthus, poplar, willow, sweet potato, cotton, hemp, jute, flax, ramie, sisal, or bagasse.

The insoluble saccharide component of the composition may comprise cellulose at greater than 40% dry w/w. The insoluble saccharide component of the composition may comprise cellulose at greater than 50% dry w/w. The insoluble saccharide component of the composition may comprise cellulose at greater than 60% dry w/w. The insoluble saccharide component of the composition may comprise cellulose at greater than 70% dry w/w. The insoluble saccharide component of the composition may comprise cellulose at greater than 80% dry w/w. The insoluble saccharide component of the composition may comprise cellulose at greater than 90% dry w/w. The insoluble saccharide component of the composition may comprise cellulose at less than 99% dry w/w. The insoluble saccharide component of the composition may comprise cellulose at less than 97.5% dry w/w. The insoluble saccharide component of the composition may comprise cellulose at less than 95% dry w/w. The insoluble saccharide component of the composition may comprise cellulose at less than 94% dry w/w. The insoluble saccharide component of the composition may comprise cellulose at less than 93% dry w/w. The insoluble saccharide component of the composition may comprise cellulose at less than 92% dry w/w. The insoluble saccharide component of the composition may comprise cellulose at less than 91% dry w/w. The insoluble saccharide component of the composition may comprise cellulose at less than 80% dry w/w. The insoluble saccharide component of the composition may comprise cellulose at less than 70% dry w/w.

The insoluble saccharide component of the composition may comprise hemicellulose at greater than 2.5% dry w/w. The insoluble saccharide component of the composition may comprise hemicellulose at greater than 5% dry w/w. The insoluble saccharide component of the composition may comprise hemicellulose at greater than 7.5% dry w/w. The insoluble saccharide component of the composition may comprise hemicellulose at greater than 10% dry w/w. The insoluble saccharide component of the composition may comprise hemicellulose at less than 50% dry w/w. The insoluble saccharide component of the composition may comprise hemicellulose at less than 40% dry w/w. The insoluble saccharide component of the composition may comprise hemicellulose at less than 30% dry w/w. The insoluble saccharide component of the composition may comprise hemicellulose at less than 20% dry w/w. The insoluble saccharide component of the composition may comprise hemicellulose at less than 15% dry w/w.

The insoluble saccharide component of the composition may comprise xylan at greater than 1% dry w/w. The insoluble saccharide component of the composition may comprise xylan at greater than 2.5% dry w/w. The insoluble saccharide component of the composition may comprise xylan at greater than 5% dry w/w. The insoluble saccharide component of the composition may comprise xylan at greater than 7.5% dry w/w. The insoluble saccharide component of the composition may comprise xylan at greater than 10% dry w/w. The insoluble saccharide component of the composition may comprise xylan at less than 70% dry w/w. The insoluble saccharide component of the composition may comprise xylan at less than 60% dry w/w. The insoluble saccharide component of the composition may comprise xylan at less than 50% dry w/w. The insoluble saccharide component of the composition may comprise xylan at less than 40% dry w/w. The insoluble saccharide component of the composition may comprise xylan at less than 30% dry w/w. The insoluble saccharide component of the composition may comprise xylan at less than 20% dry w/w. The insoluble saccharide component of the composition may comprise xylan at less than 15% dry w/w.

The insoluble saccharide component of the composition may comprise mannan at greater than 1% dry w/w. The insoluble saccharide component of the composition may comprise mannan at greater than 2.5% dry w/w. The insoluble saccharide component of the composition may comprise mannan at greater than 5% dry w/w. The insoluble saccharide component of the composition may comprise mannan at greater than 7.5% dry w/w. The insoluble saccharide component of the composition may comprise mannan at greater than 10% dry w/w. The insoluble saccharide component of the composition may comprise mannan at less than 70% dry w/w. The insoluble saccharide component of the composition may comprise mannan at less than 60% dry w/w. The insoluble saccharide component of the composition may comprise mannan at less than 50% dry w/w. The insoluble saccharide component of the composition may comprise mannan at less than 40% dry w/w. The insoluble saccharide component of the composition may comprise mannan at less than 30% dry w/w. The insoluble saccharide component of the composition may comprise mannan at less than 20% dry w/w. The insoluble saccharide component of the composition may comprise mannan at less than 15% dry w/w.

The insoluble saccharide component of the composition may comprise mixed-linkage glucan at greater than 0.1% dry w/w. The insoluble saccharide component of the composition may comprise mixed-linkage glucan at greater than 0.5% dry w/w. The insoluble saccharide component of the composition may comprise mixed-linkage glucan at greater than 1% dry w/w. The insoluble saccharide component of the composition may comprise mixed-linkage glucan at greater than 10% dry w/w. The insoluble saccharide component of the composition may comprise mixed-linkage glucan at less than 30% dry w/w. The insoluble saccharide component of the composition may comprise mixed-linkage glucan at less than 20% dry w/w. The insoluble saccharide component of the composition may comprise mixed-linkage glucan at less than 17.5% dry w/w. The insoluble saccharide component of the composition may comprise mixed-linkage glucan at less than 15% dry w/w. The insoluble saccharide component of the composition may comprise mixed-linkage glucan at less than 10% dry w/w.

The insoluble saccharide component may be formulated as particles. The insoluble saccharide component may have a particle size from 20 microns to 500 microns. In some cases, the particle size of the insoluble saccharide component is from 30 microns to 300 microns. In some cases, the particle size of the insoluble saccharide component is from 30 microns to 100 microns. In some cases, the particle size of the insoluble saccharide component is from 30 microns to 50 microns.

The particle size of the insoluble saccharide component is from 30 microns to 500 microns. The particle size of the insoluble saccharide component is from at least 30 microns. The particle size of the insoluble saccharide component is from at most 500 microns. The particle size of the insoluble saccharide component is from 30 microns to 50 microns, 30 microns to 80 microns, 30 microns to 100 microns, 30 microns to 150 microns, 30 microns to 200 microns, 30 microns to 250 microns, 30 microns to 300 microns, 30 microns to 350 microns, 30 microns to 400 microns, 30 microns to 450 microns, 30 microns to 500 microns, 50 microns to 80 microns, 50 microns to 100 microns, 50 microns to 150 microns, 50 microns to 200 microns, 50 microns to 250 microns, 50 microns to 300 microns, 50 microns to 350 microns, 50 microns to 400 microns, 50 microns to 450 microns, 50 microns to 500 microns, 80 microns to 100 microns, 80 microns to 150 microns, 80 microns to 200 microns, 80 microns to 250 microns, 80 microns to 300 microns, 80 microns to 350 microns, 80 microns to 400 microns, 80 microns to 450 microns, 80 microns to 500 microns, 100 microns to 150 microns, 100 microns to 200 microns, 100 microns to 250 microns, 100 microns to 300 microns, 100 microns to 350 microns, 100 microns to 400 microns, 100 microns to 450 microns, 100 microns to 500 microns, 150 microns to 200 microns, 150 microns to 250 microns, 150 microns to 300 microns, 150 microns to 350 microns, 150 microns to 400 microns, 150 microns to 450 microns, 150 microns to 500 microns, 200 microns to 250 microns, 200 microns to 300 microns, 200 microns to 350 microns, 200 microns to 400 microns, 200 microns to 450 microns, 200 microns to 500 microns, 250 microns to 300 microns, 250 microns to 350 microns, 250 microns to 400 microns, 250 microns to 450 microns, 250 microns to 500 microns, 300 microns to 350 microns, 300 microns to 400 microns, 300 microns to 450 microns, 300 microns to 500 microns, 350 microns to 400 microns, 350 microns to 450 microns, 350 microns to 500 microns, 400 microns to 450 microns, 400 microns to 500 microns, or 450 microns to 500 microns. The particle size of the insoluble saccharide component is from 30 microns, 50 microns, 80 microns, 100 microns, 150 microns, 200 microns, 250 microns, 300 microns, 350 microns, 400 microns, 450 microns, or 500 microns.

In some embodiments, the particle size of the insoluble saccharide, such as MCC, may impact its stability to act as a carrier during the spray granulation process.

A consumable composition such as a food product or a baked good comprising the insoluble saccharide component may comprise non-enzymatic breakdown products, such as deoxyosone, an osulose, a furan-2-aldehyde, a two-carbon alpha-dicarbonyl compound, a two-carbon hydroxycarbonyl compound, a three-carbon alpha-dicarbonyl compound, a three-carbon hydroxycarbonyl compound, a four-carbon alpha-dicarbonyl compound, a four-carbon hydroxycarbonyl compound, a glycoxal, a glycolaldehyde, a glycosylamine, a deoxyglycosyl amino acid, a deoxyglycosyl peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butylcyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol, alpha hexylcinnamaldehyde, vinyl phenol, vanillin, hexadecanoic acid, or a combination thereof.

### Soluble Oligosaccharides

In some embodiments, the soluble oligosaccharide of the composition may have a degree of polymerization (DP) of two to 20. The soluble oligosaccharide may have a DP of two to 15. The soluble oligosaccharide may have a DP of two to ten. In some cases, the soluble oligosaccharide may have a DP of two to five. In other cases, the soluble oligosaccharide may have a DP of three to 20. The soluble oligosaccharide may also have a DP of three to 15. In some cases, the soluble oligosaccharide may have a DP of three to 10. The soluble oligosaccharide of the composition may have a DP of four to 20. In some cases, the soluble oligosaccharide may have a DP of five to 20. The soluble oligosaccharide of the composition may have a DP of six to 20. In some cases, the soluble oligosaccharide may have a DP of seven to 20. The soluble oligosaccharide of the composition may have a DP of eight to 20. In some cases, the soluble oligosaccharide may have a DP of nine to 20. The soluble oligosaccharide of the composition may have a DP of ten to 20.

The insoluble saccharide of the composition may comprise partially hydrolyzed biomass. The biomass may comprise grain, grain chaff, bean pods, seed coats, seed materials, seaweeds, corn cob, corn stover, straw, wheat straw, rice straw, soy stalk, bagasse, sugar cane bagasse, miscanthus, sorghum residue, switch grass, bamboo, monocotyledonous tissue, dicotyledonous tissue, fern tissue, water hyacinth, leaf tissue, roots, vegetative matter, vegetable material, vegetable waste, hardwood, hardwood chips, hardwood pulp, softwood, softwood chips, softwood pulp, paper, paper pulp, cardboard, wood-based feedstocks, crab shells, squid biomass, shrimp shells, marine biomass, other suitable feedstocks, or a combination thereof. In some cases, the biomass may comprise plant biomass. The plant biomass may comprise corn. The corn for the biomass may comprise corn or maize. The corn for the biomass may comprise corn stover or corn straw. Corn stover may comprise corn leaves, stalks, or cobs. In other cases, the biomass may comprise lignocellulosic biomass. The plant biomass may comprise wood biomass or grass biomass. In some cases, the plant biomass may comprise bamboo, grass, hardwood stem, nut shell, rice straw, softwood stem, sugar cane bagasse, switch grass, or wheat straw. In various cases, a plant biomass may comprise sugar cane, wheat, sugar beet, switchgrass, miscanthus, poplar, willow, or sweet potato. In some cases, the plant biomass may comprise oat fiber, oat hulls or oat husks.

The soluble saccharide and the insoluble saccharide may be obtained from the biomass by hydrolysis, including by partial hydrolysis. In some cases, the method may comprise obtaining the soluble saccharide and the insoluble saccharide from the same biomass. In some cases, the method may comprise obtaining the soluble saccharide and the insoluble saccharide from the same biomass and the same hydrolysis reaction. In some cases, the method may comprise obtaining the soluble saccharide in the form of oligosaccharides by partial hydrolysis of a plant biomass and may comprise obtaining the insoluble saccharide in the form of the remaining undigested biomass.

The soluble oligosaccharide of the composition may comprise at least one of a: (i) cello-oligosaccharide; (ii) xylo-oligosaccharide; or (iii) mannan-oligosaccharide. In some cases, the soluble oligosaccharide of the composition may comprise at least two of a: (i) cello-oligosaccharide; (ii) xylo-oligosaccharide; or (iii) mannan-oligosaccharide. For example, the soluble oligosaccharide of the composition may include a cello-oligosaccharide and a xylo-oligosaccharide but lack a mannan-oligosaccharide. In other cases, the soluble oligosaccharide may comprise a cello-oligosaccharide, a xylo-oligosaccharide, and a mannan-oligosaccharide. The soluble oligosaccharide may comprise a cello-oligosaccharide and a xylo-oligosaccharide. The soluble oligosaccharide may comprise a cello-oligosaccharide and a mannan-oligosaccharide. The soluble oligosaccharide may comprise a xylo-oligosaccharide and a mannan-oligosaccharide.

The soluble oligosaccharide of the composition may comprise a cello-oligosaccharide and a xylo-oligosaccharide. In certain instances, the weight ratio of the cello-oligosaccharide to the xylo-oligosaccharide may be 2:98 to 50:50, 5:95 to 40:60, 7.5:92.5 to 30:70, or 10:90 to 25:75. In some cases, the weight ratio of the cello-oligosaccharide to the xylo-oligosaccharide may be 2:98 to 50:50. In certain cases, the weight ratio of the cello-oligosaccharide to the xylo-oligosaccharide may be 5:95 to 40:60. In various cases, the weight ratio of the cello-oligosaccharide to the xylo-oligosaccharide may be 7.5:92.5 to 30:70. In some cases, the weight ratio of the cello-oligosaccharide to the xylo-oligosaccharide may be 10:90 to 25:75. In certain embodiments, the weight ratio of the cello-oligosaccharide to the xylo-oligosaccharide may be 10:90 to 25:75, 12.5:87.5 to 20:80, 15:85 to 15:85, 17.5:82.5 to 10:90, or 20:80 to 5:95.

The soluble oligosaccharide of the composition may comprise a cello-oligosaccharide and a mannan-oligosaccharide, the weight ratio of the cello-oligosaccharide to the mannan-oligosaccharide may be 2:98 to 50:50, 5:95 to 40:60, 7.5:92.5 to 30:70, or 10:90 to 25:75. In some cases, the weight ratio of the cello-oligosaccharide to the mannan-oligosaccharide may be 2:98 to 50:50. In some cases, the weight ratio of the cello-oligosaccharide to the mannan-oligosaccharide may be 5:95 to 40:60. In some cases, the weight ratio of the cello-oligosaccharide to the mannan-oligosaccharide may be 7.5:92.5 to 30:70. In some cases, the weight ratio of the cello-oligosaccharide to the mannan-oligosaccharide may be 10:90 to 25:75. In some embodiments, the weight ratio of the cello-oligosaccharide to the mannan-oligosaccharide may be 10:90 to 25:75, 12.5:87.5 to 20:80, 15:85 to 15:85, 17.5:82.5 to 10:90, or 20:80 to 5:95.

In some embodiments, the cello-oligosaccharide of the composition may have a DP of two to six. The cello-oligosaccharide may have a DP of two to nine. The cello-oligosaccharide may have a DP of two to eight. The cello-oligosaccharide may have a DP of two to seven. The cello-oligosaccharide may have a DP of two to five. The cello-oligosaccharide may have a DP of two to four. The cello-oligosaccharide may have a DP of two. The cello-oligosaccharide may have a DP of three. The cello-oligosaccharide may have a DP of four. The cello-oligosaccharide may have a DP of five. The cello-oligosaccharide may have a DP of six. The cello-oligosaccharide may also have a degree of two to 20, two to 19, two to 18, two to 17, two to 16, two to 15, two to 14, two to 13, two to 12, two to 11, or two to ten.

In some embodiments, a sweetener composition may comprise cello-oligosaccharides. The sweetener composition may comprise from 5% to 20% w/w cello-oligosaccharides. The sweetener composition may comprise from at least 5% w/w cello-oligosaccharides. The sweetener composition may comprise from at most 20% w/w cello-oligosaccharides. The sweetener composition may comprise from 5% to 10%, 5% to 15%, 5% to 20%, 10% to 15%, 10% to 20%, or 15% to 20% w/w cello-oligosaccharides. The sweetener composition may comprise from 5%, 10%, 15%, or 20% w/w cello-oligosaccharides.

The cello-oligosaccharide may include a combination of cello-oligosaccharides having different degrees of polymerization. In certain embodiments, the cello-oligosaccharide may comprise two or more of a cello-oligosaccharide having a DP of two, three, four, five, and six. In some embodiments, the cello-oligosaccharide may comprise two or more of a cello-oligosaccharide having a DP of two, three, four, five, six, seven, eight, nine, ten, 11, 12, 13, 14, 15, 16, 17, 18, 19, and 20. For example, the cello-oligosaccharide may comprise a cello-oligosaccharide having a DP of two, a cello-oligosaccharide having a DP of three, and a cello-oligosaccharide having a DP of four.

The cello-oligosaccharide of the composition may comprise greater than 30%, 40%, 50%, 60%, or 70% cellobiose. In some cases, the cello-oligosaccharide may comprise greater than 30% cellobiose. In some cases, the cello-oligosaccharide may comprise greater than 40% cellobiose. In some cases, the cello-oligosaccharide may comprise greater than 50% cellobiose. In some cases, the cello-oligosaccharide may comprise greater than 60% cellobiose. In some cases, the cello-oligosaccharide may comprise greater than 70% cellobiose.

The cello-oligosaccharide of the composition may comprise less than 15%, 10%, or 5% cellotriose. In some cases, the cello-oligosaccharide may comprise less than 15% cellotriose. In some cases, the cello-oligosaccharide may comprise less than 10% cellotriose. In some cases, the cello-oligosaccharide may comprise less than 5% cellotriose. In some embodiments, the cello-oligosaccharide may comprise less than 14%, 13%, 12%, 11%, 10%, 9%, 8%, 7%, or 6% cellotriose.

The cello-oligosaccharide of the composition may comprise less than 15%, 10%, or 5% cellotetraose. In some cases, the cello-oligosaccharide may comprise less than 15% cellotetraose. In some cases, the cello-oligosaccharide may comprise less than 10% cellotetraose. In some cases, the cello-oligosaccharide may comprise less than 5% cellotetraose. In some embodiments, the cello-oligosaccharide may comprise less than 14%, 13%, 12%, 11%, 10%, 9%, 8%, 7%, or 6% cellotetraose.

In some embodiments, the xylo-oligosaccharide of the composition may have a DP of two to 12. The xylo-oligosaccharide may have a DP of two to 11. The xylo-oligosaccharide may have a DP of two to 10. The xylo-oligosaccharide may have a DP of two to nine. The xylo-oligosaccharide may have a DP of two to eight. The xylo-oligosaccharide may have a DP of two to seven. The xylo-oligosaccharide may have a DP of two to six. The xylo-oligosaccharide may have a DP of two to five. The xylo-oligosaccharide may have a DP of two to four. The xylo-oligosaccharide may have a DP of two to three. The xylo-oligosaccharide may have a DP of two. The xylo-oligosaccharide may have a DP of three. The xylo-oligosaccharide may have a DP of four. The xylo-oligosaccharide may have a DP of five. The xylo-oligosaccharide may have a DP of six. The xylo-oligosaccharide may have a DP of seven. The xylo-oligosaccharide may have a DP of eight. The xylo-oligosaccharide may have a DP of nine. The xylo-oligosaccharide may have a DP of ten. The xylo-oligosaccharide may have a DP of 11. The xylo-oligosaccharide may also have a DP of two to 20, two to 19, two to 18, two to 17, two to 16, two to 15, two to 14, or two to 13.

The xylo-oligosaccharide may include a combination of xylo-oligosaccharides having different degrees of polymerization. In certain embodiments, the xylo-oligosaccharide may comprise two or more of a xylo-oligosaccharide having a DP of two, three, four, five, six, seven, eight, nine, 10, 11, and 12. In some embodiments, the xylo-oligosaccharide may comprise two or more of a xylo-oligosaccharide having a DP of two, three, four, five, six, seven, eight, nine, 10, 11, 12, 13, 14, 15, 16, 17, 18, 19, and 20. For example, the xylo-oligosaccharide may comprise a xylo-oligosaccharide having a DP of two, a xylo-oligosaccharide having a DP of three, a xylo-oligosaccharide having a DP of four, a xylo-oligosaccharide having a DP of five, a xylo-oligosaccharide having a DP of six, and a xylo-oligosaccharide having a DP of seven.

In some embodiments, a sweetener composition may comprise xylo-oligosaccharides. The sweetener composition may comprise from 40% to 80% w/w xylo-oligosaccharides. The sweetener composition may comprise from 50% to 70% w/w xylo-oligosaccharides. The sweetener composition may comprise from 50% to 80% w/w xylo-oligosaccharides. The sweetener composition may comprise from at least 50% w/w xylo-oligosaccharides. The sweetener composition may comprise from at most 80% w/w xylo-oligosaccharides. The sweetener composition may comprise from 50% to 60%, 50% to 70%, 50% to 80%, 60% to 70%, 60% to 80%, or 70% to 80% w/w xylo-oligosaccharides. The sweetener composition may comprise from 50%, 60%, 70%, or 80% w/w xylo-oligosaccharides.

The xylo-oligosaccharide of the composition may comprise less than 70%, 60%, or 50% xylobiose. In some cases, the xylo-oligosaccharide may comprise less than 70% xylobiose. In some cases, the xylo-oligosaccharide may comprise less than 60% xylobiose. In some cases, the xylo-oligosaccharide may comprise less than 50% xylobiose. In some embodiments, the xylo-oligosaccharide may comprise less than 69%, 68%, 67%, 65%, 64%, 63%, 62%, 61%, 60%, 59%, 58%, 57%, 56%, 55%, 54%, 53%, 52%, or 51% xylobiose. The xylo-oligosaccharide may comprise less than 45%, 40%, 35%, or 30% xylobiose.

The xylo-oligosaccharide of the composition may comprise less than 60%, 50%, or 40% xylotriose. In some cases, the xylo-oligosaccharide may comprise less than 60% xylotriose. In some cases, the xylo-oligosaccharide may comprise less than 50% xylotriose. In some cases, the xylo-oligosaccharide may comprise less than 40% xylotriose. In some embodiments, the xylo-oligosaccharide may comprise less than 59%, 58%, 57%, 56%, 55%, 54%, 53%, 52%, 51%, 40%, 49%, 48%, 47%, 46%, 44%, 44%, 43%, 42%, or 41% xylotriose. The xylo-oligosaccharide may comprise less than 35%, 30%, 25%, or 20% xylotriose.

The xylo-oligosaccharide of the composition may comprise less than 50%, 40%, or 30% xylotetraose. In some cases, the xylo-oligosaccharide may comprise less than 50% xylotetraose. In some cases, the xylo-oligosaccharide may comprise less than 40% xylotetraose. In some cases, the xylo-oligosaccharide may comprise less than 30% xylotetraose. In some embodiments, the xylo-oligosaccharide may comprise less than 49%, 48%, 47%, 46%, 45%, 44%, 43%, 42%, 41%, 40%, 39%, 38%, 37%, 36%, 35%, 34%, 33%, 32%, or 31% xylotetraose. The xylo-oligosaccharide may comprise less than 25%, 20%, 15%, or 10% xylotetraose.

The xylo-oligosaccharide may comprise at least 10% substituted xylo-oligosaccharide.

In some embodiments, the mannan-oligosaccharide of the composition may have a DP of two to 12. The mannan-oligosaccharide may have a DP of two to 11. The mannan-oligosaccharide may have a DP of two to 10. The mannan-oligosaccharide may have a DP of two to nine. The mannan-oligosaccharide may have a DP of two to eight. The mannan-oligosaccharide may have a DP of two to seven. The mannan-oligosaccharide may have a DP of two to six. The mannan-oligosaccharide may have a DP of two to five. The mannan-oligosaccharide may have a DP of two to four. The mannan-oligosaccharide may have a DP of two to three. The mannan-oligosaccharide may have a DP of two. The mannan-oligosaccharide may have a DP of three. The mannan-oligosaccharide may have a DP of four. The mannan-oligosaccharide may have a DP of five. The mannan-oligosaccharide may have a DP of six. The mannan-oligosaccharide may have a DP of seven. The mannan-oligosaccharide may have a DP of eight. The mannan-oligosaccharide may have a DP of nine. The mannan-oligosaccharide may have a DP of 10. The mannan-oligosaccharide may have a DP of 11. The mannan-oligosaccharide may also have a degree of two to 20, two to 19, two to 18, two to 17, two to 16, two to 15, two to 14, or two to 13.

The mannan-oligosaccharide may include a combination of mannan-oligosaccharides having different degrees of polymerization. In certain embodiments, the mannan-oligosaccharide may comprise two or more of a mannan-oligosaccharide having a DP of two, three, four, five, six, seven, eight, nine, 10, 11, and 12. In some embodiments, the mannan-oligosaccharide may comprise two or more of a mannan-oligosaccharide having a DP of two, three, four, five, six, seven, eight, nine, 10, 11, 12, 13, 14, 15, 16, 17, 18, 19, and 20. For example, the mannan-oligosaccharide may comprise a mannan-oligosaccharide having a DP of two, a mannan-oligosaccharide having a DP of three, a mannan-oligosaccharide having a DP of four, a mannan-oligosaccharide having a DP of five, a mannan-oligosaccharide having a DP of six, and a mannan-oligosaccharide having a DP of seven.

In some embodiments, the mannan-oligosaccharide of the composition may comprise less 70%, 60%, or 50% of a mannan-oligosaccharide having a DP of two. The mannan-oligosaccharide may comprise less 70% of a mannan-oligosaccharide having a DP of two. The mannan-oligosaccharide may comprise less 60% of a mannan-oligosaccharide having a DP of two. The mannan-oligosaccharide may comprise less 50% of a mannan-oligosaccharide having a DP of two. The mannan-oligosaccharide may comprise less than 69%, 68%, 67%, 66%, 65%, 64%, 63%, 62%, 61%, 60%, 59%, 58%, 57%, 56%, 55%, 54%, 53%, 52%, or 51% of a mannan-oligosaccharide having a DP of two. The mannan-oligosaccharide may comprise less than 45%, 40%, 35%, or 30% of a mannan-oligosaccharide having a DP of two.

In some embodiments, the mannan-oligosaccharide of the composition may comprise less 60%, 50%, or 40% of a mannan-oligosaccharide having a DP of three. The mannan-oligosaccharide may comprise less 60% of a mannan-oligosaccharide having a DP of three. The mannan-oligosaccharide may comprise less 50% of a mannan-oligosaccharide having a DP of three. The mannan-oligosaccharide may comprise less 40% of a mannan-oligosaccharide having a DP of three. The mannan-oligosaccharide may comprise less than 59%, 58%, 57%, 56%, 55%, 54%, 53%, 52%, 51%, 50%, 49%, 48%, 47%, 46%, 45%, 44%, 43%, 42%, or 41% of a mannan-oligosaccharide having a DP of three. The mannan-oligosaccharide may comprise less than 35%, 30%, 25%, or 20% of a mannan-oligosaccharide having a DP of three.

In some embodiments, the mannan-oligosaccharide of the composition may comprise less 50%, 40%, or 30% of a mannan-oligosaccharide having a DP of four. The mannan-oligosaccharide may comprise less 50% of a mannan-oligosaccharide having a DP of four. The mannan-oligosaccharide may comprise less 40% of a mannan-oligosaccharide having a DP of four. The mannan-oligosaccharide may comprise less 30% of a mannan-oligosaccharide having a DP of four. The mannan-oligosaccharide may comprise less than 49%, 48%, 47%, 46%, 45%, 44%, 43%, 42%, 41%, 40%, 39%, 38%, 37%, 36%, 35%, 34%, 33%, 32%, or 31% of a mannan-oligosaccharide having a DP of four. The mannan-oligosaccharide may comprise less than 35%, 30%, 25%, or 20% of a mannan-oligosaccharide having a DP of four.

In some embodiments, a sweetener composition may comprise mannan-oligosaccharides. The sweetener composition may comprise from 40% to 80% w/w mannan-oligosaccharides. The sweetener composition may comprise from 50% to 70% w/w mannan-oligosaccharides. The sweetener composition may comprise from 50% to 80% w/w mannan-oligosaccharides. The sweetener composition may comprise from at least 50% w/w mannan-oligosaccharides. The sweetener composition may comprise from at most 80% w/w mannan-oligosaccharides. The sweetener composition may comprise from 50% to 60%, 50% to 70%, 50% to 80%, 60% to 70%, 60% to 80%, or 70% to 80% w/w mannan-oligosaccharides. The sweetener composition may comprise from 50%, 60%, 70%, or 80% w/w mannan-oligosaccharides.

The mannan-oligosaccharide may comprise at least 5% substituted mannan-oligosaccharide. In some cases, the composition may include galactomannan trisaccharides, tetrasaccharides and pentasaccharides. In some cases, the composition may include Man-β-1,4-(Gal-α-1,6-)Man-β-1,4-Man, Glc-β-1,4-(Gal-α-1,6-)Man-β-1,4-Man, Man-β-1,4-(Gal-α-1,6-)Glc-β-1,4-Man, Man-β-1,4-(Gal-α-1,6-)Man-β-1,4-Glc, Man-β-1,4-(Gal-α-1,6-)Glc-β-1,4-Glc, Glc-β-1,4-(Gal-α-1,6-)Man-β-1,4-Glc, Glc-β-1,4-(Gal-α-1,6-)Glc-β-1,4-Man, Gal-α-1,6-Man-β-1,4-Man-β-1,4-Man-β-1,4-Man, Man-β-1,4-(Gal-α-1,6-)Man-β-1,4-Man-β-1,4-Man, Man-β-1,4-Man-β-1,4-(Gal-α-1,6-)Man-β-1,4-Man, Man-β-1,4-Man-β-1,4-Man-β-1,4-(Gal-α-1,6-)Man, Gal-α-1,6-Glc-β-1,4-Man-β-1,4-Man-β-1,4-Man, Glc-β-1,4-(Gal-α-1,6-)Man-β-1,4-Man-β-1,4-Man, Glc-β-1,4-Man-β-1,4-(Gal-α-1,6-)Man-β-1,4-Man, Glc-β-1,4-Man-β-1,4-Man-β-1,4-(Gal-α-1,6-)Man, Gal-α-1,6-Man-β-1,4-Man-β-1,4-Man-β-1,4-Glc, Man-β-1,4-(Gal-α-1,6-)Man-β-1,4-Man-β-1,4-Glc, Man-β-1,4-Man-β-1,4-(Gal-α-1,6-)Man-β-1,4-Glc, Man-β-1,4-Man-β-1,4-Man-β-1,4-(Gal-α-1,6-)Glc,

In some embodiments, the fructo-oligosaccharide of the composition may have a DP of two to 12. The fructo-oligosaccharide may have a DP of two to 11. The fructo-oligosaccharide may have a DP of two to 10. The fructo-oligosaccharide may have a DP of two to nine. The fructo-oligosaccharide may have a DP of two to eight. The fructo-oligosaccharide may have a DP of two to seven. The fructo-oligosaccharide may have a DP of two to six. The fructo-oligosaccharide may have a DP of two to five. The fructo-oligosaccharide may have a DP of two to four. The fructo-oligosaccharide may have a DP of two to three. The fructo-oligosaccharide may have a DP of two. The fructo-oligosaccharide may have a DP of three. The fructo-oligosaccharide may have a DP of four. The fructo-oligosaccharide may have a DP of five. The fructo-oligosaccharide may have a DP of six. The fructo-oligosaccharide may have a DP of seven. The fructo-oligosaccharide may have a DP of eight. The fructo-oligosaccharide may have a DP of nine. The fructo-oligosaccharide may have a DP of 10. The fructo-oligosaccharide may have a DP of 11. The fructo-oligosaccharide may also have a degree of two to 20, two to 19, two to 18, two to 17, two to 16, two to 15, two to 14, or two to 13.

The fructo-oligosaccharide may include a combination of fructo-oligosaccharides having different degrees of polymerization. In certain embodiments, the fructo-oligosaccharide may comprise two or more of a fructo-oligosaccharide having a DP of two, three, four, five, six, seven, eight, nine, 10, 11, and 12. In some embodiments, the fructo-oligosaccharide may comprise two or more of fructo-oligosaccharide having a DP of two, three, four, five, six, seven, eight, nine, 10, 11, 12, 13, 14, 15, 16, 17, 18, 19, and 20. For example, the fructo-oligosaccharide may comprise a fructo-oligosaccharide having a DP of two, a fructo-oligosaccharide having a DP of three, a fructo-oligosaccharide having a DP of four, a fructo-oligosaccharide having a DP of five, a fructo-oligosaccharide having a DP of six, and a fructo-oligosaccharide having a DP of seven.

In some embodiments, the fructo-oligosaccharide of the composition may comprise less 70%, 60%, or 50% of a fructo-oligosaccharide having a DP of two. The fructo-oligosaccharide may comprise less 70% of a fructo-oligosaccharide having a DP of two. The fructo-oligosaccharide may comprise less 60% of a fructo-oligosaccharide having a DP of two. The fructo-oligosaccharide may comprise less 50% of a fructo-oligosaccharide a DP of two. The fructo-oligosaccharide may comprise less than 69%, 68%, 67%, 66%, 65%, 64%, 63%, 62%, 61%, 60%, 59%, 58%, 57%, 56%, 55%, 54%, 53%, 52%, or 51% of a fructo-oligosaccharide having a DP of two. The fructo-oligosaccharide may comprise less than 45%, 40%, 35%, or 30% of a fructo-oligosaccharide having a DP of two.

In some embodiments, the fructo-oligosaccharide of the composition may comprise less 60%, 50%, or 40% of fructo-oligosaccharide having a DP of three. The fructo-oligosaccharide may comprise less 60% of a fructo-oligosaccharide having a DP of three. The fructo-oligosaccharide may comprise less 50% of a fructo-oligosaccharide having a DP of three. The fructo-oligosaccharide may comprise less 40% of fructo-oligosaccharide having a DP of three. The fructo-oligosaccharide may comprise less than 59%, 58%, 57%, 56%, 55%, 54%, 53%, 52%, 51%, 50%, 49%, 48%, 47%, 46%, 45%, 44%, 43%, 42%, or 41% of a fructo-oligosaccharide having a DP of three. The fructo-oligosaccharide may comprise less than 35%, 30%, 25%, or 20% of a fructo-oligosaccharide having a DP of three.

In some embodiments, the fructo-oligosaccharide of the composition may comprise less 50%, 40%, or 30% of a fructo-oligosaccharide having a DP of four. The fructo-oligosaccharide may comprise less 50% of a fructo-oligosaccharide having a DP of four. The fructo-oligosaccharide may comprise less 40% of a fructo-oligosaccharide having a DP of four. The fructo-oligosaccharide may comprise less 30% of a fructo-oligosaccharide having a DP of four. The fructo-oligosaccharide may comprise less than 49%, 48%, 47%, 46%, 45%, 44%, 43%, 42%, 41%, 40%, 39%, 38%, 37%, 36%, 35%, 34%, 33%, 32%, or 31% of a fructo-oligosaccharide having a DP of four. The fructo-oligosaccharide may comprise less than 35%, 30%, 25%, or 20% of a fructo-oligosaccharide having a DP of four.

In some embodiments, a sweetener composition may comprise fructo-oligosaccharides. The sweetener composition may comprise from 40% to 80% w/w fructo-oligosaccharides. The sweetener composition may comprise from 50% to 70% w/w fructo-oligosaccharides. The sweetener composition may comprise from 50% to 80% w/w fructo-oligosaccharides. The sweetener composition may comprise from at least 50% w/w fructo-oligosaccharides. The sweetener composition may comprise from at most 80% w/w fructo-oligosaccharides. The sweetener composition may comprise from 50% to 60%, 50% to 70%, 50% to 80%, 60% to 70%, 60% to 80%, or 70% to 80% w/w fructo-oligosaccharides. The sweetener composition may comprise from 50%, 60%, 70%, or 80% w/w fructo-oligosaccharides.

In some cases, the composition may comprise less than 30 dry wt. %, 20 dry wt. %, or 10 dry wt. % of monosaccharide. The composition may comprise less than 30 dry wt. % of monosaccharide. The composition may comprise less than 20 dry wt. % of monosaccharide. The composition may comprise less than 10 dry wt. % of monosaccharide. In some cases, the composition may comprise less than 20 dry wt. %, 10 dry wt. %, 5 dry wt. %, 4 dry wt. %, 3 dry wt. %, 2 dry wt. %, or 1 dry wt. % of monosaccharide. The composition may comprise less than 5 dry wt. % of monosaccharide. The composition may comprise less than 4 dry wt. % of monosaccharide. The composition may comprise less than 3 dry wt. % of monosaccharide. The composition may comprise less than 2 dry wt. % of monosaccharide. The composition may comprise less than 1 dry wt. % of monosaccharide. The composition may comprise less than 29 dry wt. %, 28 dry wt. % 27 dry wt. %, 26 dry wt. %, 25 dry wt. %, 24 dry wt. %, 23 dry wt. %, 22 dry wt. %, 21 dry wt. %, 19 dry wt. %, 18 dry wt. %, 17 dry wt. %, 16 dry wt. %, 15 dry wt. %, 14 dry wt. %, 13 dry wt. %, 12 dry wt. %, 11 dry wt. %, 9 dry wt. %, 8 dry wt. %, 7 dry wt. %, or 6 dry wt. % of monosaccharide.

In some cases, the composition may comprise less than 70 dry wt. %, 60 dry wt. %, 50 dry wt. % of monosaccharide and disaccharides. The composition may comprise less than 70 dry wt. % of monosaccharide and disaccharides. The composition may comprise less than 60 dry wt. % of monosaccharide and disaccharides. The composition may comprise less than 50 dry wt. % of monosaccharide and disaccharides. The composition may also comprise less than 69 dry wt. %, 68 dry wt. %, 67 dry wt. %, 66 dry wt. %, 65 dry wt. %, 64 dry wt. %, 63 dry wt. %, 62 dry wt. %, 61 dry wt. %, 59 dry wt. %, 58 dry wt. %, 57 dry wt. %, 56 dry wt. %, 55 dry wt. %, 54 dry wt. %, 53 dry wt. %, 52 dry wt. %, or 51 dry wt. % of monosaccharide and disaccharides.

In some cases, the composition may comprise at least 20 dry wt. % of monosaccharide. The composition may comprise at least 10 dry wt. % of monosaccharide. In some cases, the composition may comprise at least 5 dry wt. %, 4 dry wt. %, 3 dry wt. %, 2 dry wt. %, or 1 dry wt. % of monosaccharide. The composition may comprise at least 5 dry wt. % of monosaccharide. The composition may comprise at least 4 dry wt. % of monosaccharide. The composition may comprise at least 3 dry wt. % of monosaccharide. The composition may comprise at least 2 dry wt. % of monosaccharide. The composition may comprise at least 1 dry wt. % of monosaccharide.

In certain cases, the composition may comprise 10 dry wt. % to 30 dry wt. %, 10 dry wt. % to 20 dry wt. %, or 5 dry wt. % to 10 dry wt. % of monosaccharide. In some cases, the composition may comprise 5 dry wt. % to 20 dry wt. %, 5 dry wt. % to 10 dry wt. %, 1 dry wt. % to 5 dry wt. %, 1 dry wt. % to 4 dry wt. %, 1 dry wt. % to 3 or 1 dry wt. % to 2 dry wt. % of monosaccharide.

### Combinations of Soluble Oligosaccharides and Insoluble Saccharides

The soluble oligosaccharide may be coupled to a portion of the insoluble saccharide. For example, the soluble oligosaccharide may be disposed around a portion of the insoluble saccharide. The soluble oligosaccharide can be disposed around a portion of the insoluble oligosaccharide by any suitable method, for example by spray drying, spray granulation, vacuum drying, or freeze drying. In some instances, the soluble oligosaccharide may be coated around a portion of the insoluble saccharide. In various instances, the soluble oligosaccharide may be coated around all of the insoluble saccharide. In some cases, the soluble oligosaccharide may be dried onto a portion of the insoluble saccharide. A portion of the insoluble saccharide may comprise 5% to 90% by surface area of the insoluble saccharide while the rest comprises soluble oligosaccharide. A portion of the insoluble saccharide may comprise 10% to 85% by surface area of the insoluble saccharide. A portion of the insoluble saccharide may comprise 15% to 80% by surface area of the insoluble saccharide. A portion of the insoluble saccharide may comprise 20% to 75% by surface area of the insoluble saccharide. A portion of the insoluble saccharide may comprise 25% to 70% by surface area of the insoluble saccharide. A portion of the insoluble saccharide may comprise 30% to 65% by surface area of the insoluble saccharide. A portion of the insoluble saccharide may comprise 35% to 60% by surface area of the insoluble saccharide. A portion of the insoluble saccharide may comprise 40% to 55% by surface area of the insoluble saccharide. A portion of the insoluble saccharide may comprise 45% to 50% by surface area of the insoluble saccharide. The soluble oligosaccharide may be coupled to the insoluble saccharide. For example, the soluble oligosaccharide may be disposed around the insoluble saccharide. In one case, the soluble oligosaccharide may be coated around the insoluble saccharide. In some cases, the soluble oligosaccharide may be dried onto the insoluble saccharide. The soluble oligosaccharide may be coupled to a portion of the insoluble saccharide via a chemical bond. The soluble oligosaccharide may also be coupled to the insoluble saccharide via a chemical bond. The chemical bond may comprise a covalent or a noncovalent bond. In some cases, the soluble oligosaccharide may ensheathe a portion of the insoluble saccharide. The soluble oligosaccharide may also ensheathe the insoluble saccharide.

The composition may be a consumable composition. A consumable composition may be an edible composition. In some cases, the composition may be ingested by a subject (e.g., a human). In some cases, the subject is may be a human. The subject may be a mammal. The subject may be any suitable animal.

The composition may be a sweetener. In some cases, the composition may be a fibrous sweetener. A sweetener, in some instances, may also be a sweetening agent. A sweetener, when ingested by a subject, may provide a sensation of sweetness to the subject. The sweetener may substitute sugar. The sweetener may provide no calories. In various cases, the sweetener may provide a minimal number of calories. In some cases, the sweetener may provide at least about 10%, 20%, 30%, 40%, 50%, 60%, 70%, 80%, or 90% fewer calories than sugar (e.g., honey, high fructose corn syrup or sucrose).

A sweetener composition may be a mixture of a soluble oligosaccharide component and insoluble saccharide component. The soluble oligosaccharide component and the insoluble saccharide component may form 100% of the sweetener composition. The sweetener composition may comprise from 50% to 90% of the soluble oligosaccharide component w/w. The sweetener composition may comprise from 70% to 90% of the soluble oligosaccharide component w/w. The sweetener composition may comprise from 80% to 90% of the soluble oligosaccharide component w/w. The sweetener composition may comprise from at least 50% of the soluble oligosaccharide component w/w. The sweetener composition may comprise at most 90% of the soluble oligosaccharide component w/w. The sweetener composition may comprise from 50% to 60%, 50% to 70%, 50% to 80%, 50% to 90%, 60% to 70%, 60% to 80%, 60% to 90%, 70% to 80%, 70% to 90%, or 80% to 90% of the soluble oligosaccharide component w/w. The sweetener composition may comprise from 50%, 60%, 70%, 80%, or 90% of the soluble oligosaccharide component w/w. It should be understood that in this case where the sweetener composition comprises only the soluble oligosaccharide component and the insoluble saccharide component; the remainder of the sweetener composition (excluding the soluble oligosaccharide component) is the insoluble saccharide component.

The sweetener composition may comprise from 10% to 50% of the insoluble saccharide component w/w. Preferably, the sweetener composition may comprise from 10% to 30% of the insoluble saccharide component w/w. The sweetener composition may comprise from at least 10% of the insoluble saccharide component w/w. The sweetener composition may comprise from at most 50% of the insoluble saccharide component w/w. The sweetener composition may comprise from 10% to 15%, 10% to 20%, 10% to 25%, 10% to 30%, 10% to 40%, 10% to 50%, 15% to 20%, 15% to 25%, 15% to 30%, 15% to 40%, 15% to 50%, 20% to 25%, 20% to 30%, 20% to 40%, 20% to 50%, 25% to 30%, 25% to 40%, 25% to 50%, 30% to 40%, 30% to 50%, or 40% to 50% of the insoluble saccharide component w/w. The sweetener composition may comprise from 10%, 15%, 20%, 25%, 30%, 40%, or 50% of the insoluble saccharide component w/w. It should be understood that in this case where the sweetener composition comprises only the insoluble saccharide component and the soluble oligosaccharide component; the remainder of the sweetener composition (excluding the insoluble saccharide component) is the soluble oligosaccharide component.

A food, cosmetic or nutraceutical product may comprise any suitable combination of the soluble oligosaccharide and the insoluble saccharide as described herein (e.g., the soluble oligosaccharides and the insoluble saccharides of the compositions provided herein). In some cases, a baked good may comprise any suitable combination of the soluble oligosaccharide and the insoluble saccharide as described herein (e.g., the soluble oligosaccharides and the insoluble saccharides of the compositions provided here). In some cases, a sweetening agent may comprise any suitable combination of the soluble oligosaccharide and the insoluble saccharide as described herein (e.g., the soluble oligosaccharides and the insoluble saccharides of the compositions provided herein). In some instances, the food product, the baked good, or the sweetening agent may comprise any combinations of the soluble oligosaccharides and the insoluble saccharides provided herein. In some cases, the food product, the baked good, or the sweetening agent may comprise any configurations of the soluble oligosaccharides and the insoluble saccharides described herein. The food product, the baked good, and the sweetening agent may be consumable (e.g., by a human). The composition may comprise various soluble oligosaccharides. The composition may include the soluble oligosaccharides at varying amounts, for example, depending on the desired properties of the composition. In some instances, the composition may comprise at least 50 dry wt. % soluble oligosaccharide having a DP of from three to 20, insoluble saccharide having a DP of at least 20, and the weight ratio of the insoluble saccharide to the soluble oligosaccharide may be 1:99 to 50:50.

In some cases, the composition may comprise at least 50 dry wt. % a soluble oligosaccharide having a DP of from three to 20; an insoluble saccharide having a DP of at least 20; and the weight ratio of the insoluble saccharide to the soluble oligosaccharide may be 2:98 to 30:70. In some cases, the composition may comprise at least 50 dry wt. % a soluble oligosaccharide having a DP of from three to 20; an insoluble saccharide having a DP of at least 20; and the weight ratio of the insoluble saccharide to the soluble oligosaccharide may be 3:97 to 25:75. In some cases, the composition may comprise at least 50 dry wt. % a soluble oligosaccharide having a DP of from three to 20; an insoluble saccharide having a DP of at least 20; and the weight ratio of the insoluble saccharide to the soluble oligosaccharide may be 4:96 to 20:80. In some cases, the composition may comprise at least 50 dry wt. % a soluble oligosaccharide having a DP of from three to 20; an insoluble saccharide having a DP of at least 20; and the weight ratio of the insoluble saccharide to the soluble oligosaccharide may be 5:95 to 17.5:82.5. The composition may also comprise at least 50 dry wt. % a soluble oligosaccharide having a DP of from three to 20; an insoluble saccharide having a DP of at least 20; and the weight ratio of the insoluble saccharide to the soluble oligosaccharide may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

The composition may comprise at least 50 dry wt. % soluble oligosaccharides and at least 90 dry wt. %, 95 dry wt. %, 96 dry wt. %, 97 dry wt. %, 98 dry wt. %, 99 dry wt. %, or 100 dry wt. % of the soluble oligosaccharide having a DP of three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 90 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 95 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 96 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50. The composition may comprise at least 50 dry wt. %, soluble oligosaccharide and at least 97 dry wt. % of the soluble oligosaccharide may have a DP of three to 20; an insoluble saccharide having a DP of from at least 20; and the weight ratio of the insoluble saccharide to the soluble oligosaccharide may be 1:99 to 50:50. The composition may comprise at least 50 dry wt. % soluble oligosaccharide and at least 98 dry wt. % of the soluble oligosaccharide may have a DP from three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 99 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 100 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 50 dry wt. %, 55 dry wt. %, 60 dry wt. %, 65 dry wt. %, 70 dry wt. %, 75 dry wt. %, 80 dry wt. %, or 85 dry wt. % of the soluble oligosaccharide may have a DP of three to 20; an insoluble saccharide having a DP of at least 20; and the weight ratio of the insoluble saccharide to the soluble oligosaccharide may be 1:99 to 50:50.

In some cases, the soluble oligosaccharide and the insoluble saccharide may be in a combined amount of at least 50 dry wt. % of the total amount of the composition. In various cases, the soluble oligosaccharide and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

### Combinations of Soluble Polysaccharides and Insoluble Saccharides

The soluble polysaccharide may be coupled to a portion of the insoluble saccharide. For example, the soluble polysaccharide may be disposed around a portion of the insoluble saccharide. In some instances, the soluble polysaccharide may be coated around a portion of the insoluble saccharide. In various instances, the soluble polysaccharide may be coated around all of the insoluble saccharide. In some cases, the soluble polysaccharide may be dried onto a portion of the insoluble saccharide. A portion of the insoluble saccharide may comprise 5% to 90% by surface area of the insoluble saccharide while the rest of the surface area comprises soluble polysaccharide. A portion of the insoluble saccharide may comprise 10% to 85% by surface area of the insoluble saccharide. A portion of the insoluble saccharide may comprise 15% to 80% by surface area of the insoluble saccharide. A portion of the insoluble saccharide may comprise 20% to 75% by surface area of the insoluble saccharide. A portion of the insoluble saccharide may comprise 25% to 70% by surface area of the insoluble saccharide. A portion of the insoluble saccharide may comprise 30% to 65% by surface area of the insoluble saccharide. A portion of the insoluble saccharide may comprise 35% to 60% by surface area of the insoluble saccharide. A portion of the insoluble saccharide may comprise 40% to 55% by surface area of the insoluble saccharide. A portion of the insoluble saccharide may comprise 45% to 50% by surface area of the insoluble saccharide. The soluble polysaccharide may be coupled to the insoluble saccharide. For example, the soluble polysaccharide may be disposed around the insoluble saccharide. In one case, the soluble polysaccharide may be coated around the insoluble saccharide. In some cases, the soluble polysaccharide may be dried onto the insoluble saccharide. In some cases, the soluble polysaccharide may be dried onto the insoluble saccharide via spray drying, spray granulation, vacuum drying, or a combination thereof. The soluble polysaccharide may be coupled to a portion of the insoluble saccharide via a chemical bond. The soluble polysaccharide may also be coupled to the insoluble saccharide via a chemical bond. The chemical bond may comprise a covalent or a noncovalent bond. In some cases, the soluble polysaccharide may ensheathe a portion of the insoluble saccharide. The soluble polysaccharide may also ensheathe the insoluble saccharide. The soluble polysaccharide may be coupled to a portion of the insoluble saccharide via a non-chemical bond. The soluble polysaccharide may also be coupled to the insoluble saccharide via a non-chemical bond. The non-chemical bond may comprise a hydrophilic (e.g. hydrogen bond), hydrophobic or electrostatic (e.g. Van der Waals) interaction.

The soluble polysaccharide may be coupled to the insoluble saccharide such that the soluble saccharide forms a coating component wherein the insoluble saccharide forms a core component of a single coated particle. The coating component may cover 1% to 99% of the surface area of the core component. The coating component may cover greater than 1%, 5%, 10%, 15%, 20%, 25%, 30%, 35%, 40%, 45%, 50%, 55%, 60%, 65%, 70%, 75%, 80%, 85%, 90%, 95%, or 99% of the surface area of the core component. The coating component may cover less than 1%, 5%, 10%, 15%, 20%, 25%, 30%, 35%, 40%, 45%, 50%, 55% 60%, 65%, 70%, 75%, 80%, 85%, 90%, 95%, or 99% of the surface area of the core component. The coating component may cover between 1% to 10%, 5% to 15%, 10% to 20%, 15% to 25%, 20% to 30%, 25% to 35%, 30% to 40%, 35% to 45%, 40% to 50%, 45% to 55%, 50% to 60%, 55% to 65%, 60% to 70%, 65% to 75%, 70% to 80%, 75% to 85%, 80% to 90%, 85% to 95%, 90% to 97%, or 95% to 99% of the surface area of the core component.

The weight ratio of the coating component to the core component for single coated particles before drying may be from 1:99 to 50:50. The weight ratio of the soluble oligosaccharide to the insoluble saccharide can be 2:98 to 30:70 (e.g., 3:97 to 25:75; 4:96 to 20:80; 5:95 to 17.5:82.5, etc.).

The weight ratio of the coating component to the core component in a single coated particle may be from 1:99 to 50:50. The weight ratio of the soluble oligosaccharide to the insoluble saccharide in a single coated particle can be 2:98 to 30:70 (e.g., 3:97 to 25:75; 4:96 to 20:80; 5:95 to 17.5:82.5, etc.).

Dried compositions or dried particles can comprise particles with a variety of compositions (e.g., coated particles, particles consisting of soluble oligosaccharide, uncoated particles, etc.). The weight ratio of coated particles+uncoated particles to other particles (e.g., particles consisting of soluble oligosaccharide, etc.) may be from 1:99 to 50:50. The weight ratio of the coated particles+uncoated particles to other particles can be 2:98 to 30:70 (e.g., 3:97 to 25:75, 4:96 to 20:80, 5:95 to 17.5:82.5, etc.). As used herein, a “coated particle” refers to a particle comprising a coating component and a core component. As used herein, an “uncoated particle” refers to a particle consisting of a core component. As used herein, “other particle” refers to a particle consisting of soluble oligosaccharides. As a whole, the dried compositions or dried particles comprise more soluble oligosaccharides than insoluble saccharides in weight percentage.

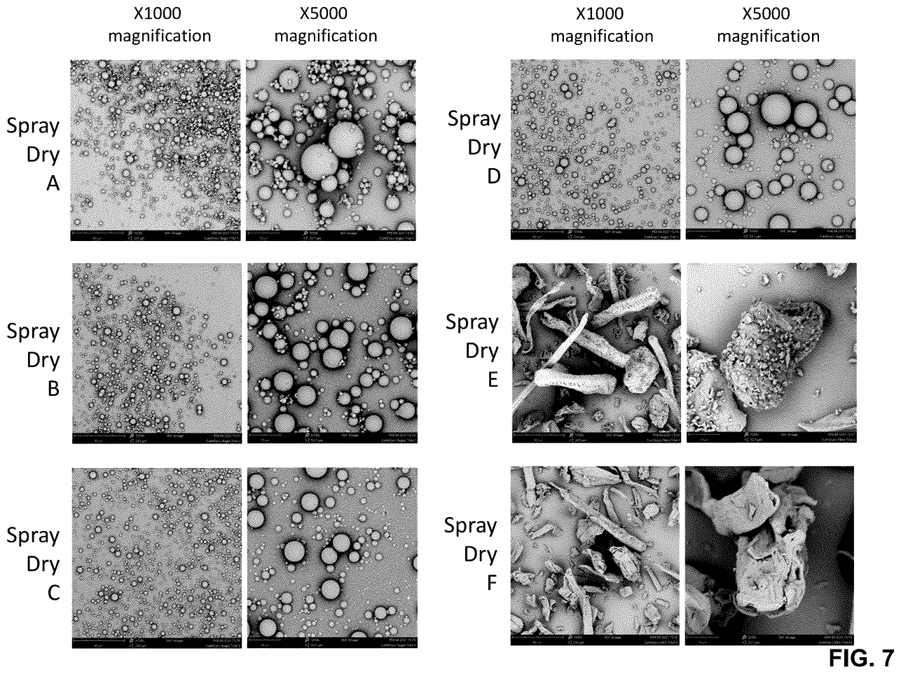

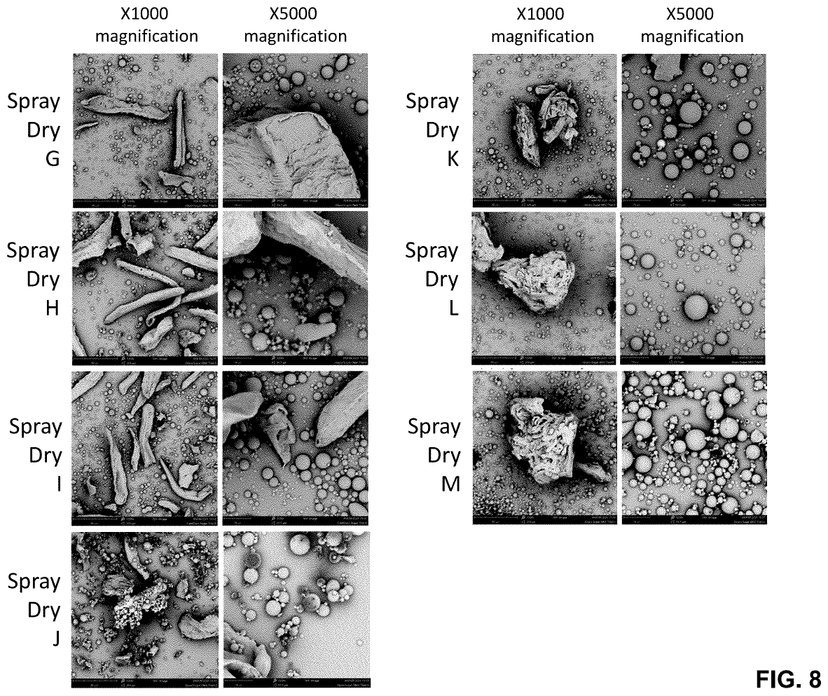

The surface of the coated particle may be substantially smooth. Substantially smooth means have less than 50%, less than 40%, less than 30%, less than 20%, less than 10% rough surface. A rough surface may appear as a bumpy texture, for example as can be seen in FIG. 7, “Spray Dry E” at 5000× magnification. A smooth surface may appear as a smooth texture, for example as can be seen in FIG. 8, “Spray Dry H” at 5000× magnification.

A food, cosmetic or nutraceutical product may comprise any suitable combination of the soluble polysaccharide and the insoluble saccharide as described herein (e.g., the soluble polysaccharides and the insoluble saccharides of the compositions provided herein). In some cases, a baked good may comprise any suitable combination of the soluble polysaccharide and the insoluble saccharide as described herein (e.g., the soluble polysaccharides and the insoluble saccharides of the compositions provided here). In some cases, a sweetening agent may comprise any suitable combination of the soluble polysaccharide and the insoluble saccharide as described herein (e.g., the soluble polysaccharides and the insoluble saccharides of the compositions provided herein). In some instances, the food product, the baked good, or the sweetening agent may comprise any combinations of the soluble polysaccharides and the insoluble saccharides provided herein. In some cases, the food product, the baked good, or the sweetening agent may comprise any configurations of the soluble polysaccharides and the insoluble saccharides described herein. The food product, the baked good, and the sweetening agent may be consumable (e.g., by a human).

### Characteristics of the Compositions and Products Including the Compositions

In some instances, at least one of the firmness, springiness, and water retention of the product may be within 10% of the same characteristic of a control product (e.g., wherein the control product comprises a soluble monosaccharide, disaccharide, oligosaccharide, a lipid, a protein, a soluble polysaccharide and/or a surfactant and lacks an insoluble saccharide). At least one of the firmness, springiness, and water retention of the product may be within 9% of the same characteristic of a control product. At least one of the firmness, springiness, and water retention of the product may be within 8% of the same characteristic of a control product. At least one of the firmness, springiness, and water retention of the product may be within 7% of the same characteristic of a control product. At least one of the firmness, springiness, and water retention of the product may be within 6% of the same characteristic of a control product. At least one of the firmness, springiness, and water retention of the product may be within 5% of the same characteristic of a control product. At least one of the firmness, springiness, and water retention of the product may be within 4% of the same characteristic of a control product. At least one of the firmness, springiness, and water retention of the product may be within 3% of the same characteristic of a control product. At least one of the firmness, springiness, and water retention of the product may be within 2% of the same characteristic of a control product. At least one of the firmness, springiness, and water retention of the product may be within 7% of the same characteristic of a control product. At least one of the firmness, springiness, and water retention of the product may be within 1% of the same characteristic of a control product. At least one of the firmness, springiness, and water retention of the product may have at least one of the firmness, springiness, and water retention as the same characteristic of a control product. At least one of the firmness, springiness, and water retention of the product may be within 20% of the same characteristic of a control product. At least one of the firmness, springiness, and water retention of the product may be within 19% of the same characteristic of a control product. At least one of the firmness, springiness, and water retention of the product may be within 18% of the same characteristic of a control product. At least one of the firmness, springiness, and water retention of the product may be within 17% of the same characteristic of a control product. At least one of the firmness, springiness, and water retention of the product may be within 16% of the same characteristic of a control product. At least one of the firmness, springiness, and water retention of the product may be within 15% of the same characteristic of a control product. At least one of the firmness, springiness, and water retention of the product may be within 14% of the same characteristic of a control product. At least one of the firmness, springiness, and water retention of the product may be within 13% of the same characteristic of a control product. At least one of the firmness, springiness, and water retention of the product may be within 12% of the same characteristic of a control product. At least one of the firmness, springiness, and water retention of the product may be within 11% of the same characteristic of a control product.

In some instances, the firmness of the product may be within 10% of the firmness of a control product (e.g., wherein the control product comprises a soluble monosaccharide, disaccharide, oligosaccharide, a lipid, a protein, a soluble polysaccharide and/or a surfactant and lacks an insoluble saccharide). The firmness of the product may be within 9% of the firmness of a control product. The firmness of the product may be within 8% of the firmness of a control product. The firmness of the product may be within 7% of the firmness of a control product. The firmness of the product may be within 6% of the firmness of a control product. The firmness of the product may be within 5% of the firmness of a control product. The firmness of the product may be within 4% of the firmness of a control product. The firmness of the product may be within 3% of the firmness of a control product. The firmness of the product may be within 2% of the firmness of a control product. The firmness of the product may be within 7% of the firmness of a control product. The firmness of the product may be within 1% of the firmness of a control product. The firmness of the product may have the firmness as that of a control product. The firmness of the product may be within 20% of the firmness of a control product. The firmness of the product may be within 19% of the firmness of a control product. The firmness of the product may be within 18% of the firmness of a control product. The firmness of the product may be within 17% of the firmness of a control product. The firmness of the product may be within 16% of the firmness of a control product. The firmness of the product may be within 15% of the firmness of a control product. The firmness of the product may be within 14% of the firmness of a control product. The firmness of the product may be within 13% of the firmness of a control product. The firmness of the product may be within 12% of the firmness of a control product. The firmness of the product may be within 11% of the firmness of a control product.

In some instances, the springiness of the product may be within 10% of the springiness of a control product (e.g., wherein the control product comprises a soluble monosaccharide, disaccharide, oligosaccharide, a lipid, a protein, a soluble polysaccharide and/or a surfactant and lacks an insoluble saccharide). The springiness of the product may be within 9% of the springiness of a control product. The springiness of the product may be within 8% of the springiness of a control product. The springiness of the product may be within 7% of the springiness of a control product. The springiness of the product may be within 6% of the springiness of a control product. The springiness of the product may be within 5% of the springiness of a control product. The springiness of the product may be within 4% of the springiness of a control product. The springiness of the product may be within 3% of the springiness of a control product. The springiness of the product may be within 2% of the springiness of a control product. The springiness of the product may be within 7% of the springiness of a control product. The springiness of the product may be within 1% of the springiness of a control product. The springiness of the product may have the springiness as that of a control product. The springiness of the product may be within 20% of the springiness of a control product. The springiness of the product may be within 19% of the springiness of a control product. The springiness of the product may be within 18% of the springiness of a control product. The springiness of the product may be within 17% of the springiness of a control product. The springiness of the product may be within 16% of the springiness of a control product. The springiness of the product may be within 15% of the springiness of a control product. The springiness of the product may be within 14% of the springiness of a control product. The springiness of the product may be within 13% of the springiness of a control product. The springiness of the product may be within 12% of the springiness of a control product. The springiness of the product may be within 11% of the springiness of a control product.

In some instances, the water retention of the product may be within 10% of the water retention of a control product (e.g., wherein the control product comprises a soluble monosaccharide, disaccharide, oligosaccharide, a lipid, a protein, a soluble polysaccharide and/or a surfactant and lacks an insoluble saccharide). The water retention of the product may be within 9% of the water retention of a control product. The water retention of the product may be within 8% of the water retention of a control product. The water retention of the product may be within 7% of the water retention of a control product. The water retention of the product may be within 6% of the water retention of a control product. The water retention of the product may be within 5% of the water retention of a control product. The water retention of the product may be within 4% of the water retention of a control product. The water retention of the product may be within 3% of the water retention of a control product. The water retention of the product may be within 2% of the water retention of a control product. The water retention of the product may be within 7% of the water retention of a control product. The water retention of the product may be within 1% of the water retention of a control product. The water retention of the product may have the water retention as that of a control product. The water retention of the product may be within 20% of the water retention of a control product. The water retention of the product may be within 19% of the water retention of a control product. The water retention of the product may be within 18% of the water retention of a control product. The water retention of the product may be within 17% of the water retention of a control product. The water retention of the product may be within 16% of the water retention of a control product. The water retention of the product may be within 15% of the water retention of a control product. The water retention of the product may be within 14% of the water retention of a control product. The water retention of the product may be within 13% of the water retention of a control product. The water retention of the product may be within 12% of the water retention of a control product. The water retention of the product may be within 11% of the water retention of a control product.

In some instances, the firmness, springiness, and water retention of the product may be within 10% of the firmness, springiness, and water retention of a control product (e.g., wherein the control product comprises a soluble monosaccharide, disaccharide, oligosaccharide, a lipid, a protein, a soluble polysaccharide and/or a surfactant and lacks an insoluble saccharide). The firmness, springiness, and water retention of the product may be within 9% of the firmness, springiness, and water retention of a control product. The firmness, springiness, and water retention of the product may be within 8% of the firmness, springiness, and water retention of a control product. The firmness, springiness, and water retention of the product may be within 7% of the firmness, springiness, and water retention of a control product. The firmness, springiness, and water retention of the product may be within 6% of the firmness, springiness, and water retention of a control product. The firmness, springiness, and water retention of the product may be within 5% of the firmness, springiness, and water retention of a control product. The firmness, springiness, and water retention of the product may be within 4% of the firmness, springiness, and water retention of a control product. The firmness, springiness, and water retention of the product may be within 3% of the firmness, springiness, and water retention of a control product. The firmness, springiness, and water retention of the product may be within 2% of the firmness, springiness, and water retention of a control product. The firmness, springiness, and water retention of the product may be within 7% of the firmness, springiness, and water retention of a control product. The firmness, springiness, and water retention of the product may be within 1% of the firmness, springiness, and water retention of a control product. The firmness, springiness, and water retention of the product may have the firmness, springiness, and water retention as that of a control product. The firmness, springiness, and water retention of the product may be within 20% of the firmness, springiness, and water retention of a control product. The firmness, springiness, and water retention of the product may be within 19% of the firmness, springiness, and water retention of a control product. The firmness, springiness, and water retention of the product may be within 18% of the firmness, springiness, and water retention of a control product. The firmness, springiness, and water retention of the product may be within 17% of the firmness, springiness, and water retention of a control product. The firmness, springiness, and water retention of the product may be within 16% of the firmness, springiness, and water retention of a control product. The firmness, springiness, and water retention of the product may be within 15% of the firmness, springiness, and water retention of a control product. The firmness, springiness, and water retention of the product may be within 14% of the firmness, springiness, and water retention of a control product. The firmness, springiness, and water retention of the product may be within 13% of the firmness, springiness, and water retention of a control product. The firmness, springiness, and water retention of the product may be within 12% of the firmness, springiness, and water retention of a control product. The firmness, springiness, and water retention of the product may be within 110% of the firmness, springiness, and water retention of a control product.

In some instances, at least two of the firmness, springiness, and water retention of the product may be within 10% of the same characteristics of a control product (e.g., wherein the control product comprises a soluble monosaccharide, disaccharide, oligosaccharide, a lipid, a protein, a soluble polysaccharide and/or a surfactant and lacks an insoluble saccharide). At least two of the firmness, springiness, and water retention of the product may be within 9% of the same characteristics of a control product. At least two of the firmness, springiness, and water retention of the product may be within 8% of the same characteristics of a control product. At least two of the firmness, springiness, and water retention of the product may be within 7% of the same characteristics of a control product. At least two of the firmness, springiness, and water retention of the product may be within 6% of the same characteristics of a control product. At least two of the firmness, springiness, and water retention of the product may be within 5% of the same characteristics of a control product. At least two of the firmness, springiness, and water retention of the product may be within 4% of the same characteristics of a control product. At least two of the firmness, springiness, and water retention of the product may be within 3% of the same characteristics of a control product. At least two of the firmness, springiness, and water retention of the product may be within 2% of the same characteristics of a control product. At least two of the firmness, springiness, and water retention of the product may be within 7% of the same characteristics of a control product. At least two of the firmness, springiness, and water retention of the product may be within 1% of the same characteristics of a control product. At least two of the firmness, springiness, and water retention of the product may have at least two of the firmness, springiness, and water retention as that of a control product. At least two of the firmness, springiness, and water retention of the product may be within 20% of the same characteristics of a control product. At least two of the firmness, springiness, and water retention of the product may be within 19% of the same characteristics of a control product. At least two of the firmness, springiness, and water retention of the product may be within 18% of the same characteristics of a control product. At least two of the firmness, springiness, and water retention of the product may be within 17% of the same characteristics of a control product. At least two of the firmness, springiness, and water retention of the product may be within 16% of the same characteristics of a control product. At least two of the firmness, springiness, and water retention of the product may be within 15% of the same characteristics of a control product. At least two of the firmness, springiness, and water retention of the product may be within 14% of the same characteristics of a control product. At least two of the firmness, springiness, and water retention of the product may be within 13% of the same characteristics of a control product. At least two of the firmness, springiness, and water retention of the product may be within 12% of the same characteristics of a control product. At least two of the firmness, springiness, and water retention of the product may be within 11% of the same characteristics of a control product.

In some instances, at least one of the color, texture, smell, sweetness, mouthfeel, and overall acceptance may be comparable to the same characteristic of a control product (e.g., wherein the control product comprises a soluble monosaccharide, disaccharide, oligosaccharide, a lipid, a protein, a soluble polysaccharide and/or a surfactant and lacks an insoluble saccharide). At least two of the color, texture, smell, sweetness, mouthfeel, and overall acceptance may be comparable to the same characteristics of a control product. At least three of the color, texture, smell, sweetness, mouthfeel, and overall acceptance may be comparable to the same characteristics of a control product. At least four of the color, texture, smell, sweetness, mouthfeel, and overall acceptance may be comparable to the same characteristics of a control product. In some instances, a product may comprise at least five of the color, texture, smell, sweetness, mouthfeel, and overall acceptance may be comparable to the same characteristics of a control product. At least six of the color, texture, smell, sweetness, mouthfeel, and overall acceptance may be comparable to the same characteristics of a control product. In some cases, the color, texture, smell, sweetness, mouthfeel, and overall acceptance may be comparable to the same characteristics of a control product.

In some instances, at least one of the color, texture, smell, sweetness, mouthfeel, and overall acceptance may be comparable to the same characteristic of a control product (e.g., wherein the control product comprises a soluble monosaccharide, disaccharide, oligosaccharide, a lipid, a protein, a soluble polysaccharide and/or a surfactant and lacks an insoluble saccharide). At least two of the color, texture, smell, sweetness, mouthfeel, and overall acceptance may be comparable to the same characteristics of a control product. At least three of the color, texture, smell, sweetness, mouthfeel, and overall acceptance may be comparable to the same characteristics of a control product. At least four of the color, texture, smell, sweetness, mouthfeel, and overall acceptance may be comparable to the same characteristics of a control product. In some instances, a product may comprise at least five of the color, texture, smell, sweetness, mouthfeel, and overall acceptance may be comparable to the same characteristics of a control product. In some cases, the color, texture, smell, sweetness, mouthfeel, and overall acceptance may be comparable to the same characteristics of a control product.

In some instances, the color of the product may be comparable to the color of a control product (e.g., wherein the control product comprises a soluble monosaccharide, disaccharide, oligosaccharide, a lipid, a protein, a soluble polysaccharide and/or a surfactant and lacks an insoluble saccharide). In some cases, the texture of the product may be comparable to the texture of a control product. The smell of the product may be comparable to the smell of a control product. In some cases, the sweetness of the product may be comparable to the sweetness of a control product. In other cases, the overall acceptance of the product may be comparable to the overall acceptance of a control product.

A baked good may comprise any one of the characteristics of the products as described herein, wherein when compared to a control baked good (e.g., the control baked good comprising a soluble monosaccharide, disaccharide, oligosaccharide and lacking an insoluble saccharide). The characteristics of the sweetening agents, products, or baked goods as described herein may be assayed or measured by any suitable method (e.g., the methods described in Examples 1-9).

A baked good, in some cases, may comprise any sweetening agents described herein. The baked good may comprise the sweetening agent in a total amount of at least 5%, 10%, 15%, 20%, 25%, 30%, or 35%. The baked good may comprise the sweetening agent in a total amount of at least 10%. The baked good may comprise the sweetening agent in a total amount of at least 25%. The baked good may comprise the sweetening agent in a total amount of at least 35%. In some cases, the baked good may comprise the sweetening agent in a total amount of at least 12.5%, 15%, 17.5%, 20%, 22.5%, 25%, 27.5%, 30%, or 32.5%.

In some instances, the baked good may be selected from the group consisting of a cookie, cake, biscuit, pastry, or scone. In some cases, the baked good may be a cookie. In certain cases, the baked good may be a cake. In various cases, the baked good may be a biscuit. In some cases, the baked good may be a pastry. In certain cases, the baked good may be a scone. In various cases, the baked good may be a muffin. The baked good may be a bread. In some cases, the baked good may be a pie. The baked good may be a tart. The baked good may also be a bagel. The baked good may be a cracker. The baked good, in some cases, may be selected from the group consisting of a cookie, cake, biscuit, pastry, scone, muffin, bread, pie, tart, bagel, or cracker.

A food product, in some cases, may comprise any sweetening agents described herein. The food product may comprise the sweetening agent in a total amount of at least 5%, 10%, 20%, 30%, or 40%. The food product may comprise the sweetening agent in a total amount of at least 10%. The food product may comprise the sweetening agent in a total amount of at least 20%. The food product may comprise the sweetening agent in a total amount of at least 30%. The food product may comprise the sweetening agent in a total amount of at least 50%. In some cases, the food product may comprise the sweetening agent in a total amount of at least 12.5%, 15%, 17.5%, 20%, 22.5%, 25%, 27.5%, 30%, 32.5%, 35%, 37.5%, 40%, 42.5%, 45% or 47.5%.

In some cases, a food product may be a fat-based food product. For example, the fat-based food product may be selected from the group consisting of chocolate and ice cream. The fat-based food product may be chocolate. The fat-based food product may be ice cream. In some cases, the fat-based food product may be cream. The fat-based food product may be whipped cream. In other cases, the fat-based food product may be condensed milk. In some cases, the fat-based food product may be butter. In some cases, the fat-based food product may be a sweetened milk (e.g., chocolate milk). In some cases, the fat-based food product may be selected from the group consisting of chocolate, ice cream, cream, whipped cream, condensed milk, butter, or sweetened milk.

In some instances, a food product may comprise a water-based food product. For example, the water-based food product may be selected from the group consisting of jam, jelly, icing, and candy. In some cases, the water-based food product may be jam. In some cases, the water-based food product may be jelly. In various cases, the water-based food product may be icing. In certain cases, the water-based food product may be candy. In some instances, the water-based food product may be syrup. The water-based food product may be molasses. In some cases, the water-based food product may be selected from the group consisting of jam, jelly, icing, candy, syrup, and molasses.

In some instances, the composition may be configured to be incorporated into a foodstuff, a cosmetic, or a nutraceutical. The foodstuff, a cosmetic, or a nutraceutical incorporated with the composition may comprise any foodstuff, a cosmetic, or nutraceutical described herein

Methods of Forming Compositions with Specific Arrangements of Insoluble Saccharides and Other Components

A method of forming a composition may comprise: (a) providing a soluble oligosaccharide having a DP of three to 20 and (b) disposing the soluble oligosaccharide on an insoluble saccharide having a DP of at least 20.

The soluble oligosaccharide may also comprise any soluble oligosaccharides described herein. For example, the soluble oligosaccharide may also comprise the soluble oligosaccharides having various degrees of polymerization. In some cases, the method may also comprise any insoluble saccharides described herein. For example, the insoluble saccharide may comprise the insoluble saccharides having various degrees of polymerization.

The disposing of the soluble oligosaccharide on the insoluble saccharide, in some cases, may comprise spray drying. For example, the method may comprise spray drying the soluble oligosaccharide on the insoluble saccharide (e.g., on at least a portion of the insoluble saccharide). In some cases, the method may comprise rapidly drying the soluble oligosaccharide on the insoluble saccharide, for example, by a hot gas. In other cases, the method may comprise removing the solvent of the soluble oligosaccharide and disposing the remaining soluble oligosaccharide on the insoluble saccharide as a solid form. Such a solid form may comprise a powder. In some cases, spray drying the soluble oligosaccharide on the insoluble saccharide may comprise spraying the soluble oligosaccharide through a nozzle into a hot vapor stream such that the soluble oligosaccharide is vaporized. In other cases, the method may comprise freeze drying the soluble oligosaccharide on the insoluble saccharide. In other cases, the method may comprise vacuum drying the soluble oligosaccharide on the insoluble saccharide The method may also comprise drum drying the soluble oligosaccharide on the insoluble saccharide. In some cases, the method may comprise pulse combustion drying the soluble oligosaccharide on the insoluble saccharide.

In some cases, the disposing of the soluble oligosaccharide on the insoluble saccharide may comprise spray granulation. The method may comprise spray granulating the soluble oligosaccharide on the insoluble saccharide (e.g., on at least a portion of the insoluble saccharide). Spray granulating the soluble oligosaccharide on the insoluble saccharide may comprise converting the soluble oligosaccharide and the insoluble saccharide into a granule. In spray granulation, (i) the insoluble saccharide is suspended in an air stream; (ii) a solution of soluble oligosaccharide is sprayed onto the suspended insoluble saccharide, thereby coating the insoluble saccharide (core) with soluble oligosaccharide, and (iii) the suspended insoluble saccharide (at least some of which is covered by the soluble oligosaccharide) is dried by hot gas. In some cases, the particle size (e.g., diameter) of the granule may be pre-determined. The particle diameter distribution of the granule may be narrow. For example, the diameter distribution of the granules may be within at least 5%, 10%, 15%, 20%, 25%, or 30% of the average diameter of the granules. In other cases, the diameter distribution of the granules may be within at least 5%, 10%, 15%, 20%, 25%, or 30% of the median diameter of the granules. The granule may be spherical in shape. The granule may also be oval in shape. The granules may be irregular in shape. The granules produced by the spray granulating may be packed in a high-bulk density. In other cases, the granules may also be dust free.

A method of forming a composition may comprise: (a) providing a suspension comprising a soluble oligosaccharide having a DP described herein, and an insoluble saccharide fraction may be dried. In some cases, the insoluble saccharide fraction may be dried by spray drying. In some cases, the insoluble saccharide fraction may be dried by spray granulation.

The insoluble saccharide may be spray dried by a hot gas. In other cases, the insoluble saccharide may be spray dried to a solid form. Such a solid form may comprise a powder. In some cases, the insoluble saccharide may be sprayed through a nozzle into a hot vapor stream such that the insoluble saccharide is vaporized. In other cases, the insoluble saccharide may be freeze dried. In other cases, the insoluble saccharide may be vacuum dried. The insoluble saccharide may also be drum dried. In some cases, the insoluble saccharide may also be pulse combustion dried. The method may comprise spray granulating the insoluble saccharide. Spray granulating the insoluble saccharide may comprise converting the insoluble saccharide into a granule. The granule may comprise the characteristics of the granules described herein.

### Spray Drying

In a spray drying process, a feed, such as, for example, a liquid, solution, emulsion, suspension, or a slurry, is atomized in a drying chamber/dryer to form a fine mist of droplets, then droplets are dried rapidly by a hot drying gas medium to produce a dried product, such as, a solid, a dry powder, etc. The solid or dry powder is then separated from the drying gas and collected. The drying gas can be air or nitrogen. The drying chamber or dryer can be a vessel, tank, tubing, or coil. The feed can be heated prior to entering the dryer. The heating temperature for the feed can be selected on the basis of the dissolution properties of the dry ingredients and the desired viscosity of the spray drying feed solution.

In some embodiments, the feed is sprayed into a current of warm filtered gas that evaporates the solvent of the feed and conveys the dried product to a collector. The spent air is then exhausted together with the vaporized solvent. Several different types of apparatus may be used to provide the desired dried product. In some embodiments, foam spray drying may be used to produce low bulk density products. In some embodiments, a fluid bed may be attached to the exit of the spray dryer to produce a product having enhanced dissolution rates. In some embodiments, the spray dryers may include, but not be limited to, co-current nozzle tower spray dryers, co-current rotary atomizer spray dryers, counter-current nozzle tower spray dryers, and mixed-flow fountain nozzle spray dryers. For example, commercial spray dryers manufactured by Buchi Ltd. or Niro Corp. can effectively produce particles of desired size.

In some embodiments, the spray-dried powdered solids/particles thus obtained can be approximately spherical in shape (e.g., microspheres), nearly uniform in size and, under certain conditions, hollow. In some embodiments, under certain conditions the spray-dried powdered solids/particles thus obtained can be filled spheres. There may be some degree of irregularity in shape depending upon the incorporated ingredients and the spray drying conditions. In some embodiments, the dispersion stability of spray-dried microspheres may appear to be more effective when an inflating agent (or blowing agent) is used during the drying process. In some embodiments, the feed may comprise an emulsion with an inflating agent as the disperse or continuous phase (the other phase being aqueous in nature). An inflating agent may be dispersed with a surfactant solution, using, for instance, a commercially available microfluidizer. This process may form an emulsion, which may be stabilized by an incorporated surfactant. When the blowing agent vaporizes during the spray-drying process, generally hollow, porous aerodynamically light microspheres may be produced. Nitrogen and carbon dioxide may be used as a blowing agent. In some embodiments, when the insoluble saccharide is the core with soluble oligosaccharide as the coating, the blowing agent may generate hollow, porous microspheres on the coating component.

Properties of the dried product, such as, for example, hygroscopicity, particle size, loose density, bulk density, tapped density and, chemical properties, may be affected by the spray drying process. Processing factors that may affect the properties of the dried product include inlet drying temperature, outlet drying temperature, humidity of the dryer, feed flow rate of the drying gas into the dryer, the properties of the to-be-dried liquid or slurry, and the atomizer/spray nozzle speed.

### Methods of Obtaining Saccharides

In some cases, the method may comprise obtaining the soluble saccharide and/or the insoluble saccharide from biomass. The biomass may comprise grain, grain chaff, bean pods, seed coats, seed materials, seaweeds, corn cob, corn stover, straw, wheat straw, rice straw, soy stalk, bagasse, sugar cane bagasse, miscanthus, sorghum residue, switch grass, bamboo, monocotyledonous tissue, dicotyledonous tissue, fern tissue, water hyacinth, leaf tissue, roots, vegetative matter, vegetable material, vegetable waste, hardwood, hardwood chips, hardwood pulp, softwood, softwood chips, softwood pulp, paper, paper pulp, cardboard, wood-based feedstocks, crab shells, squid biomass, shrimp shells, marine biomass, other suitable feedstocks, or a combination thereof. In some cases, the biomass may comprise plant biomass. The plant biomass may comprise corn. The corn for the biomass may comprise corn or maize. The corn for the biomass may comprise corn stover or corn straw. Corn stover may comprise corn leaves, stalks, or cobs. In other cases, the biomass may comprise lignocellulosic biomass. The plant biomass may comprise wood biomass or grass biomass. In some cases, the plant biomass may comprise bamboo, grass, hardwood stem, nut shell, rice straw, softwood stem, sugar cane bagasse, switch grass, or wheat straw. In various cases, a plant biomass may comprise sugar cane, wheat, sugar beet, switchgrass, miscanthus, poplar, willow, or sweet potato.

The soluble saccharide and the insoluble saccharide may be obtained from the biomass by hydrolysis, including by partial hydrolysis. In some cases, the method may comprise obtaining the soluble saccharide and the insoluble saccharide from the same biomass. In some cases, the method may comprise obtaining the soluble saccharide and the insoluble saccharide from the same biomass and the same hydrolysis reaction. In some cases, the method may comprise obtaining the soluble saccharide in the form of oligosaccharides by partial hydrolysis of a plant biomass and may comprise obtaining the insoluble saccharide in the form of the remaining undigested biomass.

Hydrolyzing the biomass may comprise using enzymes from a fungus. In some cases, hydrolyzing the biomass may comprise converting the polysaccharides in the biomass into one or more other forms of oligosaccharides. For example, a higher order form of polysaccharide may be converted to a lower order form of oligosaccharide. In some cases, the hydrolysis of the biomass may result in saccharides in forms other than monosaccharides. For example, hydrolyzing the biomass may result in disaccharides or oligosaccharides. The disaccharides or oligosaccharides may comprise any disaccharides or oligosaccharides described herein. The polysaccharides present in the biomass, which includes, but is not limited to, hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose may be cleaved into monosaccharides, disaccharides, or other forms of lower forms of oligosaccharides. The polysaccharides present in the biomass, which includes, but is not limited to, hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose may also be reduced to a lower amount in the hydrolyzed biomass compared to unhydrolyzed biomass. The resulting higher forms of oligosaccharides in the hydrolyzed biomass may comprise any soluble saccharides described herein. The resulting cello-oligosaccharide, xylo-oligosaccharide, or mannan-oligosaccharide may comprise any cello-oligosaccharides, xylo-oligosaccharides, or mannan-oligosaccharides described herein. In certain cases, the enzyme may convert the biomass into any soluble saccharides described herein. In addition, as many appropriate feedstocks are recalcitrant, pre-treatment of the feedstock prior to enzyme activity is also envisaged.

In some cases, the enzyme may be a crude enzyme. In a crude enzyme, the enzyme molecules may comprise at least 5 dry wt. %, 10 dry wt. %, 20 dry wt. %, 30 dry wt. %, 40 dry wt. %, 45 dry wt. %, 49 dry wt. %, or 49.5 dry wt. % of the molecules present in the crude enzyme. The crude enzyme may comprise substances other than the enzyme molecules. The substances other than the enzyme molecules may comprise 50.5 dry wt. %, 51 dry wt. %, 55 dry wt. %, 60 dry wt. %, 70 dry wt. %, 80 dry wt. %, 90 dry wt. %, or 95 dry wt. % of the crude enzyme. In some cases, the crude enzyme may be obtained as a lysate of a fungus. The crude enzyme may comprise a lysate of a fungus. In some cases, the crude enzyme may be obtained as a secretion of a fungus. The crude enzyme may comprise a culture broth of a fungus. In some cases, the crude enzyme may have a comparable enzymatic activity level of a purified enzyme as described herein. In some cases, the crude enzyme may have an enzymatic activity level of at least 50%, 60%, 70%, 80%, 90%, 95%, 99%, or 99.5% of the purified enzyme. In some cases, the crude enzyme may have an enzymatic activity level of at least 100%, 150%, 200%, 250%, 500%, 750%, 1000%, or 10000% of the purified enzyme.

A purified enzyme may have less than 0.5 dry wt. %, 0.3 dry wt. %, or 0.1 dry wt. % of other substances. In some cases, the enzyme may be a purified enzyme. In a purified enzyme, the enzyme molecules may comprise at least 50 dry wt. %, 60 dry wt. %, 70 dry wt. %, 80 dry wt. %, 90 dry wt. %, 95 dry wt. %, 99 dry wt. %, or 99.5 dry wt. % of the molecules present in the purified enzyme. The purified enzyme may consist essentially of enzyme molecules. For example, the purified enzyme may have less than 0.5 dry wt. %, 0.3 dry wt. %, or 0.1 dry wt. % of other substances.

The enzyme in the crude enzyme or the purified enzyme may comprise a cellulase or a hemicellulase. The enzyme in the crude enzyme or the purified enzyme may comprise a cellulase. The enzyme in the crude enzyme or the purified enzyme may comprise a hemicellulase. The enzyme in the crude enzyme or the purified enzyme may comprise an enzyme that can hydrolyze hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose.

The fungus may comprise a filamentous fungus. The filamentous fungus may synthesize an enzyme that can hydrolyze or at least partially hydrolyze the biomass. The filamentous fungus may secrete the enzyme that can hydrolyze the biomass. The filamentous fungus may synthesize an enzyme that can partially hydrolyze the biomass. The fungus may be a teleomorph. In other cases, the fungus may be an anamorph. In some cases, the fungus may comprise a non-filamentous fungus. In some cases, the fungus may be a yeast. The fungus may be a mold. In some cases, the fungus may be isolated from the environment. In other cases, the fungus may be cultured in a laboratory environment.

The method may comprise a Trichoderma species. The fungus may be Trichoderma reesei. The fungus may also be Trichoderma reesei RUT-C30. The fungus may be Aspergillus niger. In some cases, the fungus may also be a Pachybasium species, a Longibrachiatum species, a Saturnisporum species, or a Hypocreanum species. In some cases, the Trichoderma species may synthesize a cellulase and hemicellulase. In some cases, the Trichoderma species may secrete a cellulase and hemicellulase. In some cases, Trichoderma reesei may synthesize a cellulase and hemicellulase. In some cases, Trichoderma reesei may secrete a cellulase and hemicellulase. In some cases, the Trichoderma species may be isolated from the environment. In some cases, the Trichoderma species may be cultured in a laboratory environment. In some cases, Trichoderma reesei may be isolated from the environment. In some cases, Trichoderma reesei may be cultured in a laboratory environment. In some cases, the Trichoderma species may be obtained from a frozen stock. In other cases, the Trichoderma species may be lyophilized. The Trichoderma species may be in a powder form. In some cases, Trichoderma reesei may be cultured in a laboratory environment. In some cases, Trichoderma reesei may be obtained from a frozen stock. In other cases, Trichoderma reesei may be lyophilized. Trichoderma reesei may be in a powder form.

In some cases, the composition may include at least 1% w/w, 2% w/w, 3% w/w, 4% w/w, 5% w/w, 10% w/w, 15% w/w, 20% w/w, 25% w/w, 30% w/w, or more of cellobiose, xylobiose, mannobiose (e.g., Man-β-1,4-Man), Glc-β-1,4-Man, Man-β-1,4-Glc, laminaribiose, gentiobiose, sophorose, maltose, lactose, or sucrose. In certain cases, the composition may include at least 1% w/w, 2% w/w, 3% w/w, 4% w/w, 5% w/w, 10% w/w, 15% w/w, 20% w/w, 25% w/w, 30% w/w, or more of cellotriose, xylotriose, monoarabinosylated xylobiose, monoglucuronosylated xylobiose, maltotriose, mannotriose (e.g., Man-β-1,4-Man-β-1,4-Man), Glc-β-1,4-Man-β-1,4-Man, Man-β-1,4-Glc-β-1,4-Man, Man-β-1,4-Man-β-1,4-Glc, Man-β-1,4-Glc-β-1,4-Glc, Glc-β-1,4-Man-β-1,4-Glc, Glc-β-1,4-Glc-β-1,4-Man, Glc-β-1,3-Glc-β-1,4-Glc, or Glc-β-1,4-Glc-β-1,3-Glc. In certain instances, the composition may include at least 1% w/w, 2% w/w, 3% w/w, 4% w/w, 5% w/w, 10% w/w, 15% w/w, 20% w/w, 25% w/w, 30% w/w, or more of xylotetraose, cellotetraose, monoarabinosylated xylotriose, monoglucuronosylated xylotriose, diarabinosylated xylobiose, diglucuronosylated xylobiose, maltotetraose, mannotetraose (e.g., Man-β-1,4-Man-β-1,4-Man-β-1,4-Man), Glc-β-1,4-Man-β-1,4-Man-β-1,4-Man, Man-β-1,4-Glc-β-1,4-Man-β-1,4-Man, Man-β-1,4-Man-β-1,4-Glc-β-1,4-Man, Man-β-1,4-Man-β-1,4-Man-β-1,4-Glc, Glc-β-1,4-Glc-β-1,4-Man-β-1,4-Man, Man-β-1,4-Glc-β-1,4-Glc-β-1,4-Man, Man-β-1,4-Man-β-1,4-Glc-β-1,4-Glc, Glc-β-1,4-Man-β-1,4-Glc-β-1,4-Man, Glc-β-1,4-Man-β-1,4-Man-β-1,4-Glc, Man-β-1,4-Glc-β-1,4-Man-β-1,4-Glc, Glc-β-1,3-Glc-β-1,4-Glc-1,4-Glc, Glc-β-1,4-Glc-β-1,3-Glc-1,4-Glc, Glc-β-1,4-Glc-β-1,4-Glc-1,3-Glc, or Glc-β-1,3-Glc-β-1,4-Glc-1,3-Glc. In certain cases, the composition or the ingredient may include at least 0.01% w/w, 0.05% w/w, 0.1% w/w, 0.5% w/w, 1% w/w, 2% w/w, 5% w/w, 10% w/w, 15% w/w, 20% w/w, or more of xylopentaose, cellopentaose, monoarabinosylated xylotetraose, monoglucuronosylated xylotetraose, diarabinosylated xylotriose, diglucuronosylated xylotriose, maltopentaose, mannopentaose (e.g., Man-β-1,4-Man-β-1,4-Man-β-1,4-Man-β-1,4-Man), mixed-linkage glucan-derived pentasaccharide, or mannan-derived pentasaccharide

The composition may comprise from 1% to 50%, 5% to 40%, 10% to 30%, or 15% to 25% w/w of cellobiose. The composition may comprise from 2.5% to 90%, 5% to 80%, 10% to 70%, or 20% to 60% w/w of xylobiose. The composition may comprise from 2.5% to 75%, 5% to 50%, 10% to 40%, or 20% to 30% w/w of xylotriose.

The average DP of the oligosaccharides in the composition may be from 1 to 50, 1.5 to 25, 2 to 15, 2.1 to 10, 2.1 to 7, or 2.2 to 5.

Oligosaccharide consumption can cause gastrointestinal distress, including diarrhea, discomfort, and bloating. The compositions described herein may have an improved gastrointestinal tolerance such as, less or no discomfort, bloating, diarrhea, or gastrointestinal distress as compared to a saccharide composition available commercially or a saccharide composition comprising primarily monosaccharides and/or disaccharides. For example, a subject who ingests one or more of the compositions provided herein may have an improved gastrointestinal tolerance such as, less or no discomfort, bloating, diarrhea, or gastrointestinal distress as compared to if, or when, the subject ingests a saccharide composition available commercially or a saccharide composition comprising primarily monosaccharides and/or disaccharides.

In some embodiments, the composition may comprise less than 1%, 5%, 10%, 15%, 20%, 25%, 30%, or 40% w/w monosaccharides. For example, the composition may comprise less than 20% w/w monosaccharides. The composition may include from 10% to 40%, 15% to 30%, 18% to 25%, or about 20% w/w monosaccharides. In some embodiments, the composition may comprise less than 1%, 5%, 10%, 15%, 20%, 25%, 30%, or 40% w/w glucose. For example, the composition may comprise less than 10% w/w glucose. The composition may include from 10% to 40%, 15% to 30%, 18% to 25%, or about 20% w/w glucose. In some embodiments, the composition may comprise less than 1%, 5%, 10, 1%, 20%, 25%, 30%, or 40% w/w xylose. For example, the composition may comprise less than 10% w/w xylose. The composition may include from 10% to 40%, 15% to 30%, 18% to 25%, or about 20% w/w xylose.

In certain cases, the ratio of glucose residues to xylose residues (e.g., glucose:xylose) within the composition may be from 1:1 to 1:9, 1:1 to 1:7, 1:1 to 1:5, 1:1 to 1:3, or 1:1 to 1:2.

In certain embodiments, the composition may comprise less than 30%, 40%, 50%, 60%, 65%, 70%, 75%, or 80% w/w disaccharides. For example, the composition may comprise less than 70% w/w disaccharides. The composition may include from 10% to 95%, 15% to 90%, 20% to 80%, 30% to 70%, or 40% to 60% w/w disaccharides. The composition may comprise from 5% to 95%, 10% to 92.5%, 15% to 90%, 20% to 70%, 30% to 60%, or 40% to 50% disaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. The composition may comprise from 1% to 75%, 2.5% to 60%, 5% to 50%, 10% to 40%, or 20% to 30% trisaccharides. In some cases, the composition may comprise at least 0.1%, 0.5%, 1%, 2.5%, 5%, 7.5%, 10%, 15%, or 20% w/w tetrasaccharides. For example, the composition may comprise at least 1% w/w tetrasaccharides. In various cases, the composition may comprise at least 0.01%, 0.05%, 0.1%, 0.2%, 0.3%, 0.5%, 0.5%, 1%, 2.5%, 5%, 7.5%, or w/w pentasaccharides. For example, the composition may comprise at least 0.10% w/w pentasaccharides.

Compositions are provided here may be used to prepare finished products. The composition may also be treated in some physical or chemical way before or during incorporation into a foodstuff, cosmetic, or nutraceutical. The composition may be directly incorporated into a product, or the composition may be incorporated into, for example, a dough, cake mixture, chocolate mixture, or other foodstuff precursor; a cosmetic base composition; or a nutraceutical, and, for example, be cooked or otherwise treated in a way which may cause chemical modification, a change of texture, a change of color, or other modification.

A foodstuff, cosmetic, or nutraceutical may be produced from a composition described herein. For example, in the food industry, the saccharide formulations produced by the current method may be used as sweeteners, bulking agents, added dietary fiber, or humectants. The ingredient may be used as a sugar substitute. The ingredient may be incorporated into cakes, breads, or other baked goods, or into chocolate or other confectionery such as toffee, fudge, meringue, jam, jelly, or caramel; or drinks, for example, to provide favorable taste or color characteristics or to increase dietary fiber content. In certain instances, the ingredient may be incorporated into animal feed, for example, either as an isolated ingredient or by utilizing the enzymatic reaction mixture directly as feed.

In the cosmetics industry, saccharides can be useful as ingredients, as they may improve texture and moisture retention, act as UV-absorbing molecules, maintain a gel or cream structure, and/or serve as bulking agents. The compositions described herein can be incorporated into nutraceutical compositions, as the dietary fiber they provide can encourage digestive health, well-regulated gut flora, and other benefits to wellbeing. In this context, they may also function as an ingredient in a probiotic drink or other prebiotic or probiotic formulation.

Compositions as described herein may be used to alter one or more properties of the finished product. Such properties include, but are not limited to, sweetness, texture, mouthfeel, binding, glazing, smoothness, moistness, viscosity, color, hygroscopicity, flavor, bulking, water-retention, caramelization, surface texture, crystallization, structural properties, and dissolution.

In some cases, the compositions described herein may provide a property to a finished product which is comparable to or better than the same property as provided by a saccharide mixture comprising primarily monosaccharides and/or disaccharides. The control composition may be a saccharide used commonly in consumables, for instance, a monosaccharide composition such as glucose, fructose, etc., a disaccharide composition such as sucrose or an artificial sugar composition. The control composition may be table sugar, corn syrup, high-fructose corn syrup, or any other suitable composition. The term “comparable,” as used herein, generally means that the two compositions may be up to 100%, up to 95%, up to 90%, or up to 80% identical. For instance, comparable can mean that the composition is up to 90% identical to the control composition.

In some cases, the compositions described herein may be used as sweetener compositions. Sweetener compositions may be used by themselves or as an ingredient in a finished product. The compositions described herein may provide about the same level of sweetness or greater sweetness than an identical amount of a control composition wherein the control composition comprises primarily monosaccharides and/or disaccharides. The compositions described herein may be used to replace the control composition as the sweetener in a finished product. In some cases, the sweetness of a composition may be 5%, 10%, 15%, 20%, 30%, 40%, 50%, 70%, 80%, 90%, or 100% more than an identical amount of the control composition.

The compositions described herein may provide a comparable flavor profile or better flavor profile than an identical amount of a control composition wherein the control composition comprises primarily monosaccharides and/or disaccharides. The compositions described herein may be used to replace the control composition as a flavor enhancer in a finished product. In some cases, the flavor of a composition may be 5%, 10%, 15%, 20%, 30%, 40%, 50%, 70%, 80%, 90%, or 100% more than an identical amount of the control composition.

The compositions described herein may provide a comparable texture profile or better texture profile than an identical amount of a control composition wherein the control composition comprises primarily monosaccharides and/or disaccharides. The compositions described herein may be used to replace the control composition as a texture enhancer in a finished product.

The compositions described herein may provide a comparable binding profile or better binding profile than an identical amount of a control composition wherein the control composition comprises primarily monosaccharides and/or disaccharides. The compositions described herein may be used to replace the control composition as a binding enhancer in a finished product.

The compositions described herein may provide a comparable glazing profile or better glazing profile than an identical amount of a control composition wherein the control composition comprises primarily monosaccharides and/or disaccharides. The compositions described herein may be used to replace the control composition as a glazing enhancer in a finished product.

The compositions described herein may provide a comparable moistness or better moistness than an identical amount of a control composition wherein the control composition comprises primarily monosaccharides and/or disaccharides. The compositions described herein may be used to replace the control composition to provide moistness in a finished product.

The compositions described herein may provide a comparable color profile or better color profile than an identical amount of a control composition wherein the control composition comprises primarily monosaccharides and/or disaccharides. The compositions described herein may be used to replace the control composition as a color enhancer in a finished product.

The compositions described herein may provide a comparable dissolution profile or better dissolution profile than an identical amount of a control composition wherein the control composition comprises primarily monosaccharides and/or disaccharides. The compositions described herein may be used to replace the control composition as a dissolution enhancer in a finished product. In some cases, the dissolution of a composition may be 5%, 10%, 15%, 20%, 30%, 40%, 50%, 70%, 80%, 90%, or 100% more than an identical amount of the control composition.

The compositions described herein may provide a comparable mouthfeel or better mouthfeel than an identical amount of a control composition wherein the control composition comprises primarily monosaccharides and/or disaccharides.

The compositions described herein may provide a comparable viscosity or better viscosity than an identical amount of a control composition wherein the control composition comprises primarily monosaccharides and/or disaccharides.

The compositions described herein may provide a comparable hygroscopicity or better hygroscopicity than an identical amount of a control composition wherein the control composition comprises primarily monosaccharides and/or disaccharides. In some cases, the hygroscopicity of a composition may be 5%, 1, 1⁵%, 20%, 30%, 40%, 50%, 70%, 80%, 90%, or 100% more than an identical amount of the control composition.

The compositions described herein may provide a comparable water-retention or better water-retention than an identical amount of a control composition wherein the control composition comprises primarily monosaccharides and/or disaccharides. In some cases, the water-retention of a composition may be 5%, 10%, 15%, 20%, 30%, 40%, 50%, 70%, 80%, 90%, or 100% more than an identical amount of the control composition.

The compositions described herein may provide a lower calorie composition than an identical amount of a control composition wherein the control composition comprises primarily monosaccharides and/or disaccharides. In some cases, the calorie count of a composition may be 5%, 10%, 15%, 20%, 30%, 40%, 50%, 70%, 80%, 90%, or 100% less than an identical amount of the control composition.

The compositions described herein may provide a lower glycemic index than an identical amount of a control composition wherein the control composition comprises primarily monosaccharides and/or disaccharides. In some cases, the glycemic index of a composition may be 5%, 10%, 15%, 20%, 30%, 40%, 50%, 70%, 80%, 90%, or 100% less than an identical amount of the control composition.

The compositions described herein may provide a comparable bulking or better bulking than an identical amount of a control composition wherein the control composition comprises primarily monosaccharides and/or disaccharides.

The compositions described herein may provide a comparable caramelization or better caramelization than an identical amount of a control composition wherein the control composition comprises primarily monosaccharides and/or disaccharides.

The compositions described herein may provide a comparable surface texture or better surface texture than an identical amount of a control composition wherein the control composition comprises primarily monosaccharides and/or disaccharides.

The compositions described herein may provide a comparable crystallization or better crystallization than an identical amount of a control composition wherein the control composition comprises primarily monosaccharides and/or disaccharides.

The compositions described herein may provide comparable structural properties as an identical amount of a control composition wherein the control composition comprises primarily monosaccharides and/or disaccharides.

The compositions described herein may provide less aftertaste compared to an identical amount of a control composition wherein the control composition comprises primarily monosaccharides and/or disaccharides.

Different compositions of oligosaccharides may have improved dissolution profiles, hygroscopicity profiles, and taste profiles compared to the oligosaccharides used alone. In some embodiments, the addition of the insoluble polysaccharides (a core component) to the soluble oligosaccharides (a coating component on the surface of the core component) improves the spray drying process and provides better processability when compared to the spray drying process for drying the same oligosaccharides alone. For example, the addition of the insoluble polysaccharides to the compositions reduces sugar hygroscopicity of the dried product and reduces the tendency of the dried product to stick to walls of the dryer or the sides of the packaging materials.

Stickiness for a food or food ingredient may refer any one of the followings: adhesion to the processing equipment, cohesion of powders, sticking to the packaging, and sticking to fingers or part of the mouth. There are methods to measure food or food ingredient stickiness: a probe tack test or a peel test. In a probe tack test, one can calculate the negative area of a force-time graph, either in Texture Profile Analysis tests with a double cycle, or single cycle tests. The probe tack test is standardized by ASTM D2979 which was withdrawn without a replacement in April 2019. There are a few stands for testing the peel resistance of adhesive bonds, including, for example, ASTM D6862-11, ASTM D903-98, D1876-08, ASTM D3167-10, and ASTM D1781-98.

The compositions as described herein may be used to increase the fiber content of a finished product such as a foodstuff or a nutraceutical. The compositions may provide a higher level of fiber in the finished product as compared to an identical amount of a control composition wherein the control composition comprises primarily monosaccharides and/or disaccharides. In some cases, the compositions may improve the fiber content of the finished product without negatively, or substantially negatively, affecting any other properties such as taste, sweetness, mouthfeel, texture, binding, or any other properties described herein. In some cases, the fiber content of a composition may be 5%, 10%, 15%, 20%, 30%, 40%, 50%, 70%, 80%, 90%, or 100% more than an identical amount of the control composition.

Ingredients may be used to alter the properties of a finished product such as foodstuff or nutraceutical or cosmetic. In order to alter the properties of the finished products, the finished products may additionally comprise a polysaccharide, for example, a cellulosic polysaccharide, such as cellulose, or a polysaccharide derivative, for example, a cellulose derivative, such as carboxymethylcellulose, or a polysaccharide aggregate, for example, a portion of lignocellulosic biomass. In some instances, the finished products can comprise from greater than 0 dry wt. % to 40 dry wt. % of polysaccharide, polysaccharide derivative, or polysaccharide aggregate, for example, from greater than 1 dry wt. % to 30 dry wt. % of polysaccharide, polysaccharide derivative, or polysaccharide aggregate, for example, from greater than 5 dry wt. % to 25 dry wt. % of polysaccharide, polysaccharide derivative, or polysaccharide aggregate, for example, from greater than 10 dry wt. % to 20 dry wt. % of polysaccharide, polysaccharide derivative, or polysaccharide aggregate.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### EXAMPLES

The following illustrative examples are representative of embodiments of the compositions and methods described herein and are not meant to be limiting in any way.

### Example 1—Compositions Used

One composition used in this work was Unhydrolyzed corn cob Fiber (UHF). The particle size of UHF was measured using sieves with different sizes. The amount of corn cob fiber particles retained by each size is summarized in Table 1. The cellulose and hemicellulose composition of UHF is summarized in Table 2.

TABLE 1
The amount of UHF particles retained by different sieve sizes

| | Mass of Corn Cob |
|---|---|
| | Particles retained by |
| Sieve size (μm) | each sieve (%) |
| 355-500 | 50 |
| 200-355 | 35 |
| 100-200 | 10 |
| 53-100 | 4 |
| 1-53 | 1 |

TABLE 2
The Composition of UHF vs. Partially Hydrolyzed Corn Cob Fiber

| | Cellulose | Hemicellulose | Glucan/Xylan |
|---|---|---|---|
| Sample | (%) | (%) | (%) |
| Unhydrolysed corn cob | 46.2 | 40.1 | 1.2 |
| Fiber (UHF) | | | |
| Partially Hydrolyzed | 76.3 | 14 | 5.5 |
| corn cob Fiber (PHF) | | | |

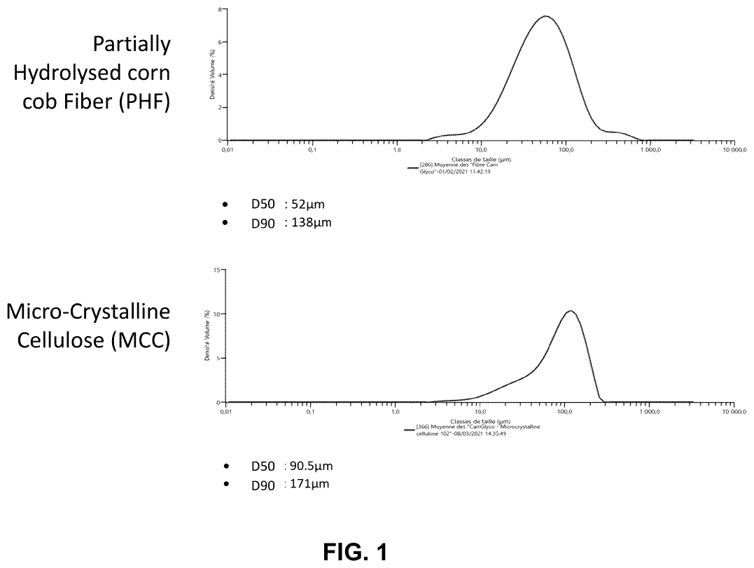

Another composition used in this work was Partially hydrolysed corn cob Fiber (PHF). PHF was created by digesting corn cob fiber using a cocktail of filamentous fungal cellulases (from Trichoderma reesei strain RUT-C30), following a thermochemical pretreatment in alkaline conditions. PHF was isolated from the reaction mixture by filtration. The cellulose and hemicellulose composition of PHF is summarized in Table 2. As shown in FIG. 1, the D50 (the diameter where 50 percent of the distribution had a smaller size and 50 percent has a larger size) and D90 of PHF were 52 and 138 μm, respectively. The composition of ground UHF was different from that of PHF. Components such as lignin and hemicellulose (xylan) were lower in partially hydrolyzed corn cob fiber (PHF), but partially hydrolyzed corn cob fiber had a higher amount of cellulose, as compared to the composition of UHF (Table 2).

Another composition used in this work is Micro-Crystalline Cellulose (MCC). MCC fiber is commercially available pure partially hydrolyzed cellulose synthesized from α-cellulose precursor (e.g., wood). In the presence of water and mineral acid, the hydrolysis process breaks cellulose polymers into smaller chain polymers (microcrystals). The D10 (the diameter where 10 percent of the distribution had a smaller size and 90 percent has a larger size), D50, and D90 of MCC fiber were less than 50 in, 90-140 in, and at least 170 in, respectively. The cellulose and hemicellulose composition of MCC is summarized in Table 3.

As shown in Table 2, and Table 3, the cellulose content of native biomass raw material sources is not as high as MCC, the digested fiber (PHF) or the partially hydrolyzed oat fiber (POF).

TABLE 3
The Composition of Different Hydrolyzed Lignocellulosic Biomass

| Lignocellulosic | | | |
|---|---|---|---|
| Biomass | Cellulose (%) | Hemicellulose (%) | Lignin (%) |
| Bamboo | 49-50 | 18-20 | 23 |
| Corn Cobs | 45 | 35 | 15 |
| Corn Stover | 35-40 | 21-25 | 11-19 |
| Grasses | 25-40 | 35-50 | 10-30 |
| Hardwood Stems | 40-50 | 24-40 | 18-25 |
| Nut Shells | 25-30 | 25-30 | 30-40 |
| Rice Straw | 29-35 | 23-26 | 17-19 |
| Softwood Stems | 45-50 | 25-35 | 25-35 |
| Sugar Cane Bagasse | 25-45 | 28-32 | 15-25 |
| Switch Grass | 30-50 | 10-40 | 5-20 |
| Wheat Straw | 33-40 | 20-25 | 15-20 |
| MCC | >99 | <0.1 | N/A |
| UOF | 49 | 43 | 4 |
| POF | 78 | 10 | 9 |

### Example 2—Comparing Baked Products Made with Fibers of Various Processing Methods and Particle Sizes

Cookies made with 20% partially hydrolyzed corn cob fiber, 20% MCC fiber, 20% UHF with particle sizes<200 μm, and 20% UHF with particle sizes<500 μm were compared. The appearance and mouthfeel of the cookies were assessed. Partial hydrolysis of corn cob fiber generates fiber particles with a D50 of about 52 μm. Side-by-side comparisons suggests that even with a similar particle size, the baked goods made with partially hydrolyzed corn cob fiber are more palatable than those made with unhydrolyzed fiber.

The partially hydrolyzed corn cob fiber was produced according to Example 1.

To obtain UHF with particle sizes of <200 μm or <500 μm, UHF was blended in a blender to break down the particle size. The blended fiber was then passed through sieves with various sieve sizes. The proportion UHF particles retained by different sieves sizes is summarized in Table 4.

TABLE 4
The amount of UHF particles retained by different sieve sizes

| | Weight of UHF | Weight of UHF |
|---|---|---|
| Sieve size (μm) | particles (g) | particles (%) |
| 710 | 1.33 | 0.4 |
| 500 | 62.91 | 21.3 |
| 355 | 119.31 | 40.4 |
| 200 | 85.06 | 28.8 |
| 100 | 15.96 | 5.4 |
| 53 | 8.72 | 2.9 |
| Ground Fines | 2.38 | 0.8 |

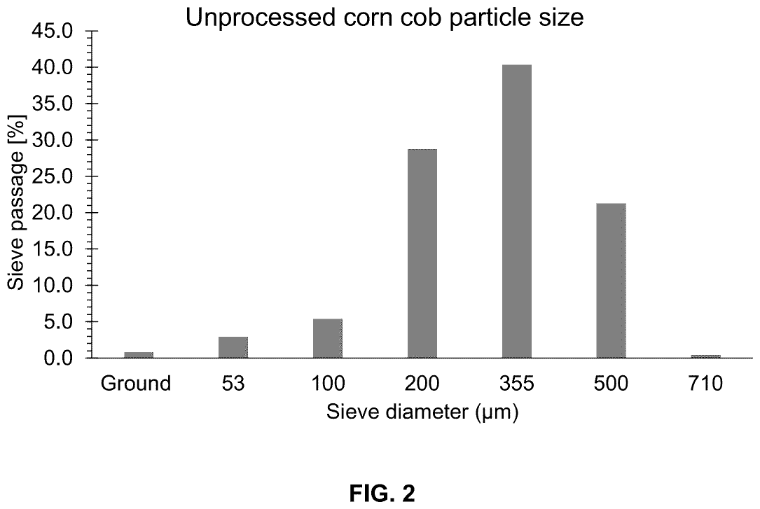

FIG. 2 shows the particle make-up of <200 μm or <500 μm UHF particles.

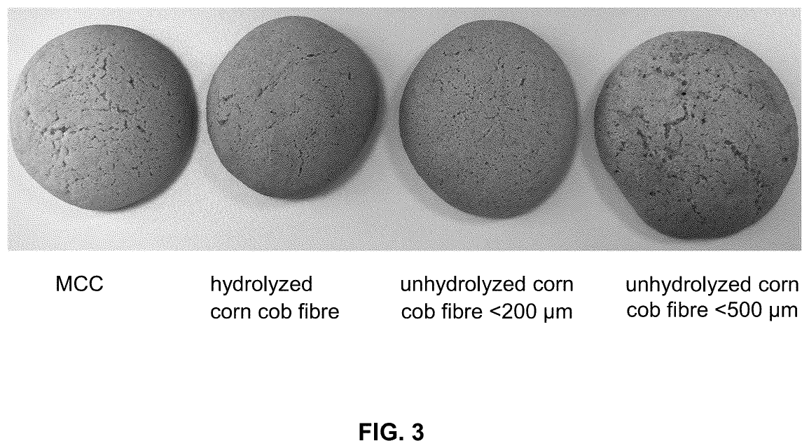

The cookies were made from cookie doughs with 20% fiber described in Table 4. Cookies were made according to the following recipe of a 25 g Cookie dough mix: Unsalted butter 5.2 g, saccharide mix (oligosaccharides and insoluble polysaccharides/fiber or sucrose) 9.7 g, eggs 2.3 g, vanilla bean paste 0.5 g, plain wheat flour 7.2 g, baking soda 0.2 g. To prepare a cookie dough mix, the soluble saccharides and partially hydrolyzed/unhydrolyzed fiber were mixed in a blender. The butter, eggs, vanilla bean paste, flour, and baking soda were added to the mixture. Materials enough for 10 cookies were prepared for each sample set. 25 g of the resultant cookie dough mix was placed on a baking tray. The diameter and height of the 25 g cookie dough were measured. The cookies were baked for 12 minutes at 180° C. As shown in FIG. 3, whole baked cookies made with fiber with similar particle sizes had a similar appearance. The cookie with a larger fiber particle spread more than those with a smaller fiber particle. The cookies made with MCC fiber, partially hydrolyzed corn cob fiber, and <200 μm UHF particles spread similarly. The cookie made with <500 μm UHF particles spread the most. Because of its high spreadability, the cookie also had the darkest surface color among all cookies.

The cookies were given to 13 respondents. They were asked to describe their mouthfeel. A summary of the description of the mouthfeel of the cookies by the respondents is given in Tables 5, 6, 7, and 8.

TABLE 5
A description of the mouthfeel of cookies made
with 20% partially hydrolyzed corn cob fiber

| Respondent | Description of the mouthfeel of the cookie |
|---|---|
| #1 | “A bit dry, smooth and soft texture” |
| #2 | “Crunchy, drying” |
| #3 | “Good texture, crispy outside” |
| #4 | “Not too dry, but leave dryness (sandy) aftertaste/feeling” |
| #5 | “Dry” |
| #6 | “Soft” |
| #7 | “Smooth with slightly gritty after feeling” |
| #8 | “Smooth, slightly cakey” |
| #9 | “Dry, little bit sticky” |
| #10 | “Dry, crumbly” |
| #11 | A little bit chewy, seems more soluble |
| #12 | “Soft, but tough bite, slight crunch, more chewy” |
| #13 | “Sticky” |

TABLE 6
A description of the mouthfeel of
cookies made with 20% MCC fiber

| Respondent | Description of the mouthfeel of the cookie |
|---|---|
| #1 | “Smooth, soft, less dry than <200 μm and hydrolysed |
| | corn cob, no sandy mouthfeel” |
| #2 | “Crunchy” |
| #3 | “Cakey inside, outside crispy, smooth texture” |
| #4 | Quite similar to hydrolysed corn cob fiber but not as |
| | dry + not much dryness after taste” |
| #5 | “Dry” |
| #6 | “Harder, crunchy” |
| #7 | “Powdery” |
| #8 | “Smooth, slightly cakey” |
| #9 | Dry, slightly unpleasant mouth coating |
| #10 | “Dry, crumbly” |
| #11 | “Also, quite chewy, not as soft as 20% hydrolysed corn |
| | cob fiber |
| #12 | Hard shell, crunchie inside” |
| #13 | “Hard and dry, does not stick to the teeth” |

TABLE 7
A description of the mouthfeel of cookies made
with 20% <200 μm UHF particles

| Respondent | Description of the mouthfeel of the cookie |
|---|---|
| #1 | “Bits, stuck in the throat, dry, sandy, hard to swallow” |
| #2 | “Crunchy” |
| #3 | “Sandy, bits” |
| #4 | “Brittle, dry, quite sandy” |
| #5 | “Dry” |
| #6 | “Softer, sticks less in the teeth” |
| #7 | “Gritty, slightly powdery” |
| #8 | “Gritty, sandy texture, caky biscuit, inside similar |
| | cakiness to hydrolysed corn cob fiber and commercial |
| | MCC” |
| #9 | “Dry, little bit grainy” |
| #10 | “Dry, crumbly” |
| #11 | “Feels a bit dry, very crumble” |
| #12 | “Soft but tough bite, slight crunch, coarse bits or sandy” |
| #13 | “Dry, but sticks to the teeth” |

TABLE 8
A description of the mouthfeel of cookies made
with 20% <500 μm UHF particles

| Respondent | Description of the mouthfeel of the cookie |
|---|---|
| #1 | “Dry, has bits that cannot be dissolved in mouth, |
| | sticks to teeth, get stuck in throat” |
| #2 | “Hard initial bite then slightly chewy” |
| #3 | “Have bits, hard” |
| #4 | “Dry, bit sticky after a while” |
| #5 | “Gritty” |
| #6 | “Hard outside, softer inside, harder bits in teeth” |
| #7 | “Very gritty” |
| #8 | “Bits/chunks, crunchier texture” |
| #9 | “Crunch, little bit grainy” |
| #10 | “Gritty/lumpy and dry” |
| #11 | “More crunchy, bitty, grainy” |
| #12 | “Hard shell, softer with a crunch, coarse bits” |
| #13 | “Dry, hard, bitty” |

Overall, the respondents found that the cookie made with MCC fibers was dry, smooth, and soft. The cookie made with partially hydrolyzed corn cob fibers was dry, smooth, and cakey inside. The cookie made with <200 μm UHF particles was bitty, sandy, and gritty. The cookie made with <500 μm UHF particles was sticky and gritty, with harder bits in the teeth.

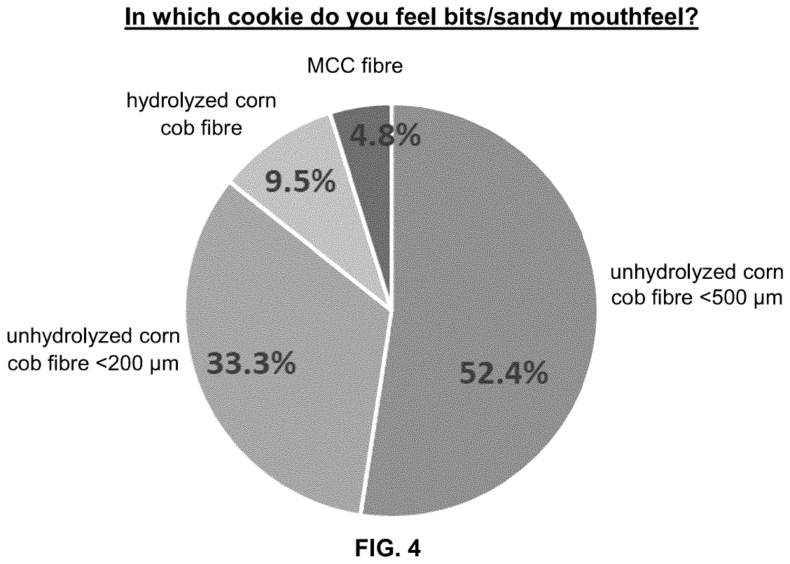

The respondents were asked if they noticed a difference in mouthfeel between the cookies made with <200 μm or <500 μm UHF particles. As shown in FIG. 4, all respondents noticed a difference in mouthfeel between the two cookies. A summary of the description of the mouthfeel of the cookies by the respondents is given in Table 9.

TABLE 9
A description of the difference in mouthfeel between the cookie made with 20% UHF
with <200 μm fiber particles and one made with 20% UHF with <500 μm fiber particles

| | Is there a difference between the cookies; description of the difference in the |
|---|---|
| Respondent | mouthfeel of the cookies |
| #1 | “Yes; mouthfeel of the cookie made with <500 μm UHF fiber particles is worse, |
| | bigger bits” |
| #2 | “Yes; mouthfeel of the cookie made with <500 μm UHF fiber particles is |
| | chewier” |
| #3 | “Yes; mouthfeel of the cookie made with <500 μm UHF fiber particles is bitty, |
| | sticky, clumpy” |
| #4 | “Yes; mouthfeel of the cookie made with <500 μm UHF fiber particles is a bit |
| | sticky after a while and stick on your teeth” |
| #5 | “Yes; mouthfeel of the cookie made with <500 μm UHF fiber particles is better” |
| #6 | “Yes; mouthfeel of the cookie made with <500 μm UHF fiber particles is more |
| | lumpy” |
| #7 | “Yes; mouthfeel of the cookie made with <500 μm UHF fiber particles is much |
| | gritter than that made with <200 μm UHF particles” |
| #8 | “Yes; mouthfeel of the cookie made with <200 μm UHF fiber particles is gritty, |
| | cookies made with have larger bits” |
| #9 | “Yes; mouthfeel of the cookie made with <500 μm UHF particles is crunchier, |
| | stickier towards the end” |
| #10 | “Yes; mouthfeel of the cookie made with <500 μm UHF particles is lumpy/ |
| | gritty” |
| #11 | “Yes; mouthfeel of the cookie made with <500 μm UHF particles is grainier” |
| #12 | “Yes; mouthfeel of the cookie made with <500 μm UHF particles is much harder/ |
| | firmer” |
| #13 | “Yes; mouthfeel of the cookie made with <500 μm UHF particles is gritty” |

The respondents were asked which cookie they could feel a bitty/sandy mouthfeel. Each respondent could pick two cookies. As shown in FIG. 4, about 85% of respondents felt a bitty/sandy mouthfeel in the cookie made with UHF; 52.38% of respondents (11/21) felt a bitty/sandy mouthfeel in the cookie made with UHF with <500 μm fiber particles. 33.3% of respondents (7/21) felt a bitty/sandy mouthfeel in the cookie made with UHF with <200 μm fiber particles. 9.5% of respondents (2/21) felt a bitty/sandy mouthfeel in the cookie made with partially hydrolyzed corn cob fiber. 4.8% of respondents (1/21) felt a bitty/sandy mouthfeel in the cookie made with MCC fiber. compares the whole baked cookies with different amounts of UHF and MCC fiber.

The respondents were asked which cookie's mouthfeel they preferred. Each respondent could pick one cookie. About 77% of respondents preferred the mouthfeel of the cookie made with partially hydrolyzed corn cob fiber or MCC fiber; 38.5% of respondents (5/13) preferred the mouthfeel of the cookie made with MCC fiber; 38.5% of respondents (5/13) preferred the mouthfeel of the cookie made with partially hydrolyzed corn cob fiber. 15.4% of respondents (2/13) preferred the mouthfeel of the cookie made with <200 μm UHF particles. Only 7.7% of respondents (1/13) preferred the mouthfeel of the cookie made with <500 UHF particles. This respondent suggested that this cookie was more crunchy and chewier than the others, which the respondent preferred.

The respondents were asked which cookie had the worst mouthfeel. Each respondent could pick one cookie. About 70% of respondents (9/13) said that the cookie made with <500 UHF particles had the worst mouthfeel. 15.4% of respondents (2/13) said that the cookie made with <200 UHF particles had the worst mouthfeel. 15.4% of respondents (2/13) said that the cookie made with partially hydrolyzed corn cob fiber had the worst mouthfeel. The cookie made with MCC fiber was not associated with a having the worst mouthfeel.

Therefore, even with a similar particle size, the baked goods made with partially hydrolyzed corn cob fiber are more palatable than those made with unhydrolyzed fiber.

### Example 3—Spray Drying with Insoluble Fiber can Improve the Drying of Saccharides

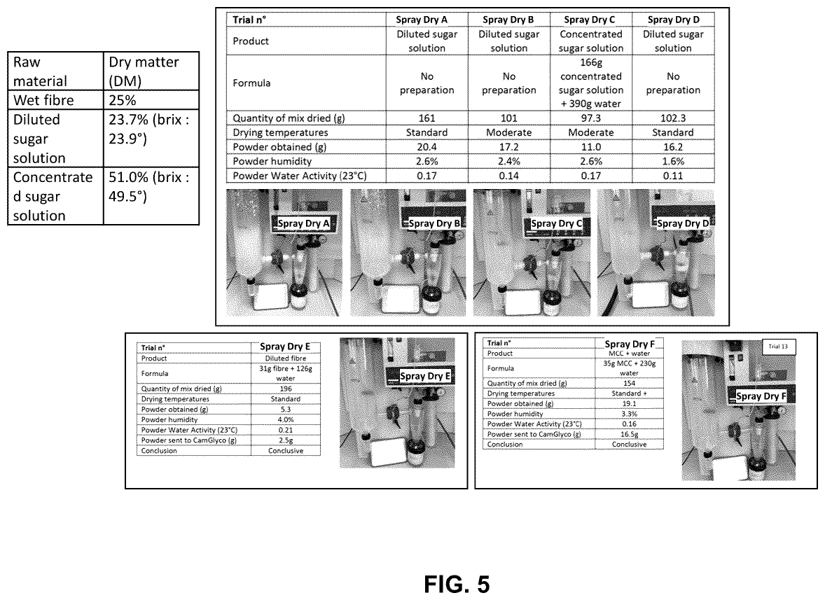

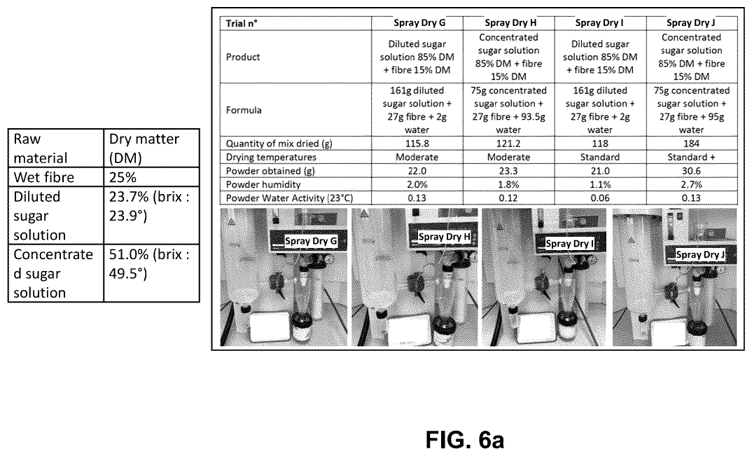

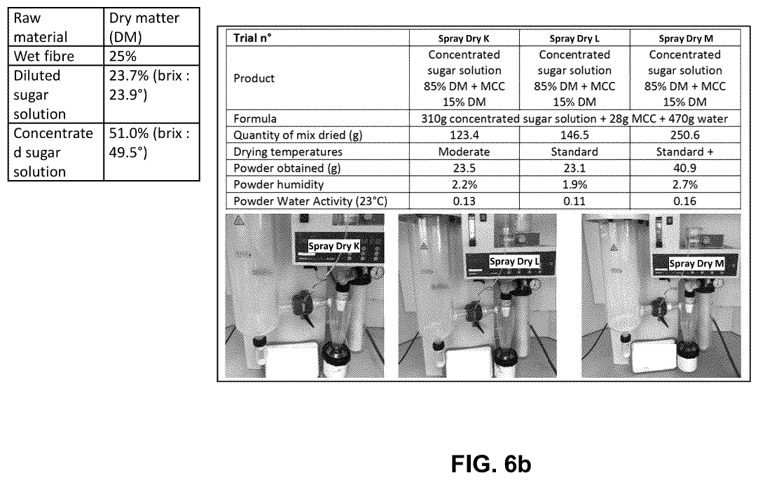

The impact of combining insoluble saccharides with soluble oligosaccharides (mixtures of COS and XOS) on spray drying was assessed with the following formulations: Diluted soluble oligosaccharide solution; Concentrated soluble oligosaccharide solution; Diluted fiber; PHF: diluted soluble oligosaccharide (ratio 15:85% dry wt.); PHF: concentrated soluble oligosaccharide (ratio 15:85% dry wt.); MCC: concentrated soluble oligosaccharide (ratio 15:85% dry wt.). Brix measurements and dry matter for each composition are described in FIGS. 5 and 6A/6B.

The soluble oligosaccharide solutions were successfully spray-dried in moderate drying conditions, though with a tendency to hygroscopicity and sensitivity to temperature. The spray-drying of the PHF itself was very good but requires an important dilution. Regarding soluble oligosaccharide+PHF spray-drying, and soluble oligosaccharide+MCC spray-drying, we observed an improvement in comparison to the drying of the soluble oligosaccharide alone. The PHF and the MCC played the role of carrier for the sugar reducing hygroscopicity and tendency to stick to/deposit on the walls of the chamber (FIGS. 5 and 6A/6B).

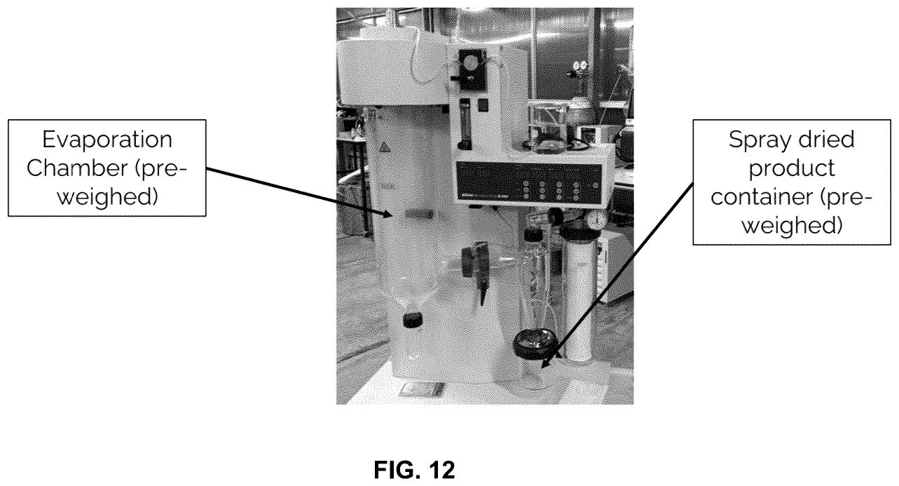

Each dried sample was further analysed by scanning electron microscopy (SEM). Pictures at two magnifications: 1000× and 5000× are presented in FIGS. 7 and 8. The dried soluble oligosaccharide gives a powder with a smooth surface. The spray-dried powder has a round shape, whereas the vacuum dried powder (FIG. 11) has the form of a ground material.

The soluble oligosaccharide solutions can be spray-dried in moderate drying conditions (moderate temperature and slow flow rate). We observed during trials Spray Dry A-D the soluble oligosaccharide's tendency to be hygroscopic and sensitive to temperature. The spray-drying of PHF itself is very good as soon as it can be sprayed in good conditions. A dilution was necessary to obtain a nice spray of the fiber, suggesting that a dry matter between 5% and 10% would be required to spray the PHF suspension (trial Spray Dry E).

When the soluble oligosaccharide solution is dried with either PHF or MCC (trials Spray Dry G-M), we observed an improvement in the drying. Indeed, the PHF and MCC seems to play the role of carrier and reduces the stickiness and hygroscopicity of the soluble oligosaccharide. The drying conditions can be optimized with such a mix.

The spray-drying of the MCC is very good as soon as it can be sprayed in good conditions.

### Example 4—MCC Particle Size Impacts its Ability to Act as a Carrier During Spray Granulation

The impact of insoluble saccharide (microcrystalline cellulose (MCC)) particle size on spray granulation was assessed using four different insoluble saccharide sources (MCC sources) with differing D50 particle sizes and using three different soluble oligosaccharide compositions 99% xylo-oligosaccharides (XOS99), 95% xylo-oligosaccharides (XOS95), cello-oligosaccharides (99% cellobiose). The dry insoluble saccharide was placed in the spray granulator and sprayed with spray solutions of different oligosaccharide concentration and composition. The conditions are reported in (Table 10).

TABLE 10
Summary of seven spray-granulating trials using different sizes of MCC

| | | MCC | MCC | MCC | MCC | MCC | MCC | MCC |
|---|---|---|---|---|---|---|---|---|
| | | Trial | Trial | Trial | Trial | Trial | Trial | Trial |
| | | A | B | C | D | E | F | G |
| Spray | XOS99 (%) | — | — | — | — | — | — | 64.4 |
| solution | XOS95 (%) | 22.5 | 37.5 | 37.5 | 37.5 | 37.5 | 64.5 | — |
| | Cellobiose (CB) (%) | 20 | 5 | 5 | 5 | 5 | 8.5 | 8.6 |
| | Spray solution | 42.5 | 42.5 | 42.5 | 42.5 | 42.5 | 73 | 73 |
| | oligosaccharide | | | | | | | |
| | concentration (%) | | | | | | | |
| | Water (%) | 57.5 | 57.5 | 57.5 | 57.5 | 57.5 | 27 | 27 |
| | XOS:CB ratio | 1.125:1 | 7.5:1 | 7.5:1 | 7.5:1 | 7.5:1 | 7.6:1 | 7.5:1 |

| Insoluble saccharide | | MCC | MCC | MCC | MCC | MCC | MCC | MCC |
|---|---|---|---|---|---|---|---|---|
| Carrier (MCC) | | Trial | Trial | Trial | Trial | Trial | Trial | Trial |
| MCC type | D50 (μm) | A | B | C | D | E | F | G |
| 101 | 45-75 | | | x | | | | |
| 102 | 90-140 | x | x | | | | x | x |
| 105 | 17-25 | | | | x | | | |
| 200 | 150-280 | | | | | x | | |

| | | | | | | | |
|---|---|---|---|---|---|---|---|
| Processability | Medium | Good | Good | Poor | Best | Medium | Medium |

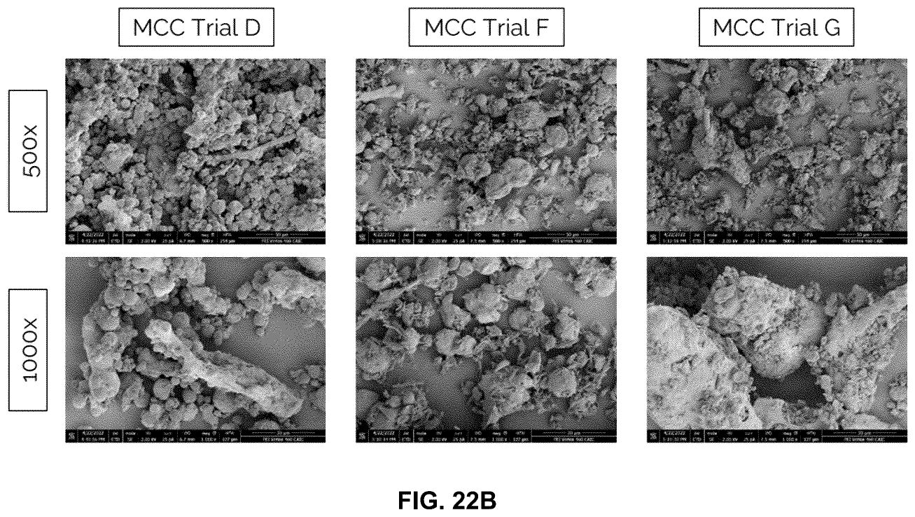

SEM imaging was also carried out on the spray granulated products. The images are reported in FIGS. 22A/22B 100× and 500× magnifications of MCC trials A, B, C and E, and at 500× and 1000× magnification for MCC trials D, F and G.

MCC trial A encountered some challenges due to the high concentration of cellobiose which precipitated out of solution and thus required constant stirring and caused some clogging on the nozzle. Despite this, little differences between MCC trial A and B can be seen (FIG. 22A), suggesting that the ratio of XOS to Cellobiose does not impact morphology or drying performance. Bulk density of the dried particles was also comparable at 847 g/L and 836 g/L respectively.

MCC trial C explored the utilization of a MCC grade with a smaller D50 (45-75 μm instead of 90-140). This grade of MCC gave better fluidization in the drier but resulted in smaller granules as seen in the SEM images.

MCC Trial D utilized the smallest grade of MCC which resulted of poor fluidization of the insoluble saccharide. A low bulk density (430 g/L) was achieved, and the drying had to be aborted. The granules obtained were smaller. The morphology as observed through SEM appears different with spheres adhering to fibers.

MCC Trial E used the largest MCC particle sizes which provided the best fluidization. The granules in FIG. 22A were comparable to MCC trials A and B, suggesting that MCC grades 102 and 200 (the largest grades investigated) were the most suitable for spray granulation applications.

MCC Trials F and G used a more concentrated soluble saccharide solution. Both trials resulted in finer granules with lower bulk densities (450 g/L and 530 g/L, respectively).

This trial showed that smallest insoluble saccharide fibers result in a less easily fluidized bed, making processing difficult. Smaller fibers also resulted in the smaller granules.

Whilst solubility of the soluble saccharides in the spray solution had an impact, the precise ratio of the oligosaccharides did not, displaying flexibility of application.

Higher solids content in the spray solution resulted in more challenging drying despite reducing the evaporative requirements.

Different oligosaccharide sources (XOS95 and XOS99) resulted in difference performance with material spray dried with XOS99 resulting in very fine particles that made sieving after drying challenging.

### Example 5—Drying Insoluble Saccharides with Soluble Oligosaccharides Improves Functionality in Food Products

To assess the impact of spray drying on the functionality of insoluble saccharide: soluble oligosaccharide compositions comprised of xylo-oligosaccharides (XOS), cello-oligosaccharides (COS) and microcrystalline cellulose (MCC), cookies were baked replacing sugar using:
a. 75:10:15 XOS:COS:MCC composition that has been spray-dried (Trial Spray Dry M—FIG. 6B)
b. 75:10:15 XOS:COS:MCC composition that has been spray-granulated (MCC trial B from Table 10)
c. 75:10:15 XOS:COS:MCC composition that has been dry-mixed by combining powders of each of the three components separately

Cookies were made by combining 27 g unsalted butter, 50 g saccharide mixtures, 12 g whisked egg, 2.5 g vanilla bean paste, 37 g plain flour and 1.2 g baking soda before being baked for 15 minutes at 350° F.

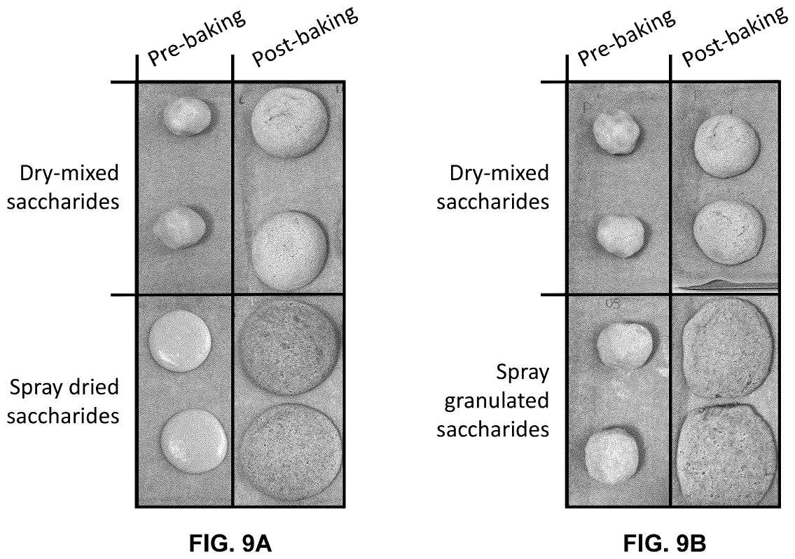

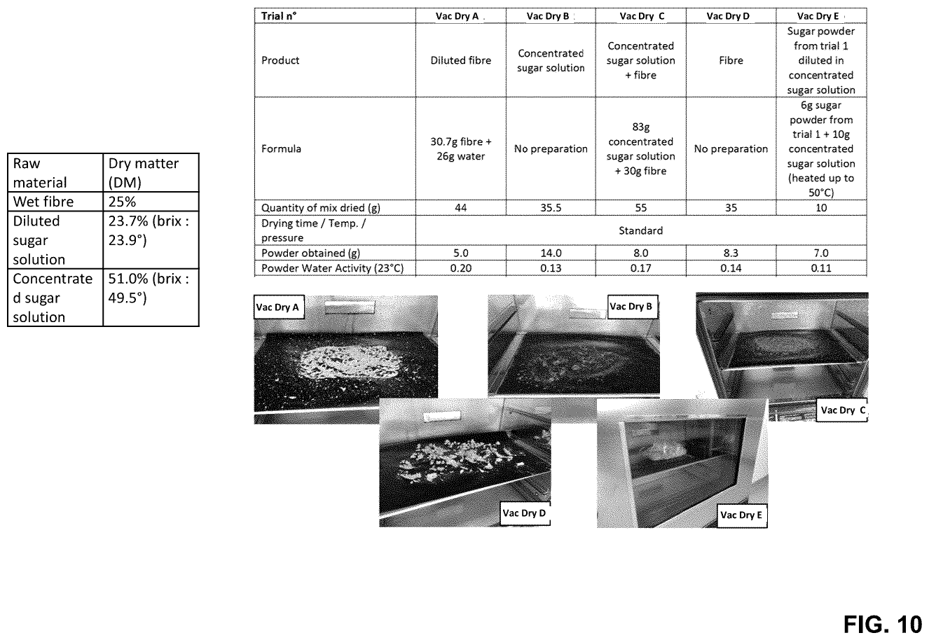

The results are shown in FIGS. 9A/9B. Prior to baking, dry-mixed and spray granulated cookie doughs looked identical, as hard balls of dough, and spray dried cookie doughs were softer and formed disk shapes when placed onto a flat surface. But after baking the cookie containing the spray dried saccharide mixture and the cookie containing the spray granulated saccharide mixture spread in a way that a cookie containing sucrose would do, whereas the cookie containing the dry-mixed mixture did not and instead remained as a thick cakey structure.

### Example 6—Vacuum Drying

The impact of combining insoluble saccharides with soluble oligosaccharides on vacuum drying was assessed with the following formulations: PHF (Trial Vac Dry A—dilute fiber; Trial Vac Dry D—25% fiber dry weight); Concentrated soluble oligosaccharide solution (51%; brix 49.5°—Trial Vac Dry B); Concentrated soluble oligosaccharide solution: PHF (85%:15% dry weight—Trial Vac Dry C); concentrated soluble oligosaccharide solution (78%, brix 78.5°—Trial Vac Dry E). The vacuum dried powder has the form of a ground material. This technology could be an interesting option to dry the oligosaccharide solution provided a high concentration could be reached. PHF could be dried with this technology, but a dilution would still be necessary to bring it into a pumpable state (˜15% dry matter).

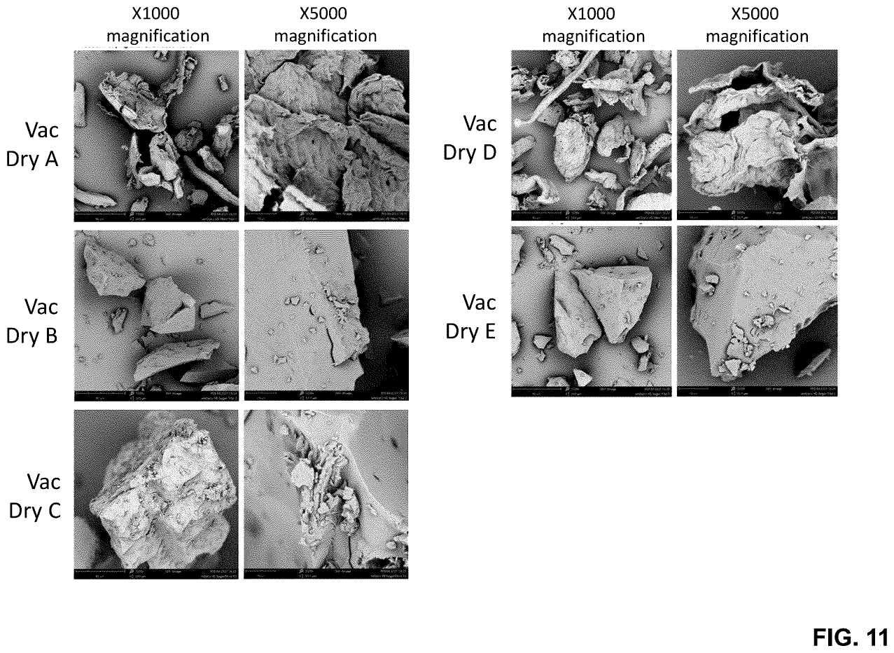

The pictures in FIG. 10 were taken at the end of each trial, except for trial Vac Dry E (taken during trial). After each trial, it was possible to recover powder. The cakes were crushable. Such low dry matter is expected to reduce the industrial productivity and can be tested.

SEM images were collected on each powder sample. Pictures at two magnifications: 1000× and 5000× are presented in FIG. 11. The dried fiber is shaped like straws and balls, both on vacuum drying (Trial Vac Dry A and D) and spray-drying. The vacuum dried concentrated soluble oligosaccharide solutions show an angular morphology of the particles with irregular and sharper edges compared to the spray drier and/or spray granulated morphologies. Trial Vac Dry C shows fibrous particles decorated with angular particles.

### Example 7—MCC Concentration Affects Spray Drying Performance

To assess the impact of MCC as the insoluble saccharide on the spray drying performance, solutions comprising different concentrations of MCC were prepared. Powdered soluble oligosaccharides were mixed with MCC and water in varying concentrations to obtain a slurry of 50% dry wt. and increasing MCC concentrations of: 0% w/w; 2.5% w/w 5% w/w; 10% w/w 15% w/w; and 20% w/w. The quantities used are shown in Table 11.

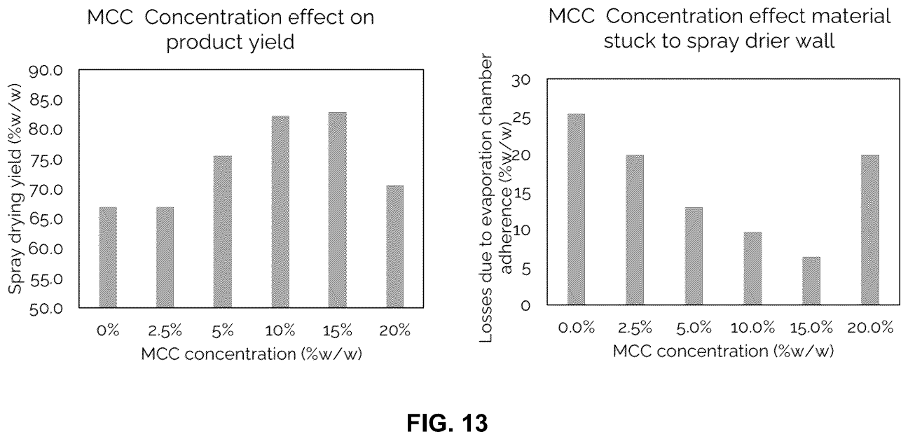

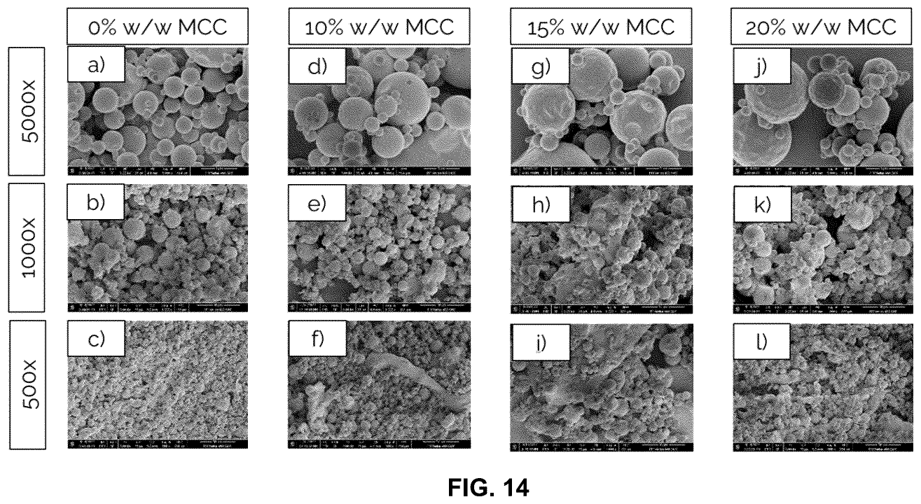

The material was successfully dried in moderate conditions (130° C. inlet temperature, 3 mL/min feed rate and 100% aspiration rate) in a lab-scale spray drier (shown in FIG. 12). The spray dried material in the product container was collected and weighed. The spray drying yield was obtained by dividing the recovered product by the starting mass of saccharides. The material stuck in the evaporation chamber was also weighed to establish drying losses. The spray drying yield and the losses to the evaporation chamber due to material stickiness are reported in FIG. 13.

The drying yield improved with increasing MCC concentration; however, beyond a certain concentration the yield started to decline, suggesting an optimum concentration of MCC for spray drying at around 15% w/w. Similarly, the stickiness of the product, which is measured by the amount of product lost to the evaporation chamber wall is at its lowest at 15% MCC w/w. This suggests that the insoluble saccharide, which acts as a carrier has a beneficial effect on spray drying but this is limited to a specific concentration range. For MCC this appears to be 10%-15% w/w.

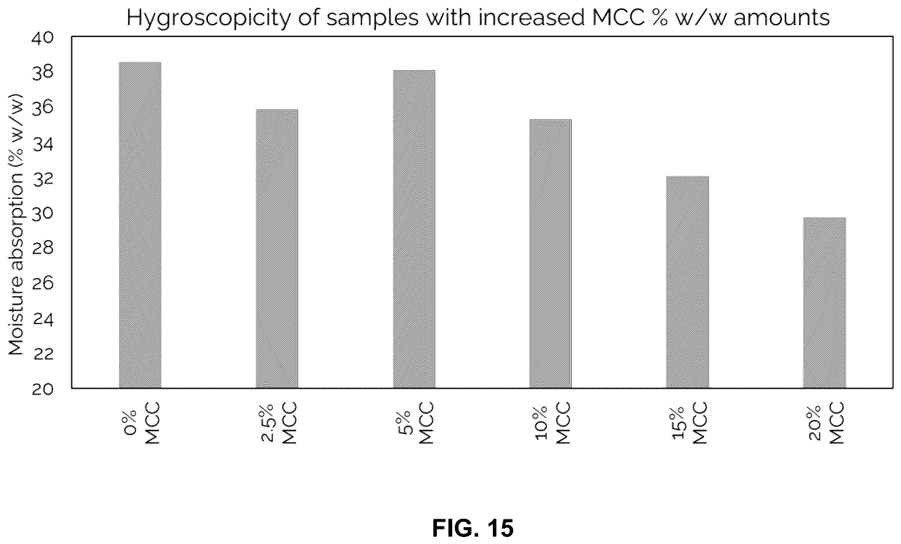

Spray dried samples were also imaged by Scanning Electron Microscopy (SEM) at 500×, 1000× and 5000× magnification. These are shown in FIG. 14. FIG. 14 panel A shows 0% MCC at 5000× magnification demonstrate how the soluble saccharides dry in spheres which then attach to each other to create a complex network structure. At lower magnification and higher fiber content (FIG. 14. Panels E, F, H, I, K, and L) it is possible to see how the soluble saccharide spheres surround longer insoluble saccharide particles, which are not present in the 0% MCC sample.

The spray drying process results in a product with variably sized spherical soluble saccharide particles that have a tendency to form irregular branched structures with relatively large surface area (vs larger spheres of uniform size) which can aid more rapid dissolution of the powder into a solvent phase.

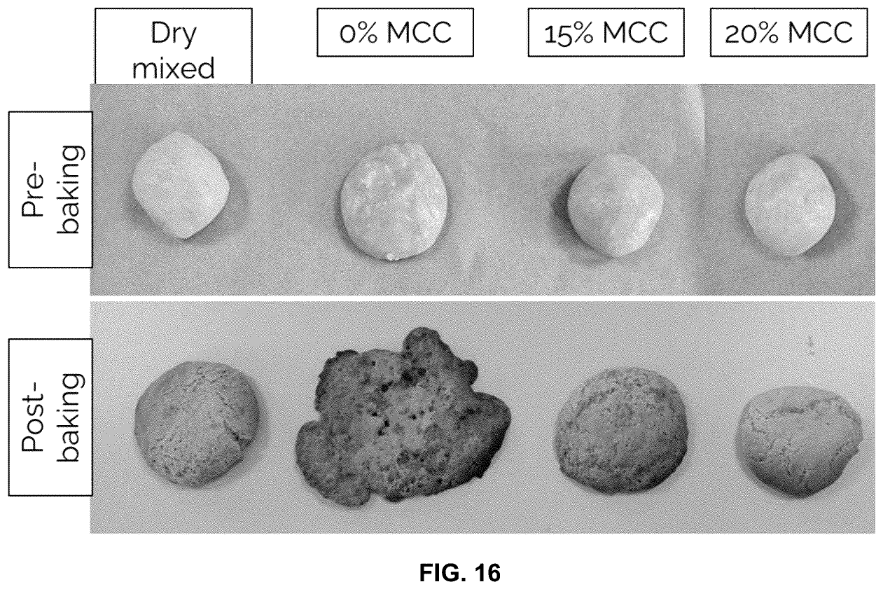

Hygroscopicity was measured by incubating the samples for one week at 85% RH, 20° C. The percentage increase in the sample weight due to moisture absorption is reported as a measure of hygroscopicity in FIG. 15. The hygroscopic tendencies of the spray dried product decreased with increasing fiber content. This suggests that the addition of fiber can be beneficial to improving the storage of the product, e.g. by acting as an anti-caking agent, as well as the drying performance.

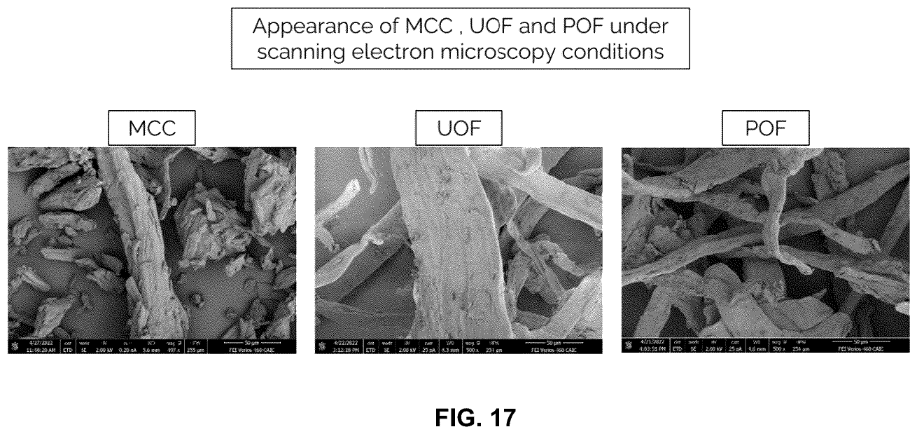

To assess the impact of MCC concentration on functionality of the final product, a representative sub-sample of each of the compositions dried by spray drying were tested in a food product. This was compared to a control composition made by dry blending powders of the soluble saccharides XOS (75% w/w) Cellobiose (10% w/w) and MCC (15% w/w). Cookies were made according to the following recipe: Unsalted butter 6.7 g, saccharide mix 12.5 g, eggs 3 g, vanilla bean paste 2.1 g, plain wheat flour 9.7 g, baking soda 1 g. A 30 g portion was taken, and the dough was rolled into a ball and baked for 8 min at 180° C. Pictures before and after baking are shown in FIG. 16.

The appearance of the balls of dough before baking was very similar across the samples. After baking it is possible to see how the lack of MCC in the 0% MCC sample results in a cookie that has spread out and browned more rapidly than the other samples. The 15% w/w and 20% w/w samples show appealing browning and slight differences in spreadability, with the sample with 15% w/w MCC content spreading more than the dry mixed sample and the 20% w/w MCC material.

The insoluble saccharide contained in the product acts as a binder in the dough, preventing the dough to spread. Depending on the final food application, the insoluble saccharide content can be modulated to provide the desired amount of spread and browning.

MCC addition was found to improve spray drying yield, reduce stickiness and impact the spreading and browning of the sugars in a final food application. Further, insoluble saccharide presence reduced hygroscopicity, thereby improving stability of the product.

TABLE 11
Summary of spray drying trials using differing
concentrations of insoluble saccharides

| | | 0% | 2.5% | 5% | 10% | 15% | 20% |
|---|---|---|---|---|---|---|---|
| Target MCC concentration | | w/w | w/w | w/w | w/w | w/w | w/w |
| Soluble | XOS95 (g) | 37.5 | 37.5 | 37.5 | 37.5 | 37.5 | 37.5 |
| oligosaccharide | Cellobiose | 5 | 5 | 5 | 5 | 5 | 5 |
| components | (g) | | | | | | |
| | Total soluble | 42.5 | 42.5 | 42.5 | 42.5 | 42.5 | 42.5 |
| | (g) | | | | | | |

| | | | | | | |
|---|---|---|---|---|---|---|
| Insoluble polysaccharide (g) | 0 | 1.09 | 2.24 | 4.72 | 7.5 | 10.63 |
| Water (g) | 42.5 | 43.59 | 44.74 | 47.22 | 50 | 53.13 |

### Example 8—Modulation of Spray Drying Parameters Enables the Use of Different Types of Soluble and Insoluble Saccharides with Tunable Performance in Final Food Application

To determine the versatility of spray drying as a technology to dry different combinations of soluble and insoluble saccharides, a series of spray drying trials were performed. 50% dry wt. solutions were prepared with final solids compositions as described in Table 12. Trial A was also previously discussed in Example 7 (15% w/w MCC).

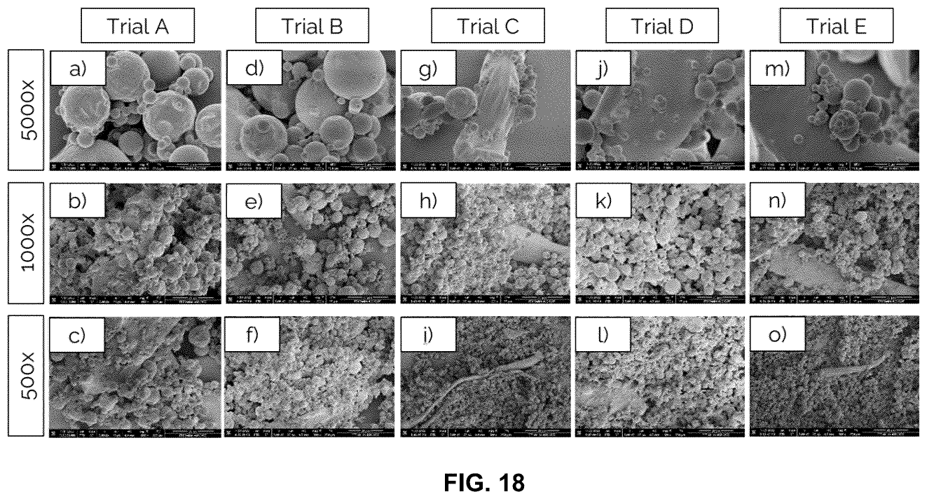

Insoluble saccharides used in this study were the previously described MCC (Example 1), Unhydrolyzed Oat Fiber (UOF) and Partially Hydrolyzed Oat Fiber (POF). The appearance of MCC, UOF and POF at 1000× magnification is shown in FIG. 17.

Soluble saccharides used in this trial were: XOS95; Cellobiose; and Fructo-oligosaccharides (FOS), a commercial preparation from Chicory root comprising fructose oligomers with a DP ranging between 3 and 10 (F.O.S by BioCare, UK).

UOF is a commercially available food grade oat fiber called Vitacel® HF-200 (JRS, Germany). POF was prepared by digesting UOF using a commercially available cocktail of cellulases from filamentous fungi. The POF was isolated from the reaction mixture by filtration. The cellulose, hemicellulose, and lignin compositions of MCC, UOF, and POF are summarized in Table 3.

The dried POF was ground and sieved. The fraction between sieves of 53 μm and 100 μm was collected and used in the trial (Trial C). Similarly, MCC was also sieved and the fraction between 53 μm and 100 μm was also collected and used in Trial B.

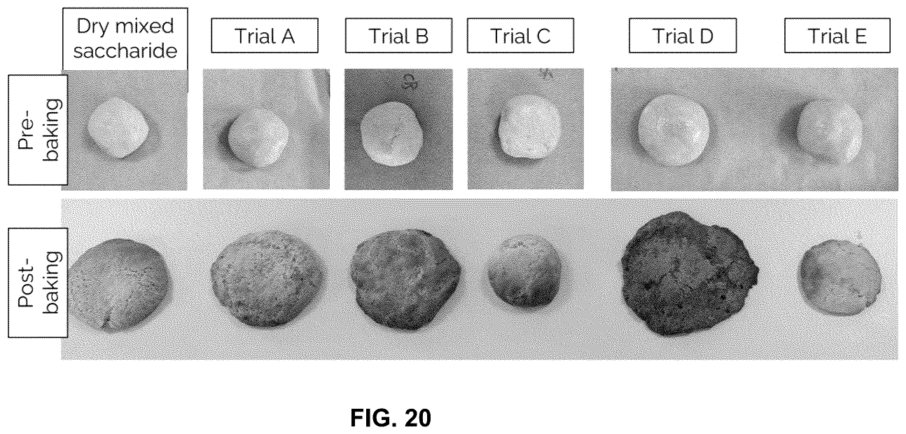

Attempts to dry soluble saccharides with UOF were made (Trials F and G). However, the saccharide solutions swelled and became gel-like slurries that were challenging to process. Therefore, it was not possible to spray dry the non-enzyme hydrolyzed oat fiber in its size distribution shown in FIGS. 19A/19B.

UOF was sieved and the smallest particles (<53 m) were used in combination with FOS and Cellobiose. This enabled spray drying, though the viscosity of starting saccharide solution (soluble oligosaccharides+insoluble fiber+water) was much greater than the solutions prepared with MCC and the partially enzyme hydrolysed oat fiber (POF). This suggests that the extent of hydrolysis undergone by MCC and POF is beneficial to the spray drying performance and overall processability of the saccharide solutions.

TABLE 12
Summary of spray drying trials using various
sources of soluble and insoluble saccharides

| | | Trial | Trial | Trial | Trial | Trial | Trial | Trial |
|---|---|---|---|---|---|---|---|---|
| Trial | | A | B | C | D | E | F | G |
| Soluble | XOS95 (%) | 75 | 75 | 75 | 0 | 75 | 0 | 75 |
| oligosaccharide | FOS (%) | 0 | 0 | 0 | 75 | 0 | 75 | 0 |
| components | Cellobiose (%) | 10 | 10 | 10 | 10 | 10 | 10 | 10 |
| | Total soluble (%) | 85 | 85 | 85 | 85 | 85 | 85 | 85 |
| Insoluble | MCC (%) | 15 | 0 | 0 | 15 | 0 | 0 | 0 |
| saccharide | MCC (>53 μm-100 | 0 | 15 | 0 | 0 | 0 | 0 | 0 |
| components | μm) (%) | | | | | | | |
| | UOF (%) | 0 | 0 | 0 | 0 | 0 | 15 | 15 |
| | UOF (<53 μm) (%) | 0 | 0 | 0 | 0 | 15 | 0 | 0 |
| | POF (>53 μm-100 | 0 | 0 | 15 | 0 | 0 | 0 | 0 |
| | μm) (%) | | | | | | | |
| | Total insoluble (%) | 15 | 15 | 15 | 15 | 15 | 0 | 0 |

| | | | | | | | |
|---|---|---|---|---|---|---|---|
| Processability | Good | Good | Good | Good | Fair | Poor | Poor |

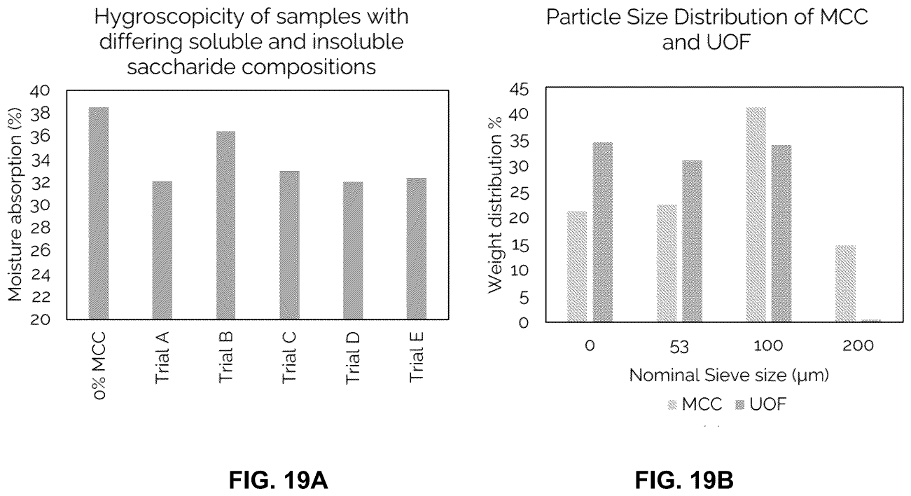

Trials A-E were successfully spray dried, and SEM imaging was performed at 500×, 1000× and 5000× magnification, shown in FIG. 18. The 5000× magnification (FIG. 18 at panels A, D, G, J, and M) shows how the soluble component dries in spheres regardless of the type of soluble saccharide. FIG. 18 at panels G, J, and M in particular, also showcase how the soluble oligosaccharide spheres are attached to the fiber particles during the spray drying process.

At lower magnification it is possible to see how the soluble saccharides are attached to and surround the fibers. The spheres are produced in a range of diameters. These create a branched structure with a large surface area. This would be conducive to faster dissolution of the product in a final application.

The spray dried samples were also tested for their hygroscopic behaviour by incubating samples for one week at 85% RH, 20° C. This is reported in FIG. 19A along with the particle size distribution of MCC and UOF, measured by sieving FIG. 19B. The samples were compared to the hygroscopic behaviour of the soluble saccharides spray dried in absence of any insoluble saccharide carrier (Example 7, 0% MCC).

Trial A and Trial B present different hygroscopic tendencies despite using the same source of insoluble saccharides, MCC. Trial B, however, employed only particles collected with a 53 μm sieve, meaning that the size distribution was narrower (53 μm to 100 μm). The broader distribution of MCC particle size in Trial A indicates that the hygroscopicity can be adjusted without altering which saccharides are used in the composition.

Trial C used a different insoluble saccharide (POF) with the same particle size distribution as the MCC used in Trial B. The product obtained in Trial C had a lower hygroscopicity than B.

The hygroscopicity of product from Trial D and Trial A are comparable indicating that the soluble component of the composition has a little effect on moisture absorption.

The UOF used in Trial E had a smaller size distribution than MCC (FIG. 19B). However trial D and E resulted in spray dried formulations with similar moisture absorption (hygroscopicity) properties, indicating that while partial hydrolysis is the key driver in the ability to spray dry the insoluble+soluble saccharide formulations and their ultimate physical/chemical characteristics, particle size of the insoluble saccharide component is also a factor, with smaller particle sizes performing similarly to partially hydrolysed insoluble fibers with larger particle sizes.

All trials A-E had lower hygroscopicity than the material with 0% MCC, suggesting that the presence of an insoluble saccharide is beneficial for reducing hygroscopicity of the final product. A lower hygroscopicity can improve shelf-life stability of the product.

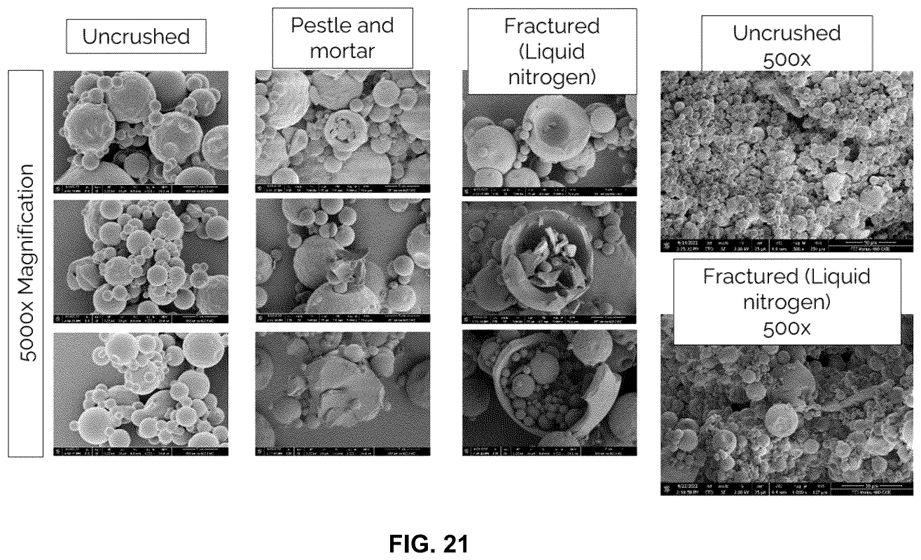

The spray dried products were tested in a cookie recipe. Cookies were made according to the following recipe: Unsalted butter 6.7 g, saccharide mix 12.5 g, eggs 3 g, vanilla bean paste 2.1 g, plain wheat flour 9.7 g, baking soda 1 g. A 30 g portion was taken, and the dough was rolled into a ball and baked for 8 min at 180° C. The spray dried samples were compared to a composition made by dry blending powders of the soluble saccharides XOS (75% w/w) Cellobiose (10% w/w) and MCC (15% w/w). Pictures before and after baking are shown in FIG. 20.

Although the particles dried similarly and have a similar structure, they behaved differently in baked products. The raw cookie dough balls appeared similar across the samples. Trial A and B contained the same insoluble saccharide (MCC); and despite the difference in particle size distribution, the cookies spread similarly. Trial C, which was prepared using POF, spread the least, suggesting that POF has high water and fat binding capacity, preventing spread of cookies during baking.

TABLE 13
Water retention capacity for different insoluble fibers

| Samples | WRC [g/g] |
|---|---|
| MCC partially hydrolyzed fiber | 2.41 |
| Partially hydrolyzed corn cob fiber | 3.08 |
| (PHF) | |
| Partially hydrolyzed oat fiber (POF) | 4.79 |
| Unhydrolyzed corn cob fiber (UHF) | 5.24 |
| Unhydrolyzed oat fiber (UOF) | 5.00 |

Spray drying was used to successfully dry various compositions, comprising different soluble and insoluble saccharides. Morphologically, the samples appeared very similar, with fully formed soluble saccharide spheres adhering to larger insoluble saccharide particles.

SEMs of the various samples revealed that the spray drying process results in particles of similar size regardless of soluble and insoluble saccharide utilized.

The particle size distribution as well as type of insoluble saccharide used affected product attributes such as hygroscopicity. Unlike the type of insoluble saccharide, particle size distribution, however, affected spreading and appearance of the food product very little.

With the same insoluble saccharide to adhere to different compositions of soluble saccharides presented comparable hygroscopicity, but differing browning (Trial A and D).

The work presented here shows that despite similar morphological structures, by correctly accounting for different features of soluble and insoluble saccharides, the product can be customized to obtain the desired features, such as enhanced browning, reduced spreading, or in the case of reduced hygroscopicity, increased shelf-life stability.

### Example 9—Structural Features of Spray Dried and Spray Granulated Material

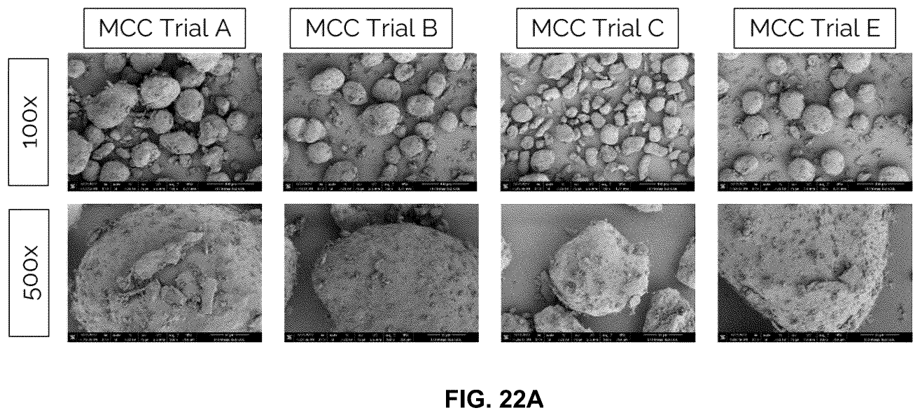

To examine the integrity of the soluble sugar spheres obtained during spray drying, product obtained in the 15% MCC spray drying trial described in Table 11 was inspected at 5000× magnification SEM before and after being subjected to crushing by either liquid nitrogen treatment or mortar and pestle action. The images obtained are shown in FIG. 21.

The intact sample presents fully formed spheres. Conversely, the crushing, either by nitrogen or by pestle and mortar, results in some spheres being broken. At 5000× magnification it is possible to see that some larger spheres are broken and present a hollow structure. This structure is beneficial as the hollow structure can result in a rapid dissolution. As the outer layer of the spheres is dissolved the internal structure is exposed thereby increasing surface area.

The starting sample (intact) and the crushed (liquid nitrogen) samples seen at lower magnification (500×), however, highlight that the majority of the spheres of soluble saccharides remains intact, unbroken, suggesting good particle integrity. The advantage of the saccharide spheres being resistant to fracturing and filled is that the volume that they occupy in a formulated product is maintained during processing, i.e. particle size reduction during processing does not expose significant voids that, if they were present, they would need to be filled by fat during the formulation of a fat-based product (e.g., chocolate or ice cream). This would increase the cost of the formulated fat-based product and also alter its recipe (require more fat to be used) and therefore nutritional labelling; increased fat and calories.

The spray granulated samples obtained in Example 4 were also imaged by SEM. The granules obtained were larger than the spray dried samples and are visible at 100× and 500× magnification in FIG. 22A; and MCC trials D, F and G (Table 10) were imaged at 500× and 1000× FIG. 22B.

The lab scale spray granulation (Table 10) produced granules of product much larger than the spheres obtained during spray drying. The different conditions explored in Example 4 also resulted in different morphologies of the granules with trials A, B, C and E, resulting in large uniform granules. Trials A, B, C and E also showed good processability, whilst Trial D was not processable, with MCC adhering to the drier walls.

The final product of trial F had poor flow characteristics, whilst Trial G, resulted in a product that was not sievable as it was too fine. These differences in trials results can explain the morphological differences observed in FIG. 22B. The size of the spray granulated particles that are obtained is related to the processability of the material.

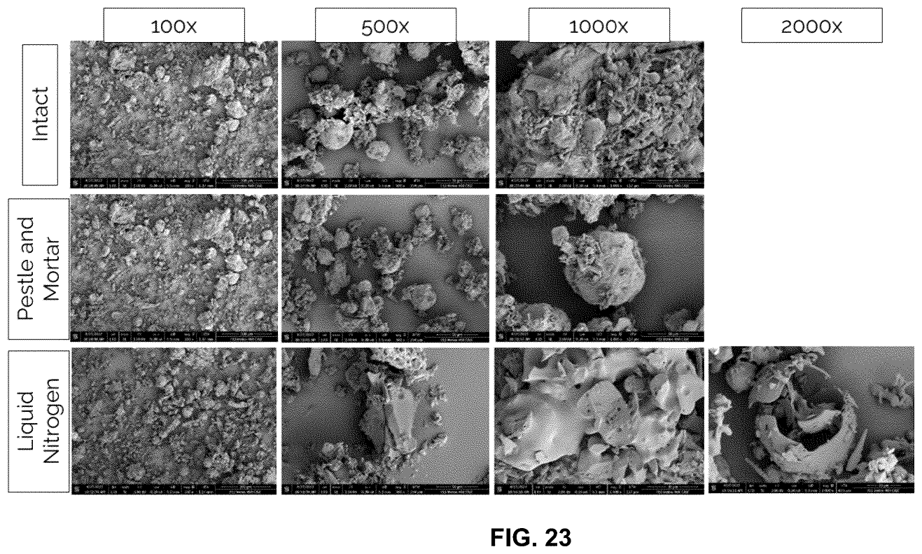

MCC Trial F was also subjected to crushing by mortar and pestle and liquid nitrogen to investigate the internal structure of the material. The SEM at different magnification of the intact, crushed (pestle and mortar) and crushed (liquid nitrogen) can be seen in FIG. 23.

The crushed (pestle and mortar) and the intact samples did not show many differences at any magnification. Meanwhile the crushed (liquid nitrogen) sample showed some cavitations at 1000× which appeared as ‘craters’ in a larger structure. At higher magnification (2000×) some hollow structures were found, however these represented a small fraction of the total dried compositions.

The spray granulated material appeared more densely packed than the spray dried material, this would result in different properties in the final food application. The larger particles would result in slower dissolution in final food application.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1.-76. (canceled)

77. A dry composition comprising:
a plurality of first particles, each first particle comprising a core, a surface on the core, and a coating at least partially covering the surface;
wherein the core comprises one or more insoluble saccharide(s); the coating comprises one or more soluble oligosaccharide(s); and
wherein the composition comprises insoluble saccharide and soluble oligosaccharide in a weight ratio of from 1:99 to 50:50.

78. The dry composition of claim 77, wherein the one or more soluble oligosaccharide(s) are independently xylo-oligosaccharides, cello-oligosaccharides, manno-oligosaccharides, fructo-oligosaccharides, galacto-oligosaccharides, or a combination thereof.

79. The dry composition of claim 77, wherein the one or more insoluble saccharide(s) are independently cellulose; hemicellulose, xylan, mannan, glucan, microcrystalline cellulose (MCC), or a combination thereof.

80. The dry composition of claim 77, wherein the coating comprises at least 80% by weight the one or more soluble oligosaccharide(s).

81. The dry composition of claim 77, wherein the plurality of first particles has a D10 particle size from 25 μm to 100 μm; and/or wherein the plurality of first particles has a D90 particle size from 100 μm to 500 μm.

82. The dry composition of claim 77, wherein the plurality of first particles comprises the coating and the core in a weight ratio of at least 1:1.

83. The dry composition of claim 77, further comprising a plurality of second particles, each second particle comprising another soluble oligosaccharide.

84. The dry composition of claim 77, further comprising a plurality of third particles, each third particle comprising a third soluble oligosaccharide, wherein the third soluble oligosaccharide is different from the another soluble oligosaccharide.

85. The dry composition of claim 77, wherein the one or more insoluble saccharide(s) comprise at least two insoluble saccharides.

86. The dry composition of claim 77, wherein the one or more insoluble saccharide(s) comprise a multimolecular complex of cellulose and hemicellulose.

87. The dry composition of claim 77, wherein the core further comprises a polyaromatic compound.

88. The dry composition of claim 77, wherein the one or more insoluble saccharide(s) comprise one or more of the following a-d):
a) At least 20% by weight cellulose
b) 1-70% by weight xylan
c) 1-70% by weight mannan
d) 0.1-17.5% by weight mixed-linkage glucan.

89. The dry composition of claim 77, wherein the one or more soluble oligosaccharide(s) comprise one or more oligosaccharide(s) with degrees of polymerization of two to twelve.

90. The dry composition of claim 77, wherein the dry composition is a sweetener composition.

91. A method of producing a dry composition comprising:
(a) providing a mixture of
(i) one or more soluble oligosaccharide(s) in a liquid medium; and
(ii) one or more insoluble saccharide(s);
(b) drying the mixture to form the dry composition comprising a plurality of first particles, each first particle comprising a core, a surface on the core, and a coating at least partially covering the surface; wherein: the core comprises one or more insoluble saccharide(s); the coating comprises one or more soluble oligosaccharide(s); and wherein the dry composition comprises insoluble saccharide and soluble oligosaccharide in a weight ratio of from 1:99 to 50:50.

92. The method of claim 91, wherein the drying comprises spray drying, vacuum drying and/or spray granulation.

93. The method of claim 92, wherein the drying comprises at least two from: spray drying, spray granulation, vacuum drying.

94. The method of claim 91, wherein the one or more insoluble saccharide(s) are placed in another liquid medium before (a).

95. The method of claim 91, wherein the dry composition further comprises a plurality of second particles, each second particle comprising another soluble oligosaccharide.

96. The method of claim 95, wherein a dry weight ratio of the plurality of second particles to the plurality of first particles is at least 1:1.

97. The method of claim 91, wherein the one or more insoluble saccharide(s) comprise MCC, and wherein the MCC has a D50 particle size from 45 μm to 280 μm.

98. The method of claim 91, wherein the liquid medium comprises at least two different soluble oligosaccharides.
